(19) United States
(12) Patent Application Publication
(10) Pub. No.: US 2026/0012989 A1
(43) Pub. Date: Jan. 8, 2026

(54) SMART CARRIER SELECTION FOR COOPERATING WIRELESS DEVICES

(71) Applicant: QUALCOMM Incorporated, San Diego, CA (US)

(72) Inventors: Mickael MONDET, Louannec (FR); Chih-Ping LI, San Diego, CA (US); Mohamed Atef Abdelazim SHEHATA, Lannion (FR); Diana MAAMARI, San Diego, CA (US); Prashanth Haridas HANDE, San Diego, CA (US); Peerapol TINNAKORNSRISUPHAP, San Diego, CA (US); Hyun Yong LEE, San Diego, CA (US)

(21) Appl. No.: 18/764,027

(22) Filed: Jul. 3, 2024

(51) Int. Cl. H04W 76/14; H04W 24/10; H04W 56/00; H04W 92/18

(52) U.S. Cl. CPC H04W 76/14; H04W 24/10; H04W 56/0015; H04W 92/18

(57) ABSTRACT

Methods, systems, and devices for wireless communications are described. An anchor wireless device may establish a cooperative communication link with a companion wireless device for direct communication with the companion wireless device and indirect communication with a network entity. The anchor wireless device may exchange messages with the companion wireless device via the cooperative communication link in accordance with a cooperative carrier selection process. The messages may cause a first Uu communication link for the anchor wireless device to be configured with a first carrier (associated with a first frequency) and a second Uu communication link for the companion device to be configured with a second carrier (associated with a different, second frequency). Thus, the anchor wireless device may communicate, in accordance with the cooperative communication link, with the companion wireless device via the cooperative communication link and with the network entity via the first Uu communication link.

### INTRODUCTION

The following relates to wireless communications that pertain to carrier selection of wireless devices. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by an anchor wireless device is described. The method may include establishing a cooperative communication link with a companion wireless device for direct communication with the companion wireless device and indirect communication with a network entity, exchanging, with the companion wireless device via the cooperative communication link in accordance with a cooperative carrier selection process, messages that cause a first Uu communication link to be configured with a first carrier and a second Uu communication link to be configured with a second carrier, where the first carrier is associated with a first frequency different from a second frequency associated with the second carrier, where the first Uu communication link enables communication between the anchor wireless device and the network entity and the second Uu communication link enables communication between the companion wireless device and the network entity, and communicating, in accordance with the cooperative communication link, with the companion wireless device via the cooperative communication link and with the network entity via the first Uu communication link.

An anchor wireless device for wireless communication is described. The anchor wireless device may include one or more memories storing processor executable code, and one or more processors coupled with the one or more memories. The one or more processors may individually or collectively be operable to execute the code to cause the anchor wireless device to establish a cooperative communication link with a companion wireless device for direct communication with the companion wireless device and indirect communication with a network entity, exchange, with the companion wireless device via the cooperative communication link in accordance with a cooperative carrier selection process, messages that cause a first Uu communication link to be configured with a first carrier and a second Uu communication link to be configured with a second carrier, where the first carrier is associated with a first frequency different from a second frequency associated with the second carrier, where the first Uu communication link enables communication between the anchor wireless device and the network entity and the second Uu communication link enables communication between the companion wireless device and the network entity, and communicate, in accordance with the cooperative communication link, with the companion wireless device via the cooperative communication link and with the network entity via the first Uu communication link.

Another anchor wireless device for wireless communication is described. The anchor wireless device may include means for establishing a cooperative communication link with a companion wireless device for direct communication with the companion wireless device and indirect communication with a network entity, means for exchanging, with the companion wireless device via the cooperative communication link in accordance with a cooperative carrier selection process, messages that cause a first Uu communication link to be configured with a first carrier and a second Uu communication link to be configured with a second carrier, where the first carrier is associated with a first frequency different from a second frequency associated with the second carrier, where the first Uu communication link enables communication between the anchor wireless device and the network entity and the second Uu communication link enables communication between the companion wireless device and the network entity, and means for communicating, in accordance with the cooperative communication link, with the companion wireless device via the cooperative communication link and with the network entity via the first Uu communication link.

A non-transitory computer-readable medium storing code for wireless communication is described. The code may include instructions executable by one or more processors to establish a cooperative communication link with a companion wireless device for direct communication with the companion wireless device and indirect communication with a network entity, exchange, with the companion wireless device via the cooperative communication link in accordance with a cooperative carrier selection process, messages that cause a first Uu communication link to be configured with a first carrier and a second Uu communication link to be configured with a second carrier, where the first carrier is associated with a first frequency different from a second frequency associated with the second carrier, where the first Uu communication link enables communication between the anchor wireless device and the network entity and the second Uu communication link enables communication between the companion wireless device and the network entity, and communicate, in accordance with the cooperative communication link, with the companion wireless device via the cooperative communication link and with the network entity via the first Uu communication link.

In some examples of the method, anchor wireless devices, and non-transitory computer-readable medium described herein, exchanging the messages in accordance with the cooperative carrier selection process may include operations, features, means, or instructions for transmitting, while in an idle connection state with the network entity, a first message that indicates a measurement and reporting configuration for the companion wireless device and receiving a second message that includes a report indicative of inter-frequency measurement information in accordance with the measurement and reporting configuration.

In some examples of the method, anchor wireless devices, and non-transitory computer-readable medium described herein, the measurement and reporting configuration corresponds to a set of channel measurements on different frequencies and to periodic or event-triggered reporting of information indicative of the set of channel measurements.

In some examples of the method, anchor wireless devices, and non-transitory computer-readable medium described herein, the inter-frequency measurement information may be indicative of a synchronization signal block (SSB) frequency and a physical cell identifier (PCI) associated with the companion wireless device, one or more quality measurements associated with the SSB frequency, a list of other SSB frequencies not associated with the PCI, corresponding quality measurements associated with each of the list of other SSB frequencies, or any combination thereof.

In some examples of the method, anchor wireless devices, and non-transitory computer-readable medium described herein, exchanging the messages in accordance with the cooperative carrier selection process may include operations, features, means, or instructions for transmitting, to the companion wireless device and based on the inter-frequency measurement information, a third message that indicates the second carrier.

In some examples of the method, anchor wireless devices, and non-transitory computer-readable medium described herein, exchanging the messages in accordance with the cooperative carrier selection process may include operations, features, means, or instructions for selecting, based on the inter-frequency measurement information, the first carrier and transmitting, to the companion wireless device, a third message that indicates one or more carriers that may be not to be associated with the second Uu communication link, where the one or more carriers includes the first carrier.

In some examples of the method, anchor wireless devices, and non-transitory computer-readable medium described herein, exchanging the messages in accordance with the cooperative carrier selection process may include operations, features, means, or instructions for transmitting, while in a connected connection state with the network entity, a first message that indicates a measurement and reporting configuration for the companion wireless device and receiving a second message that includes a first report indicative of first inter-frequency measurement information in accordance with the measurement and reporting configuration.

In some examples of the method, anchor wireless devices, and non-transitory computer-readable medium described herein, the measurement and reporting configuration corresponds to channel measurements on a serving cell and on one or more neighboring cells and to periodic or event-triggered reporting of information indicative of the channel measurements and the one or more neighboring cells may be on one or more respective carriers different from a carrier of the serving cell.

In some examples of the method, anchor wireless devices, and non-transitory computer-readable medium described herein, the first inter-frequency measurement information may be indicative of one or more quality measurements associated with a same carrier, a list of other frequencies not associated with the same carrier, corresponding highest quality measurements associated with each of the list of other frequencies, or any combination thereof.

In some examples of the method, anchor wireless devices, and non-transitory computer-readable medium described herein, exchanging the messages in accordance with the cooperative carrier selection process may include operations, features, means, or instructions for transmitting, to the companion wireless device and based on the first inter-frequency measurement information and on second inter-frequency measurement information associated with the anchor wireless device, a third message that indicates that the first carrier may be to be disadvantaged for the companion wireless device and receiving a fourth message that includes a second report indicative of updated first inter-frequency measurement information that may be associated with the second carrier based on the first carrier being disadvantaged for the companion wireless device by the third message.

In some examples of the method, anchor wireless devices, and non-transitory computer-readable medium described herein, exchanging the messages in accordance with the cooperative carrier selection process may include operations, features, means, or instructions for disadvantaging the second carrier at the anchor wireless device based on the first inter-frequency measurement information and on second inter-frequency measurement information associated with the anchor wireless device, transitioning to the first carrier for the first Uu communication link based on the second carrier being disadvantaged, transmitting, to the companion wireless device, a third message that indicates that the first carrier may be to be disadvantaged for the companion wireless device, and receiving a fourth message that includes a second report indicative of updated first inter-frequency measurement information that may be associated with the second carrier based on the first carrier being disadvantaged for the companion wireless device by the third message.

In some examples of the method, anchor wireless devices, and non-transitory computer-readable medium described herein, exchanging the messages in accordance with the cooperative carrier selection process may include operations, features, means, or instructions for participating in a handover procedure that results in establishment by the anchor wireless device of a third Uu communication link configured with a third carrier and transmitting, to the companion wireless device and based on establishment of the third Uu communication link configured with the third carrier, a third message that indicates that the third carrier may be to be disadvantaged for the companion wireless device.

Some examples of the method, anchor wireless devices, and non-transitory computer-readable medium described herein may further include operations, features, means, or instructions for receiving, from the companion wireless device after a handover procedure associated with the companion wireless device and based on establishment of a third Uu communication link configured with a third carrier for the companion wireless device, a third message that indicates a report indicative of inter-frequency measurement information that may be associated with the third carrier.

In some examples of the method, anchor wireless devices, and non-transitory computer-readable medium described herein, exchanging the messages in accordance with the cooperative carrier selection process may include operations, features, means, or instructions for transmitting, to the network entity, a radio resource control (RRC) message that indicates a request to configure or to release inter-frequency measurement procedures and receiving, from the network entity, an indication of one or more frequency-specific offsets that may be usable by the anchor wireless device to disadvantage selection of the first carrier as a result of a measurement report triggering event.

In some examples of the method, anchor wireless devices, and non-transitory computer-readable medium described herein, exchanging the messages in accordance with the cooperative carrier selection process may include operations, features, means, or instructions for transmitting, to the companion wireless device, a first message that indicates a request to report cooperation identity information associated with the companion wireless device and receive, from the companion wireless device and based on the first message, a first report indicative of the cooperation identity information associated with the companion wireless device, where the cooperation identity information may be indicative of an absolute radio frequency channel number (ARFCN) associated with the companion wireless device, a PCI that corresponds to the ARFCN, and a cell-radio network temporary identifier (C-RNTI) associated with the companion wireless device.

Some examples of the method, anchor wireless devices, and non-transitory computer-readable medium described herein may further include operations, features, means, or instructions for transmitting, to the network entity, a second message that indicates the cooperation identity information associated with the companion wireless device.

Some examples of the method, anchor wireless devices, and non-transitory computer-readable medium described herein may further include operations, features, means, or instructions for receiving, from the network entity, an RRC reconfiguration message that indicates that the anchor wireless device may be to participate in a handover procedure that results in establishment by the anchor wireless device of a third Uu communication link configured with a third carrier and participating in the handover procedure to establish the third Uu communication link configured with the third carrier based on the RRC reconfiguration message.

In some examples of the method, anchor wireless devices, and non-transitory computer-readable medium described herein, the second message may be an RRC message, a medium access control-control element (MAC-CE) message, or a layer 1 uplink control information (UCI) message.

In some examples of the method, anchor wireless devices, and non-transitory computer-readable medium described herein, exchanging the messages in accordance with the cooperative carrier selection process may include operations, features, means, or instructions for receiving, from the companion wireless device, a second report indicative of updated cooperation identity information associated with the companion wireless device, where the updated cooperation identity information includes a second ARFCN associated with the companion wireless device, a second PCI that corresponds to the second ARFCN, and a second C-RNTI associated with the companion wireless device.

A method for wireless communication by a companion wireless device is described. The method may include establishing a cooperative communication link with an anchor wireless device, where the companion wireless device is configured to receive first information via a first Uu communication link of the companion wireless device, and transmit, according to a forwarding scheme and via the cooperative communication link, second information to the anchor wireless device, where the second information is associated with the first information, and where the first Uu communication link enables communication between the companion wireless device and a network entity and a second Uu communication link enables communication between the anchor wireless device and the network entity, exchanging, with the anchor wireless device via the cooperative communication link in accordance with a cooperative carrier selection process, messages that cause the first Uu communication link to be configured with a first carrier and the second Uu communication link to be configured with a second carrier, where the first carrier is associated with a first frequency different from a second frequency associated with the second carrier, and communicating, in accordance with the cooperative communication link and the forwarding scheme, with the anchor wireless device via the cooperative communication link and with the network entity via the first Uu communication link.

A companion wireless device for wireless communication is described. The companion wireless device may include one or more memories storing processor executable code, and one or more processors coupled with the one or more memories. The one or more processors may individually or collectively be operable to execute the code to cause the companion wireless device to establish a cooperative communication link with an anchor wireless device, where the companion wireless device is configured to receive first information via a first Uu communication link of the companion wireless device, and transmit, according to a forwarding scheme and via the cooperative communication link, second information to the anchor wireless device, where the second information is associated with the first information, and where the first Uu communication link enables communication between the companion wireless device and a network entity and a second Uu communication link enables communication between the anchor wireless device and the network entity, exchange, with the anchor wireless device via the cooperative communication link in accordance with a cooperative carrier selection process, messages that cause the first Uu communication link to be configured with a first carrier and the second Uu communication link to be configured with a second carrier, where the first carrier is associated with a first frequency different from a second frequency associated with the second carrier, and communicate, in accordance with the cooperative communication link and the forwarding scheme, with the anchor wireless device via the cooperative communication link and with the network entity via the first Uu communication link.

Another companion wireless device for wireless communication is described. The companion wireless device may include means for establishing a cooperative communication link with an anchor wireless device, where the companion wireless device is configured to receive first information via a first Uu communication link of the companion wireless device, and transmit, according to a forwarding scheme and via the cooperative communication link, second information to the anchor wireless device, where the second information is associated with the first information, and where the first Uu communication link enables communication between the companion wireless device and a network entity and a second Uu communication link enables communication between the anchor wireless device and the network entity, means for exchanging, with the anchor wireless device via the cooperative communication link in accordance with a cooperative carrier selection process, messages that cause the first Uu communication link to be configured with a first carrier and the second Uu communication link to be configured with a second carrier, where the first carrier is associated with a first frequency different from a second frequency associated with the second carrier, and means for communicating, in accordance with the cooperative communication link and the forwarding scheme, with the anchor wireless device via the cooperative communication link and with the network entity via the first Uu communication link.

A non-transitory computer-readable medium storing code for wireless communication is described. The code may include instructions executable by one or more processors to establish a cooperative communication link with an anchor wireless device, where the companion wireless device is configured to receive first information via a first Uu communication link of the companion wireless device, and transmit, according to a forwarding scheme and via the cooperative communication link, second information to the anchor wireless device, where the second information is associated with the first information, and where the first Uu communication link enables communication between the companion wireless device and a network entity and a second Uu communication link enables communication between the anchor wireless device and the network entity, exchange, with the anchor wireless device via the cooperative communication link in accordance with a cooperative carrier selection process, messages that cause the first Uu communication link to be configured with a first carrier and the second Uu communication link to be configured with a second carrier, where the first carrier is associated with a first frequency different from a second frequency associated with the second carrier, and communicate, in accordance with the cooperative communication link and the forwarding scheme, with the anchor wireless device via the cooperative communication link and with the network entity via the first Uu communication link.

In some examples of the method, companion wireless devices, and non-transitory computer-readable medium described herein, exchanging the messages in accordance with the cooperative carrier selection process may include operations, features, means, or instructions for receiving, while in an idle connection state with the network entity, a first message that indicates a measurement and reporting configuration for the companion wireless device, generating, based on the measurement and reporting configuration, inter-frequency measurement information that includes channel measurements on one or more frequencies, and transmitting a second message that includes a report indicative of the inter-frequency measurement information in accordance with the measurement and reporting configuration.

In some examples of the method, companion wireless devices, and non-transitory computer-readable medium described herein, the measurement and reporting configuration corresponds to channel measurements on different frequencies and periodic or event-triggered reporting of information indicative of the channel measurements.

In some examples of the method, companion wireless devices, and non-transitory computer-readable medium described herein, the inter-frequency measurement information may be indicative of a synchronization signal block (SSB) frequency and a PCI associated with the companion wireless device, one or more quality measurements associated with the SSB frequency, a list of other SSB frequencies not associated with the PCI, corresponding quality measurements associated with each of the list of other SSB frequencies, or any combination thereof.

In some examples of the method, companion wireless devices, and non-transitory computer-readable medium described herein, exchanging the messages in accordance with the cooperative carrier selection process may include operations, features, means, or instructions for receiving, from the anchor wireless device and based on the inter-frequency measurement information, a third message that indicates the second carrier and selecting, based on the third message, the first carrier; and.

In some examples of the method, companion wireless devices, and non-transitory computer-readable medium described herein, exchanging the messages in accordance with the cooperative carrier selection process may include operations, features, means, or instructions for receiving, from the anchor wireless device, a third message that indicates one or more carriers that may be not to be associated with the first Uu communication link, where the one or more carriers includes the second carrier.

In some examples of the method, companion wireless devices, and non-transitory computer-readable medium described herein, exchanging the messages in accordance with the cooperative carrier selection process may include operations, features, means, or instructions for receiving, while in a connected connection state with the network entity, a first message that indicates a measurement and reporting configuration for the companion wireless device and transmitting a second message that includes a first report indicative of first inter-frequency measurement information in accordance with the measurement and reporting configuration.

In some examples of the method, companion wireless devices, and non-transitory computer-readable medium described herein, the measurement and reporting configuration corresponds to channel measurements on a serving cell and on one or more neighboring cells and to periodic or event-triggered reporting of information indicative of the channel measurements and the one or more neighboring cells may be on one or more respective carriers different from a carrier of the serving cell.

In some examples of the method, companion wireless devices, and non-transitory computer-readable medium described herein, the first inter-frequency measurement information may be indicative of one or more quality measurements associated with a same carrier, a list of other frequencies not associated with the same carrier, corresponding highest quality measurements associated with each of the list of other frequencies, or any combination thereof.

In some examples of the method, companion wireless devices, and non-transitory computer-readable medium described herein, exchanging the messages in accordance with the cooperative carrier selection process may include operations, features, means, or instructions for receiving, from the anchor wireless device, a third message that indicates that the second carrier may be to be disadvantaged for the companion wireless device and transmitting a fourth message that includes a second report indicative of updated first inter-frequency measurement information that may be associated with the first carrier based on the second carrier being disadvantaged for the companion wireless device by the third message.

In some examples of the method, companion wireless devices, and non-transitory computer-readable medium described herein, exchanging the messages in accordance with the cooperative carrier selection process may include operations, features, means, or instructions for receiving, from the anchor wireless device, a third message that indicates that the second carrier may be to be disadvantaged for the companion wireless device, where a same carrier may be the first carrier and transmitting a fourth message that includes a second report indicative of updated first inter-frequency measurement information that may be associated with the first carrier based on the second carrier being disadvantaged for the companion wireless device by the third message.

Some examples of the method, companion wireless devices, and non-transitory computer-readable medium described herein may further include operations, features, means, or instructions for receiving, from the anchor wireless device after a handover procedure associated with the anchor wireless device and based on establishment of a third Uu communication link configured with a third carrier for the anchor wireless device, a third message that indicates that the third carrier may be to be disadvantaged for the companion wireless device.

Some examples of the method, companion wireless devices, and non-transitory computer-readable medium described herein may further include operations, features, means, or instructions for participating in a handover procedure that results in establishment by the companion wireless device of a third Uu communication link configured with a third carrier and transmitting, to the anchor wireless device and based on establishment of the third Uu communication link configured with the third carrier, a third message that indicates a report indicative of inter-frequency measurement information that may be associated with the third carrier.

In some examples of the method, companion wireless devices, and non-transitory computer-readable medium described herein, exchanging the messages in accordance with the cooperative carrier selection process may include operations, features, means, or instructions for receiving, via a system information block (SIB) message or an RRC release message, an indication of one or more frequency-specific offsets, one or more frequency-specific priorities, or both, that may be usable by the companion wireless device to disadvantage one or more frequencies.

Some examples of the method, companion wireless devices, and non-transitory computer-readable medium described herein may further include operations, features, means, or instructions for using, while in an idle connection state with the network entity, the one or more frequency-specific offsets or the one or more frequency-specific priorities to disadvantage the second carrier.

In some examples of the method, companion wireless devices, and non-transitory computer-readable medium described herein, exchanging the messages in accordance with the cooperative carrier selection process may include operations, features, means, or instructions for transmitting, to the network entity, an RRC message that indicates a request to configure or to release inter-frequency measurement procedures and receiving, from the network entity, an indication of one or more frequency-specific offsets that may be usable by the companion wireless device to disadvantage selection of the second carrier as a result of a measurement report triggering event.

In some examples of the method, companion wireless devices, and non-transitory computer-readable medium described herein, exchanging the messages in accordance with the cooperative carrier selection process may include operations, features, means, or instructions for receiving, from the anchor wireless device, a first message that indicates a request to report cooperation identity information associated with the companion wireless device and transmitting, to the anchor wireless device and based on the first message, a first report indicative of the cooperation identity information associated with the companion wireless device, where the cooperation identity information may be indicative of an ARFCN associated with the companion wireless device, a PCI that corresponds to the ARFCN, and a C-RNTI associated with the companion wireless device.

Some examples of the method, companion wireless devices, and non-transitory computer-readable medium described herein may further include operations, features, means, or instructions for receiving, from the network entity, an RRC reconfiguration message that indicates that the companion wireless device may be to participate in a handover procedure that results in establishment by the companion wireless device of a third Uu communication link configured with a third carrier and participating in the handover procedure to establish the third Uu communication link configured with the third carrier based on the RRC reconfiguration message.

Some examples of the method, companion wireless devices, and non-transitory computer-readable medium described herein may further include operations, features, means, or instructions for transmitting, to the network entity, a second message that indicates that the handover procedure to establish the third Uu communication link configured with the third carrier may be complete.

In some examples of the method, companion wireless devices, and non-transitory computer-readable medium described herein, exchanging the messages in accordance with the cooperative carrier selection process may include operations, features, means, or instructions for transmitting, to the anchor wireless device, a second report indicative of updated cooperation identity information associated with the companion wireless device, where the updated cooperation identity information includes a second ARFCN associated with the companion wireless device, a second PCI that corresponds to the second ARFCN, and a second C-RNTI associated with the companion wireless device.

In some examples of the method, companion wireless devices, and non-transitory computer-readable medium described herein, the first information and the second information include same information.

In some examples of the method, companion wireless devices, and non-transitory computer-readable medium described herein, the first information and the second information include different information.

In some examples of the method, companion wireless devices, and non-transitory computer-readable medium described herein, the forwarding scheme includes an amplify and forward scheme.

In some examples of the method, companion wireless devices, and non-transitory computer-readable medium described herein, the forwarding scheme includes a decode and forward scheme.

A method for wireless communication by a first network entity is described. The method may include outputting, to an anchor wireless device connected via a cooperative communication link with a companion wireless device, an indication of one or more frequency-specific offsets that are usable by the anchor wireless device to disadvantage selection of a carrier in a cooperative carrier selection process that configures a first Uu communication link of the anchor wireless device to be configured with a first carrier and a second Uu communication link of the companion wireless device to be configured with a second carrier that is different from the first carrier, where the first Uu communication link enables communication between the anchor wireless device and the first network entity and the second Uu communication link enables communication between the companion wireless device and the first network entity, and where a cooperative communication link between the anchor wireless device and the companion wireless device enables indirect communication between the anchor wireless device and the first network entity and communicating with the anchor wireless device, the companion wireless device, or both, in accordance with a forwarding scheme.

A first network entity for wireless communication is described. The first network entity may include one or more memories storing processor executable code, and one or more processors coupled with the one or more memories. The one or more processors may individually or collectively be operable to execute the code to cause the first network entity to output, to an anchor wireless device connected via a cooperative communication link with a companion wireless device, an indication of one or more frequency-specific offsets that are usable by the anchor wireless device to disadvantage selection of a carrier in a cooperative carrier selection process that configures a first Uu communication link of the anchor wireless device to be configured with a first carrier and a second Uu communication link of the companion wireless device to be configured with a second carrier that is different from the first carrier, where the first Uu communication link enables communication between the anchor wireless device and the first network entity and the second Uu communication link enables communication between the companion wireless device and the first network entity, and where a cooperative communication link between the anchor wireless device and the companion wireless device enables indirect communication between the anchor wireless device and the first network entity and communicate with the anchor wireless device, the companion wireless device, or both, in accordance with a forwarding scheme.

Another first network entity for wireless communication is described. The first network entity may include means for outputting, to an anchor wireless device connected via a cooperative communication link with a companion wireless device, an indication of one or more frequency-specific offsets that are usable by the anchor wireless device to disadvantage selection of a carrier in a cooperative carrier selection process that configures a first Uu communication link of the anchor wireless device to be configured with a first carrier and a second Uu communication link of the companion wireless device to be configured with a second carrier that is different from the first carrier, where the first Uu communication link enables communication between the anchor wireless device and the first network entity and the second Uu communication link enables communication between the companion wireless device and the first network entity, and where a cooperative communication link between the anchor wireless device and the companion wireless device enables indirect communication between the anchor wireless device and the first network entity and means for communicating with the anchor wireless device, the companion wireless device, or both, in accordance with a forwarding scheme.

A non-transitory computer-readable medium storing code for wireless communication is described. The code may include instructions executable by one or more processors to output, to an anchor wireless device connected via a cooperative communication link with a companion wireless device, an indication of one or more frequency-specific offsets that are usable by the anchor wireless device to disadvantage selection of a carrier in a cooperative carrier selection process that configures a first Uu communication link of the anchor wireless device to be configured with a first carrier and a second Uu communication link of the companion wireless device to be configured with a second carrier that is different from the first carrier, where the first Uu communication link enables communication between the anchor wireless device and the first network entity and the second Uu communication link enables communication between the companion wireless device and the first network entity, and where a cooperative communication link between the anchor wireless device and the companion wireless device enables indirect communication between the anchor wireless device and the first network entity and communicate with the anchor wireless device, the companion wireless device, or both, in accordance with a forwarding scheme.

Some examples of the method, first network entities, and non-transitory computer-readable medium described herein may further include operations, features, means, or instructions for obtaining, from the anchor wireless device, an RRC message that indicates a request to configure or to release inter-frequency measurement procedures, where the one or more frequency-specific offsets may be usable by the anchor wireless device to disadvantage selection of the first carrier as a result of a measurement report triggering event.

Some examples of the method, first network entities, and non-transitory computer-readable medium described herein may further include operations, features, means, or instructions for obtaining, from the anchor wireless device, a message that indicates cooperation identity information associated with the companion wireless device, where the cooperation identity information may be indicative of an ARFCN associated with the companion wireless device, a PCI that corresponds to the ARFCN, and a C-RNTI associated with the companion wireless device.

Some examples of the method, first network entities, and non-transitory computer-readable medium described herein may further include operations, features, means, or instructions for outputting, to the anchor wireless device, an RRC reconfiguration message that indicates that the anchor wireless device may be to participate in a handover procedure that results in establishment by the anchor wireless device of a third Uu communication link configured with a third carrier.

In some examples of the method, first network entities, and non-transitory computer-readable medium described herein, the message may be an RRC message, a medium access control-control element (MAC-CE) message, or a layer 1 uplink control information (UCI) message.

Some examples of the method, first network entities, and non-transitory computer-readable medium described herein may further include operations, features, means, or instructions for obtaining, from a second network entity, a message that includes a request to initiate a handover procedure for the companion wireless device, where the message indicates cooperation identity information associated with the companion wireless device, and where the cooperation identity information may be indicative of an ARFCN associated with the companion wireless device, a PCI that corresponds to the ARFCN, and a C-RNTI associated with the companion wireless device and outputting, to the companion wireless device, an RRC reconfiguration message that indicates that the companion wireless device may be to participate in the handover procedure that results in establishment by the companion wireless device of a third Uu communication link configured with a third carrier.

Some examples of the method, first network entities, and non-transitory computer-readable medium described herein may further include operations, features, means, or instructions for obtaining, from the companion wireless device, a second message that indicates that the handover procedure to establish the third Uu communication link configured with the third carrier may be complete and outputting, to the second network entity, a third message that indicates a confirmation of the handover procedure.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports smart carrier selection for cooperating wireless devices in accordance with one or more aspects of the present disclosure.

FIG. 2 shows an example of a wireless communications system that supports smart carrier selection for cooperating wireless devices in accordance with one or more aspects of the present disclosure.

FIG. 3 shows an example of a process flow that supports smart carrier selection for cooperating wireless devices in accordance with one or more aspects of the present disclosure.

FIG. 4 shows an example of a process flow that supports smart carrier selection for cooperating wireless devices in accordance with one or more aspects of the present disclosure.

FIGS. 5A and 5B show examples of process flows that support smart carrier selection for cooperating wireless devices in accordance with one or more aspects of the present disclosure.

FIG. 6 shows an example of a process flow that supports smart carrier selection for cooperating wireless devices in accordance with one or more aspects of the present disclosure.

FIG. 7 shows an example of a process flow that supports smart carrier selection for cooperating wireless devices in accordance with one or more aspects of the present disclosure.

FIG. 8 shows an example of a process flow that supports smart carrier selection for cooperating wireless devices in accordance with one or more aspects of the present disclosure.

FIGS. 9 and 10 show block diagrams of devices that support smart carrier selection for cooperating wireless devices in accordance with one or more aspects of the present disclosure.

FIG. 11 shows a block diagram of a communications manager that supports smart carrier selection for cooperating wireless devices in accordance with one or more aspects of the present disclosure.

FIG. 12 shows a diagram of a system including a device that supports smart carrier selection for cooperating wireless devices in accordance with one or more aspects of the present disclosure.

FIGS. 13 and 14 show block diagrams of devices that support smart carrier selection for cooperating wireless devices in accordance with one or more aspects of the present disclosure.

FIG. 15 shows a block diagram of a communications manager that supports smart carrier selection for cooperating wireless devices in accordance with one or more aspects of the present disclosure.

FIG. 16 shows a diagram of a system including a device that supports smart carrier selection for cooperating wireless devices in accordance with one or more aspects of the present disclosure.

FIGS. 17 and 18 show block diagrams of devices that support smart carrier selection for cooperating wireless devices in accordance with one or more aspects of the present disclosure.

FIG. 19 shows a block diagram of a communications manager that supports smart carrier selection for cooperating wireless devices in accordance with one or more aspects of the present disclosure.

FIG. 20 shows a diagram of a system including a device that supports smart carrier selection for cooperating wireless devices in accordance with one or more aspects of the present disclosure.

FIGS. 21 through 23 show flowcharts illustrating methods that support smart carrier selection for cooperating wireless devices in accordance with one or more aspects of the present disclosure.

### DETAILED DESCRIPTION

A first wireless device (e.g., an anchor user equipment (UE)) and a second wireless device (e.g., a companion UE) may each establish a connection (e.g., a Uu connection) with a network entity. Such a process may provide multiple paths to aggregate traffic for a device (e.g., a wearable device) that is wirelessly connected to the first wireless device and the second wireless device. The two wireless devices may also provide additional antennas or bandwidth, which may help support operations at the device, reducing latency and increasing throughput. The two wireless devices may establish a cooperative relationship which may support one or more forwarding schemes for wireless communication at one or both wireless devices.

Techniques described herein support an anchor wireless device that may establish a cooperative communication link with a companion wireless device for direct communication with the companion wireless device and indirect communication with a network entity. The anchor wireless device may exchange messages with the companion wireless device via the cooperative communication link in accordance with a cooperative carrier selection process. The messages may cause a first Uu communication link to be configured with a first carrier and a second Uu communication link to be configured with a second carrier. The first carrier may be associated with a first frequency different from a second frequency associated with the second carrier. The first Uu communication link may enable communication between the anchor wireless device and the network entity and the second Uu communication link may enable communication between the companion wireless device and the network entity. In accordance with the cooperative communication link, the companion wireless device may be configured to receive first information from the network entity via the second Uu communication link, and to transmit, according to a forwarding scheme and via the cooperative communication link, second information to the anchor wireless device. Thus, the anchor wireless device may communicate, in accordance with the cooperative communication link, with the companion wireless device via the cooperative communication link and with the network entity via the first Uu communication link.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to smart carrier selection for cooperating wireless devices.

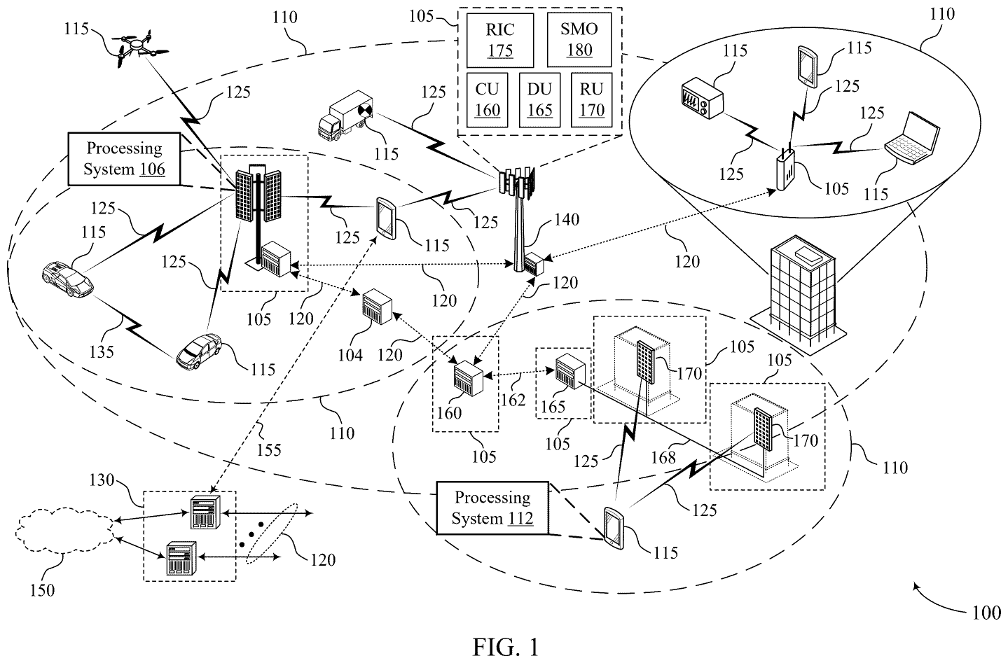

FIG. 1 shows an example of a wireless communications system 100 that supports smart carrier selection for cooperating wireless devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, a device (e.g., a wearable device) may operate according to various limits, such as a limited quantity of antennas or a power limit. The device may establish a connection with a user equipment (UE) to perform operations (e.g., extended reality (XR) features). However, this connection with the UE may be insufficient to support such operations given the limits of the device, resulting in relatively high latency and low throughput, thereby diminishing the experience of a user of the device.

The wireless communications system 100 may provide means for an anchor wireless device (e.g., a first UE 115) to establish a cooperative communication link with a companion wireless device (e.g., a second UE 115) for direct communication with the companion wireless device and indirect communication with a network entity 105. The anchor wireless device may exchange messages with the companion wireless device via the cooperative communication link in accordance with a cooperative carrier selection process. The messages may cause a first Uu communication link to be configured with a first carrier and a second Uu communication link to be configured with a second carrier. The first carrier may be associated with a first frequency different from a second frequency associated with the second carrier. The first Uu communication link may enable communication between the anchor wireless device and the network entity 105 and the second Uu communication link may enable communication between the companion wireless device and the network entity 105. In accordance with the cooperative communication link, the companion wireless device may be configured to receive first information from the network entity 105 via the second Uu communication link, and to transmit, according to a forwarding scheme and via the cooperative communication link, second information to the anchor wireless device. Thus, the anchor wireless device may communicate, in accordance with the cooperative communication link, with the companion wireless device via the cooperative communication link and with the network entity 105 via the first Uu communication link.

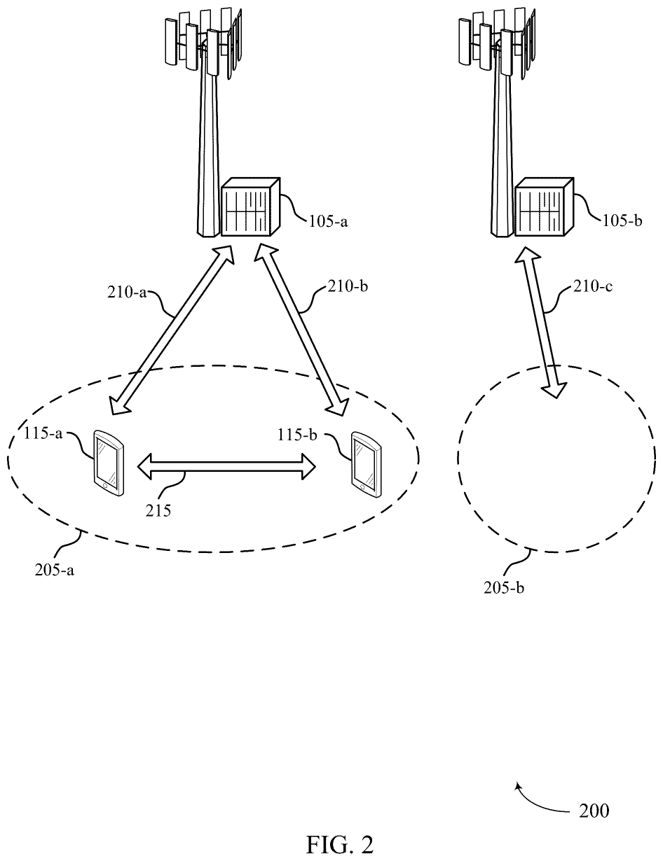

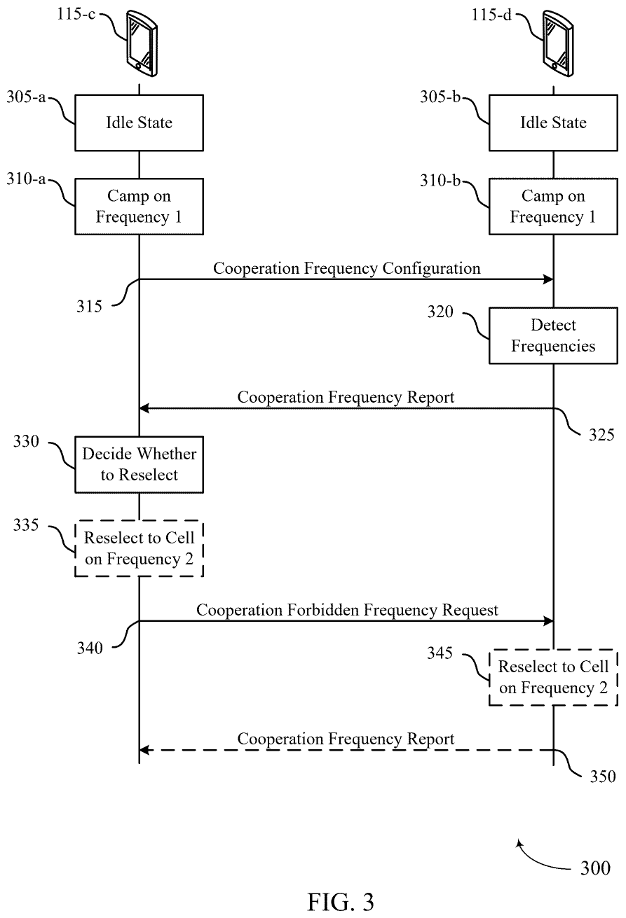

FIG. 2 shows an example of a wireless communications system 200 that supports smart carrier selection for cooperating wireless devices in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a and a UE 115-b) and one or more network entities 105 (e.g., a network entity 105-a and a network entity 105-b), which may be examples of the corresponding devices as described herein. In some cases, the one or more UEs 115 may be respective examples of network entities or other wireless devices. The UE 115-a and the UE 115-b may be in a cell 205-a, in communication with the network entity 105-a. In some cases, at least one UE 115 may change (e.g., move) to a cell 205-b, and may similarly communicate with the network entity 105-b (e.g., over a wireless connection 210-c). In some examples, if the UE 115-b operates on a carrier in the cell 205-b, the UE 115-b may participate in a handover procedure to move to a third cell 205 in communication with the network entity 105-b (e.g., to avoid operating on a same carrier as the UE 115-b, as described with reference to FIG. 3-8).

In some implementations, the UE 115-a may be referred to as an anchor UE 115. An anchor UE 115 may be a device that can run an application such as an extended reality (XR) application. That is, the UE 115-a may be an XR device. Accordingly, the UE 115-b may be referred to as a companion UE 115. A companion UE 115 may be a cooperating device (e.g., an XR device) that may provide a second connection to the anchor UE 115. In some implementations, the UE 115-a may be a companion UE 115 and the UE 115-b may be an anchor UE 115. In any case, the anchor UE 115 may host or run an XR application and may manage a Uu full stack connection to the network entity 105-a. The anchor UE 115 and the companion UE 115 may be respective examples of devices such as an electronic wristband, a smartwatch, augmented reality (AR) or XR glasses, another wearable device, a smartphone, or the like. In some cases, the anchor UE 115 and the companion UE 115 may communicate jointly or separately with a XR or AR device (such as a wearable device).

In some cases, the UE 115-a may exchange (e.g., transmit and receive) one or more messages with the network entity 105-a via a wireless connection 210-a (e.g., a first Uu connection). Similarly, the UE 115-b may exchange one or more messages with the network entity 105-a via a wireless connection 210-b (e.g., a second Uu connection). The UE 115-a may exchange one or more messages with the UE 115-b via a link 215 (e.g., a wireless cooperation link). The link 215 may be a PC5 connection, an ultra-wideband connection, a wi-fi connection, a Bluetooth connection, or the like. Thus, the UE 115-a and the UE 115-b may establish a cooperation relationship (e.g., in the form of a multi-path connection). In some cases, the cooperation relationship may include forwarding internet protocol (IP) packets, forwarding in-phase and quadrature (IQ) samples, or both. Such a cooperation relationship may result in a relatively high rank, improved (e.g., larger) bandwidth, diversity gains, load balancing which may improve throughput, and improved data rates (e.g., under XR device power limits), among other benefits.

The wireless communications system 200 may support a multi-path connection for an application at an anchor UE 115 (e.g., the UE 115-a). For example, the wireless connection 210-a and the wireless connection 210-b may form the multi-path connection. In some cases, the wireless communications system 200 may support Access Traffic Steering, Switching and Splitting (ATSSS) functionality or similar functionality (e.g., dual steer functionality). For example, the wireless communications system 200 may support aggregation, splitting, or both at the user plane function (UPF) and at a UE 115 below the IP layer such as with 3GPP ATSSS. The access of an anchor UE 115 (through a companion UE 115) may be classified as non-3GPP which may be compatible with multi-access packet data unit (PDU) (MA-PDU) session establishment. In some examples, the wireless communications system 200 may support over the top aggregation, splitting, or both. For example, the wireless communications system 200 may support aggregation, splitting, or both at one or more layers above the IP layer with over-the-top multi-path quick user datagram protocol (UDP) internet connection (mpQUIC). In some cases, the anchor UE 115 (e.g., the UE 115-a) and the companion UE 115 (e.g., the UE 115-b) may have separate PDU sessions. If an anchor UE 115 and a companion UE 115 are connected to cells on different carriers, they may achieve relatively high gains when compared to an anchor UE 115 and a companion UE 115 connected to cells on a same carrier. Thus, techniques described herein support smart carrier selection, to avoid two UEs 115 on a same carrier.

FIGS. 3-8 show respective examples of process flows that support smart carrier selection for cooperating wireless devices in accordance with one or more aspects of the present disclosure. The process flows may include one or more UEs 115 and one or more network entities 105. The wireless communications system 200 may support the operations describes in each of the process flows.

For example, an anchor UE 115 (e.g., the UE 115-a) may establish a cooperative communication link (e.g., the link 215) with a companion UE 115 (e.g., the UE 115-b) for direct communication with the companion wireless device and indirect communication with a network entity 105. The anchor UE 115 may exchange messages with the companion UE 115 via the cooperative communication link in accordance with a cooperative carrier selection process. The messages may cause a first Uu communication link (e.g., the wireless connection 210-a) to be configured with a first carrier and a second Uu communication link (e.g., the wireless connection 210-b) to be configured with a second carrier. The first carrier may be associated with a first frequency different from a second frequency associated with the second carrier. The first Uu communication link may enable communication between the anchor UE 115 and the network entity 105 and the second Uu communication link may enable communication between the companion UE 115 and the network entity 105.

The companion UE 115 may establish the cooperative communication link with the anchor UE 115. The companion UE 115 (or a processing system thereof) may be configured to receive first information via the second Uu communication link of the companion UE 115, and transmit, according to a forwarding scheme and via the cooperative communication link, second information to the anchor UE 115. The second information may be associated with the first information. The companion UE 115 may communicate, in accordance with the cooperative communication link and the forwarding scheme, with the anchor UE 115 via the cooperative communication link and with the network entity 105 via the second Uu communication link.

A Uu communication link (e.g., the first Uu communication link or the second Uu communication link) may be a type of access link. An access link may be an example of a wireless connection between a pair of wireless devices. Specifically, a Uu communication link may refer to an access link between a network entity 105 and a UE 115. For example, the first Uu communication link may be an access link between the network entity 105-a and the UE 115-a, while the second Uu communication link may be an access link between the network entity 105-a and the UE 115-b. A third Uu communication link (e.g., the wireless connection 210-c) may be an access link between the network entity 105-b and another UE 115 (e.g., the UE 115-b).

As described herein, a forwarding scheme may refer to a procedure in which a first UE 115 (e.g., a companion UE 115) may receive first information (e.g., via the second Uu communication link) that is for (e.g., destined for) a second UE 115 (e.g., an anchor UE 115). The first UE 115 may generate second information based on the first information and may transmit the second information to the second UE 115 (e.g., via the cooperative communication link). In this example, the cooperative communication link may be considered as enabling indirect communication between the second UE 115 and the network entity (e.g., network entity 105 from which the first UE 115 receives the first information. Similarly, the first UE 115 may receive third information, from the second UE 115 (e.g., via the cooperative communication link), (e.g., destined for) for a network entity (e.g., network entity 105) which may be the same network entity from which the first UE 115 received the first information or may be a different network entity from the network entity from which the first UE 115 received the first information. The first UE 115 may generate fourth information based on the third information and may transmit (e.g., via the second Uu communication link) the fourth information to the network entity (e.g., network entity 105). In this example, the cooperative communication link may similarly be considered as enabling indirect communication between the second UE 115 and the network entity. Thus, the second UE 115 may communicate with the network entity 105 via the first UE 115, according to the forwarding scheme. In some implementations, the second UE 115 may transmit or receive information directly to or from the network entity 105. For example, despite the indirect communication pathway to the network entity via a cooperative communication link in accordance with a forwarding scheme, the second UE 115 may also be in direct communication with the network entity via a different communication pathway (e.g., a first Uu communication link) with the network entity, meaning that the second UE 115, in such an example, may be configured to communicate with the network entity directly (e.g., the first Uu communication link) and indirectly (e.g., via the cooperative communication link). In some cases, the forwarding scheme may be an example of an amplify and forward scheme. Additionally or alternatively, the forwarding scheme may be an example of a decode and forward scheme. In some examples, reference to “direct” may refer to the exclusion of a companion network entity (e.g., companion UE 115) but zero or more intermediate network entities may exist within the direct communication pathway, and “indirect” may refer to the inclusion of a companion network entity (e.g., companion UE 115) but one or more additional intermediate network entities may exist within the indirect communication pathway. In such examples, direct communication between the two network entities (e.g., the second UE 115 and the network entity 105) may include zero or more intermediate network entities notwithstanding the exclusion of a companion network entity (e.g., companion UE 115). In other examples, reference to “direct” may refer to the exclusion of all intermediate network entities, including exclusion of a companion network entity (e.g., companion UE 115) and “indirect” may refer to the inclusion of a companion network entity (e.g., companion UE 115) and zero or more other intermediate network entities.

In some implementations, the first information may be different than the second information. For example, the first UE 115 may receive the first information and may generate the second information based on the first information. The first UE 115 may generate the second information in response to the first information (e.g., based on instructions within the first information). In some cases, the second information may include at least a portion of the first information (e.g., the second information may be a copy of the first information). Thus, the first UE 115 may receive a set of information, including information for the second UE 115, and may transmit the information that is for the second UE 115 to the second UE 115.

The cooperative communication link (e.g., the link 215) between the anchor UE 115 and the companion UE 115 may enable non-forwarded communication between the anchor UE 115 and the companion UE 115. The cooperative communication link may enable forwarded communication between the anchor UE 115 and the network entity 105 via the cooperative communication link (e.g., via the companion UE 115 according to the forwarding scheme).

FIG. 3 shows an example of a process flow 300 that supports smart carrier selection for cooperating wireless devices in accordance with one or more aspects of the present disclosure. The process flow 300 includes a UE 115-c and a UE 115-d, which may be examples of the corresponding devices as described with respect to FIGS. 1 and 2. In the following description of the process flow 300, the operations between the UE 115-c and the UE 115-d may be performed in a different order than the example order shown. Some operations may also be omitted from the process flow 300, and other operations may be added to the process flow 300. Further, although some operations or signaling may be shown to occur at different times for discussion purposes, these operations may actually occur at the same time. In the following description, one of the UE 115-c and the UE 115-d may operate as an anchor UE 115 (which hosts an application), and the other may operate as a companion UE (which supports the application). In some cases, either the anchor UE or the companion UE may manage the operations of the process flow 300 (e.g., the smart carrier selection). In some examples as described herein, a “frequency” may refer to a “carrier” and vice versa.

At 305-a, the UE 115-c may operate in an idle state (e.g., RRC_IDLE) or an inactive state. Similarly, at 305-b, the UE 115-d may operate in an idle state or an inactive state. At 310-a and 310-b, the UE 115-c and the UE 115-d, may each operate (e.g., camp) on a first frequency (e.g., a first carrier). That is, the UE 115-c and the UE 115-d may operate on a same frequency (or carrier). The UE 115-c may establish a cooperation link with the UE 115-d, which may be an example of the link 215 described with reference to FIG. 2. In some examples, the cooperation link may be a Wi-fi connection, a sidelink connection, an ultra-wideband connection, or similar. The UE 115-c may exchange one or more messages with the UE 115-d via the cooperation link. In some cases, if a pair of UEs 115 share a cooperation link, the pair of UEs 115 may support smart carrier selection (e.g., even when the actual service is not ongoing). In such a cooperation link, a UE 115 may manage mobility. In some examples, if a UE 115 operates in RRC_IDLE, the UE 115 may select and reselect an associated serving cell autonomously, from measurements made at the UE and from parameters provided by the network.

At 315, the UE 115-c may transmit, to the UE 115-d, a cooperation frequency configuration message. The cooperation frequency configuration message may include a set of one or more reporting conditions, which instruct the UE 115-d to detect one or more frequencies and report properties (e.g., measurements) associated with the one or more frequencies. For example, the cooperation frequency configuration message may indicate a period (e.g., for periodic reporting) or an event associated with reporting the properties. The event may include, for example, a reselection to an updated cell or frequency, a change of signal quality or level by a configurable amount, or both.

At 320, the UE 115-d may perform a detection operation on the one or more frequencies, which may include measuring and identifying properties of the one or more frequencies (e.g., power level, signal quality, and so forth). In some cases, a cooperating UE 115 (e.g., the UE 115-d) may perform inter-frequency measurements even if the conditions for doing so were not fulfilled. The UE 115-c may also perform a detection operation on one or more second frequencies, which may similarly include measuring and identifies properties of the one or more second frequencies.

At 325, the UE 115-c may receive, from the UE 115-d, a cooperation frequency report message. The cooperation frequency report message may include a set of values identifying the one or more frequencies (e.g., a list of frequencies detected at the UE 115-d) and the properties of the one or more frequencies. For example, the cooperation frequency report message may include a synchronization signal broadcasting frequency or a synchronization signal block (SSB) frequency and a physical cell identifier of the cell that the UE 115-d is operating on (e.g., camping on). The one or more frequencies may be examples of SSB frequencies. The cooperation frequency report message may further include, for each frequency of the one or more frequencies, a physical cell identifier (PCI) of a cell associated with the frequency, a cell selection Rx level value (Srxlev) (e.g., reference signal received power (RSRP), an received power value), a cell selection quality value (Squal) (e.g., reference signal received quality (RSRQ), a received quality value), or any combination thereof. In some cases, the Srxlev associated with each frequency may be a threshold (e.g., highest) Srxlev of all cells detected on the respective frequency. Similarly, the Squal associated with each frequency may be a threshold (e.g., highest) Squal of all cells detected on the respective frequency.

At 330, the UE 115-c may decide whether to reselect to a second frequency (e.g., change to communicate over the second frequency, or change to a cell on the second frequency) or to request the UE 115-d to reselect to the second frequency. This decision may be based on a combination of information in the cooperation frequency report message and information associated with frequencies detected at the UE 115-d. As an illustrative example, if the cooperation frequency report message indicates that the UE 115-d operates on a frequency with higher quality than all other frequencies, or if the UE 115-c determines that the first frequency has a higher quality for the UE 115-d than the UE 115-c operating on the same frequency, the UE 115-c may decide to reselect to the second frequency. If the UE 115-c operates on a frequency with higher quality than all other frequencies, the UE 115-c may request the UE 115-d to reselect to the second frequency. At 335, the UE 115-d may optionally reselect to the second frequency (e.g., after determining to do so at 330).

At 340, the UE 115-c may transmit, to the UE 115-d, a cooperation forbidden frequency request message that indicates the decision of the UE 115-c executed at 330. For example, if the UE 115-c decided to reselect to the second frequency, the cooperation forbidden frequency request message may indicate that the UE 115-d is to refrain from (e.g., avoid) reselecting to any cell on the second frequency (and remain on the first frequency). If the UE 115-c decided to request the UE 115-d to reselect to the second frequency, the cooperation forbidden frequency request message may indicate that the UE 115-d is to reselect to a cell on the second frequency. Thus, the UE 115-c and the UE 115-d may modify their connections such that they operate on separate frequencies (e.g., carriers).

At 345, if the cooperation forbidden frequency request message indicated that the UE 115-d is to reselect to a cell on the second frequency, the UE 115-d may do so. If the UE 115-d reselects to an updated cell (on the second frequency), at 350, the UE 115-c may receive a second cooperation frequency report message from the UE 115-d. The second cooperation frequency report message may include measurements associated with frequencies measured at the UE 115-d. In some cases, the second cooperation frequency report message may confirm that the UE 115-d successfully reselected to the second frequency.

In some implementations, a wireless communications system (e.g., the wireless communications system 200, as described with reference to FIG. 2) may support means to control how a cooperating UE 115 may avoid camping on a cell which is on the same frequency as a supporting UE 115 of the cooperating UE 115 (e.g., according to the process flow 300). For example, the wireless communications system may support frequency-specific offsets or frequency specific priorities (e.g., to avoid a UE 115 camping on a cell which is on the same frequency as its peer).

In some cases, a UE 115 (e.g., the UE 115-c or the UE 115-d) may receive signaling from a network entity 105. The signaling may indicate one or more frequency-specific offsets, one or more frequency-specific priorities, or both. The UE 115 (e.g., either UE 115) may use the one or more frequency-specific offsets, the one or more frequency-specific priorities, or both, to disadvantage a frequency while reselecting a cell to establish communication. The network entity 105 may transmit the signaling prior to deciding whether to reselect to the second frequency (e.g., at 330). In some cases, the network entity 105 may transmit the signaling in a system information block (SIB), a system information broadcast message, or an RRC release message. In some examples, one UE 115 (e.g., the UE 115-c) may receive the signaling from the network entity 105 and may forward the information in the signaling to a cooperating UE 115 (e.g., the UE 115-d).

In some implementations, the one or more frequency specific offsets may include a first offset (e.g., Qrxlev_cooperation) and a second offset (e.g., Qsqual_cooperation). The UE 115 may use the first offset and the second offset when evaluating the cell selection and reselection criteria (e.g., at 330). In some cases, the UE 115 (e.g., either UE 115) determines to disadvantage a frequency, the UE 115 may apply the offsets to a received power value (e.g., Srxlev), a received quality value (e.g., Squal), or both, associated with the frequency. For example, the UE 115 may apply the first offset to the received power value according to formula (1) (e.g., by subtracting the first offset from the value calculated using a set of received power value parameters, p1).

Srxlev=p1−Qrxlev_cooperation (1)

Similarly, the UE 115 may apply the second offset to the received power value according to formula (2) (e.g., by subtracting the second offset from the value calculated using a set of received quality value parameters, p2).

Squal=p2−Qsqual_cooperation (2)

In some implementations, the one or more frequency-specific priorities may include a cooperating priority value (e.g., cellReselectionCooperatingPriority). The UE 115 (e.g., the UE 115-c or the UE 115-d) may apply the cooperating priority value to a measurement value of a particular frequency to disadvantage the particular frequency during cell selection or reselection. For example, if a cooperating UE 115 determines not to disadvantage a first frequency, the cooperating UE 115 may apply a non-cooperating priority parameter (e.g., cellReselectionPriority) to a measurement value of the first frequency. If the cooperating UE 115 determines to disadvantage a second frequency, the cooperating UE 115 may apply the cooperating priority value to a measurement value of the second frequency.

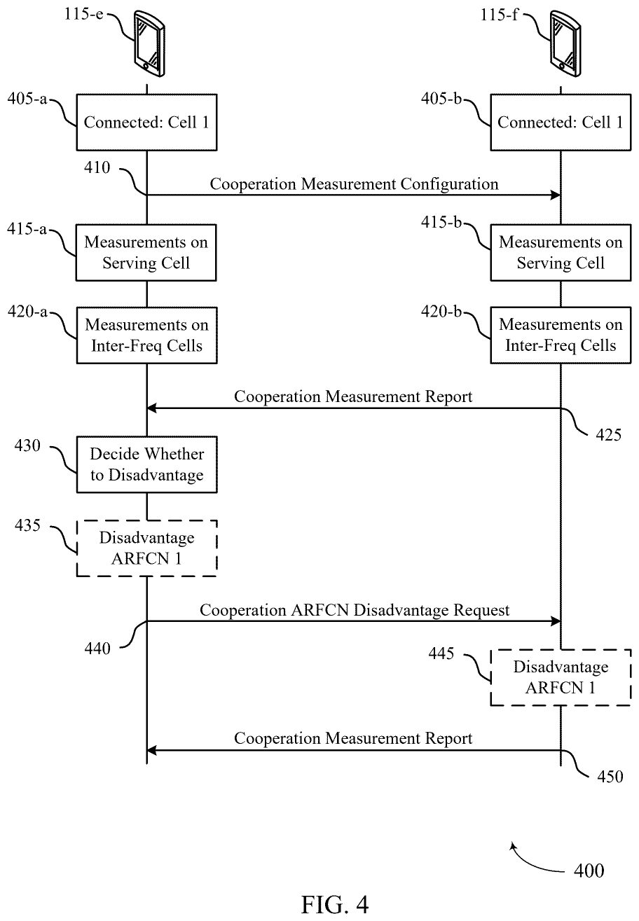

FIG. 4 shows an example of a process flow 400 that supports smart carrier selection for cooperating wireless devices in accordance with one or more aspects of the present disclosure. The process flow 400 includes a UE 115-e and a UE 115-f, which may be examples of the corresponding devices as described with respect to FIGS. 1-3. In the following description of the process flow 400, the operations between the UE 115-e and the UE 115-f may be performed in a different order than the example order shown. Some operations may also be omitted from the process flow 400, and other operations may be added to the process flow 400. Further, although some operations or signaling may be shown to occur at different times for discussion purposes, these operations may actually occur at the same time. In the following description, one of the UE 115-e and the UE 115-f may operate as an anchor UE 115 (which hosts an application), and the other may operate as a companion UE (which supports the application). In some cases, either the anchor UE or the companion UE may manage the operations of the process flow 400 (e.g., the smart carrier selection). In some examples as described herein, a “frequency” may refer to a “carrier” and vice versa.

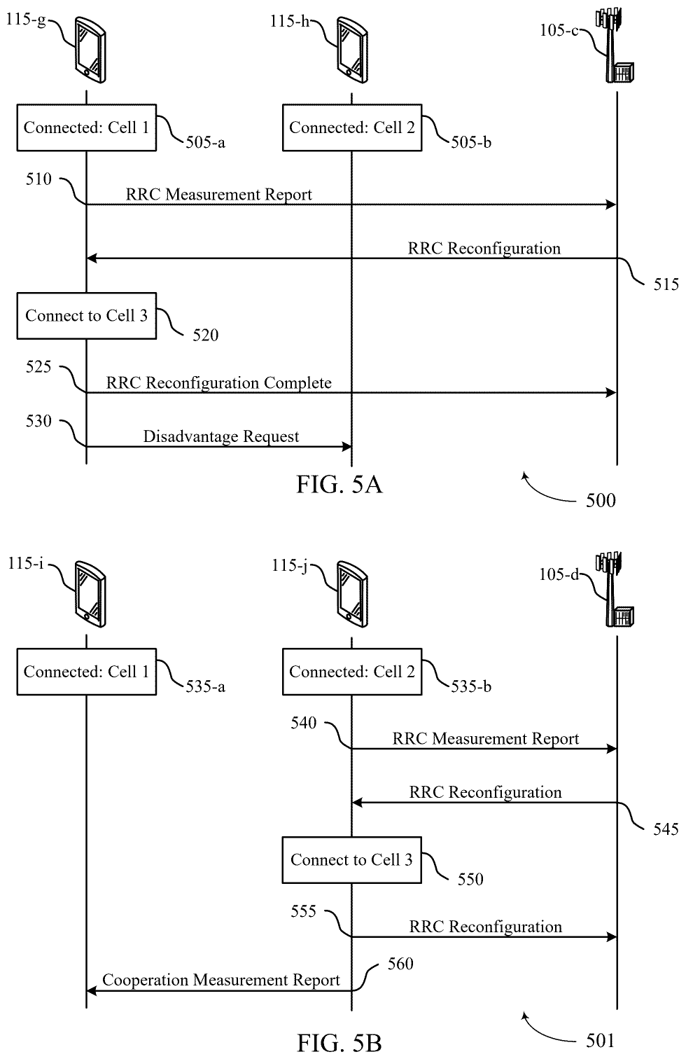

At 405-a, the UE 115-e may operate in a connected state (e.g., RRC_Connected) and may be connected to a first cell (on a first absolute radio frequency channel number (ARFCN)). Similarly, at 405-b, the UE 115-f may operate in a connected state and may be connected to the first cell (on the first ARFCN). In some cases, the pair of UEs 115 may share a cooperation link and may accordingly perform smart carrier selection while in the connected state. In such cases, the pair of UEs 115 may perform one or more tasks to complete smart carrier selection. A first task of the one or more tasks may include moving either the anchor UE 115 or the companion UE 115 to an updated cell in response to both UEs being on a same frequency (as described below with reference to FIG. 4). A second task of the one or more tasks may include ensuring that the anchor UE 115 and the companion UE 115 are on different frequencies in response to either UE 115 participating in a handover to establish a connection with a target cell (as described with reference to FIGS. 5A and 5B). In one example, the anchor UE 115 may be on a first frequency, and the companion UE 115 may participate in a handover to establish a connection with a target cell, changing from a second frequency to a third frequency on the target cell. In such an example, the smart carrier selection procedure may include ensuring that the third frequency is not the same as the first frequency.

At 410, the UE 115-e may transmit a cooperation measurement configuration message to the UE 115-f. The cooperation measurement configuration message may include one or more parameters or conditions associated with measuring frequencies at each UE 115. The UE 115-e and the UE 115-f may measure a respective set of frequencies based on the one or more parameters or conditions. The UE 115-e may configure the companion UE, via the cooperation measurement configuration message, to report measurements (e.g., radio resource management (RRM) measurements) according to a periodicity or based on an event. Thus, the cooperation measurement configuration message may also indicate a period (in the case of periodic reporting) or based on an event (in the case of event reporting, as described with reference to FIG. 3).

At 415-a, the UE 115-e may perform measurements on a serving cell of the UE 115-e. At 420-a, the UE 115-e may perform measurements on inter-frequency cells associated with the UE 115-e (e.g., if the UE 115-e is thus configured by an associated network). Similarly, at 415-b, the UE 115-f may perform measurements on a serving cell of the UE 115-f. At 420-b, the UE 115-f may perform measurements on inter-frequency cells associated with the UE 115-f.

At 425, the UE 115-e may receive a cooperation measurement report message from the UE 115-f. The cooperation measurement report message may indicate a set of measurements (e.g., RSRP, RSRQ, signal to interference and noise ratio (SINR)) of the serving cell of the UE 115-f. The cooperation measurement report message may also include a list of inter-frequencies (e.g., ARFCNs) that are measured, and may indicate, for each inter-frequency of the list, a threshold (e.g., highest) RSRP, a threshold RSRQ, and a threshold SINR across all cells on the respective inter-frequency.

At 430, the UE 115-e may decide whether to disadvantage the first ARFCN or to request the UE 115-f to disadvantage the first ARFCN. The ARFCN disadvantage decision may be based on a combination of information in the cooperation measurement report message and information associated with frequencies measured at the UE 115-e. Further, the ARFCN disadvantage decision may be based on aspects similar to aspects related to the cell reselection decision, described with reference to FIG. 3. At 435, the UE 115-e may optionally disadvantage the first ARFCN (e.g., after determining to do so at 430), and may thus establish a connection with a cell associated with a second ARFCN.

At 440, the UE 115-e may transmit a cooperation ARFCN disadvantage request message to the UE 115-f. The cooperation ARFCN disadvantage request message may indicate that the UE 115-f is to disadvantage a particular ARFCN based on the decision of the UE 115-f at 430. For example, if the UE 115-e determined to disadvantage the first ARFCN (and established a connection with the cell associated with the second ARFCN), the cooperation ARFCN disadvantage request message may indicate that the UE 115-f is to disadvantage the second ARFCN. If the UE 115-e determined to request the UE 115-f to disadvantage the first ARFCN, the cooperation ARFCN disadvantage request message may indicate that the UE 115-f is to disadvantage the first ARFCN. Thus, at 445, the UE 115-f may disadvantage the first ARFCN according to the request and may establish a connection with a cell on the second ARFCN (or a third ARFCN, based on the measurements at 420-b). For example, the UE 115-f may perform an RRC reestablishment procedure to connect to a cell the second ARFCN (or the third ARFCN). As an illustrative example, a UE 115 may disadvantage a given ARFCN by applying offsets to measurements on a serving cell associated with the UE 115 and on associated inter-frequency cells to control respective quality values (e.g., RSRP, RSRQ) in the report.

In any case, at 450, the UE 115-e may receive a second cooperation measurement report message from the UE 115-f. The second cooperation measurement report message may indicate one or more measurements associated with the ARFCN associated with the UE 115-f (e.g., the first ARFCN, the second ARFCN, or the third ARFCN). The second cooperation measurement report message may indicate successful reception of the cooperation ARFCN disadvantage request, and may further indicate that the UE 115-f successfully disadvantaged the first ARFCN, or successfully remained on the first ARFCN, as applicable.

In some implementations, a wireless communications system (e.g., the wireless communications system 200, as described with reference to FIG. 2) may support means to control how a cooperating UE 115 may avoid camping on a cell which is on the same frequency as a supporting UE 115 of the cooperating UE 115 (e.g., according to the process flow 400). For example, the cooperating UE 115 may request inter-frequency measurements from the supporting UE 115. Based on the inter-frequency measurements, the cooperating UE 115 may request the supporting UE to disadvantage a frequency in a measurement report corresponding to the inter-frequency measurements. In some cases, a UE 115 may report, to a network entity 105, information associated with its peer UE 115 (e.g., a companion UE 115 if the UE 115 is an anchor UE 115, or an anchor UE 115 if the UE 115 is a companion UE 115), such as a cell radio network temporary identifier (C-RNTI) of the peer UE 115, an ARFCN of a serving cell of the peer UE 115, and a PCI of the serving cell of the peer UE 115. The network entity 105 may manage cell reselection of the UEs 115 based on the information. For example, the network entity 105 may manage inter-frequency handover of one of the UEs 115, allocation of different bandwidth parts (BWPs) for each UE 115, frequency division multiplexing (FDM) of the UEs 115, or similar procedures.

In some cases, a cooperating UE 115 may request a network entity 105 to configure or to release inter-frequency measurements through an RRC message (e.g., a “UE assistance information” message). In response, the network entity 105 may transmit signaling that indicates one or more frequency-specific offsets such as a cooperation offset parameter (e.g., OffsetMO_Cooperation) that the cooperating UE 115 may use when evaluating measurement report triggering events. For example, if the cooperating UE 115 determines not to disadvantage a first frequency, the cooperating UE 115 may use a non-cooperation offset parameter (e.g., offsetMO). If the cooperating UE 115 determines to disadvantage a second frequency, the cooperating UE 115 may use the cooperation offset parameter (e.g., Ofn). For example, in some cases, a UE 115 may compare a signal quality of a serving cell with a signal quality of a neighboring cell. The UE 115 may choose to enter (e.g., switch to) a carrier on a neighboring cell if a signal quality (or level) of the neighboring cell is higher than a signal quality of a serving cell. Thus, in some implementations, the UE 115 may apply the cooperation offset parameter to the signal quality of a carrier on the neighboring cell or the signal quality of a carrier on the serving cell to disadvantage a particular frequency. That is, a UE 115 may artificially offset the signal quality value of a frequency to disadvantage that frequency.

FIG. 5A shows an example of a process flow 500 that supports smart carrier selection for cooperating wireless devices in accordance with one or more aspects of the present disclosure. The process flow 500 includes a UE 115-g, a UE 115-h, and a network entity 105-c, which may be examples of the corresponding devices as described with respect to FIGS. 1-4. In the following description of the process flow 500, the operations between the UE 115-g, the UE 115-h, and the network entity 105-c may be performed in a different order than the example order shown. Some operations may also be omitted from the process flow 500, and other operations may be added to the process flow 500. Further, although some operations or signaling may be shown to occur at different times for discussion purposes, these operations may actually occur at the same time. In the following description, one of the UE 115-g and the UE 115-h may operate as an anchor UE 115 (which hosts an application), and the other may operate as a companion UE (which supports the application). In some cases, either the anchor UE or the companion UE may manage the operations of the process flow 500 (e.g., the smart carrier selection). In some examples as described herein, a “frequency” may refer to a “carrier” and vice versa.

At 505-a, the UE 115-g may operate in a connected state (e.g., RRC_Connected) and may be connected to a first cell (on a first ARFCN). Similarly, at 505-b, the UE 115-h may operate in a connected state and may be connected to a second cell (on a second ARFCN). In some cases, the pair of UEs 115 may share a cooperation link and may accordingly perform smart carrier selection while in the connected state. In such cases, the pair of UEs 115 may perform one or more tasks to accomplish smart carrier selection (e.g., as described with reference to FIG. 4). In FIG. 5A, the pair of UEs 115 may perform smart carrier selection in response to a handover at the UE 115-g (e.g., the anchor UE).

At 510, the UE 115-g may transmit, to the network entity 105-c, an RRC measurement report. The RRC measurement report may indicate measurement information associated with a third cell (and a third ARFCN). At 515, the network entity 105-c may transmit, to the UE 115-g and in response to the RRC measurement report, an RRC reconfiguration. The RRC reconfiguration may indicate a handover procedure, for the UE 115-g to establish a connection with the third cell (e.g., based on the RRC measurement report).

At 520, in response to the RRC reconfiguration, the UE 115-g may establish the connection to the third cell (e.g., through the handover procedure indicated in the RRC reconfiguration). Accordingly, at 525, the UE 115-g may transmit, to the network entity 105-c, a message that indicates an RRC reconfiguration completion (e.g., that the handover procedure was successful).

At 530, in response to the handover procedure, the UE 115-g may transmit a disadvantage request (e.g., a cooperation ARFCN disadvantage request) to the UE 115-h. The disadvantage request may indicate that the UE 115-h is to disadvantage the carrier (e.g., the ARFCN) newly associated with the UE 115-g. In some cases, the disadvantage request may be an example of the cooperation ARFCN disadvantage request as described with reference to FIG. 4. The UE 115-h may respond accordingly. For example, the UE 115-h may disadvantage a carrier indicated in the disadvantage request and may thus avoid being on a same frequency as the UE 115-g after the handover procedure (e.g., as described with reference to FIG. 4).

FIG. 5B illustrates an example of a process flow 501 that supports smart carrier selection for cooperating wireless devices in accordance with one or more aspects of the present disclosure. The process flow 501 includes a UE 115-i, a UE 115-j, and a network entity 105-d, which may be examples of the corresponding devices as described with respect to FIGS. 1-5A. In the following description of the process flow 501, the operations between the UE 115-i, the UE 115-j, and the network entity 105-d may be performed in a different order than the example order shown. Some operations may also be omitted from the process flow 501, and other operations may be added to the process flow 501. Further, although some operations or signaling may be shown to occur at different times for discussion purposes, these operations may actually occur at the same time. In the following description, one of the UE 115-i and the UE 115-j may operate as an anchor UE 115 (which hosts an application), and the other may operate as a companion UE (which supports the application). In some cases, either the anchor UE or the companion UE may manage the operations of the process flow 501 (e.g., the smart carrier selection). In some examples as described herein, a “frequency” may refer to a “carrier” and vice versa.

At 535-a, the UE 115-i may operate in a connected state (e.g., RRC_Connected) and may be connected to a first cell (on a first ARFCN). Similarly, at 535-b, the UE 115-j may operate in a connected state and may be connected to a second cell (on a second ARFCN). In some cases, the pair of UEs 115 may share a cooperation link and may accordingly perform smart carrier selection while in the connected state. In such cases, the pair of UEs 115 may perform one or more tasks to accomplish smart carrier selection (e.g., as described with reference to FIG. 4). In FIG. 5B, the pair of UEs 115 may perform smart carrier selection in response to a handover at the UE 115-j (e.g., the companion UE).

At 540, the UE 115-j may transmit, to the network entity 105-d, an RRC measurement report. The RRC measurement report may indicate measurement information associated with a third cell (and a third ARFCN). At 545, the network entity 105-d may transmit, to the UE 115-j and in response to the RRC measurement report, an RRC reconfiguration. The RRC reconfiguration may indicate a handover procedure, for the UE 115-j to establish a connection with the third cell (e.g., based on the RRC measurement report).

At 550, in response to the RRC reconfiguration, the UE 115-j may establish the connection to the third cell (e.g., through the handover procedure indicated in the RRC reconfiguration). Accordingly, at 555, the UE 115-j may transmit, to the network entity 105-d, a message that indicates an RRC reconfiguration completion (e.g., that the handover procedure was successful).

At 560, in response to the handover procedure, the UE 115-j may transmit a cooperation measurement report to the UE 115-i. The cooperation measurement report may indicate an updated set of measurements associated with the updated cell and ARFCN (e.g., the third cell and the third ARFCN). In some cases, the cooperation measurement report may be an example of the cooperation measurement report as described with reference to FIG. 4. The UE 115-i may respond accordingly. For example, the UE 115-i may disadvantage a carrier indicated in the cooperation measurement report and may thus avoid being on a same frequency as the UE 115-j after the handover procedure (e.g., as described with reference to FIG. 4). The techniques described in FIGS. 5A and 5B are further applicable to other mobility scenarios where the UEs 115 are in a connected state (e.g., conditional handover, RRC Re-establishment procedure, or the like).

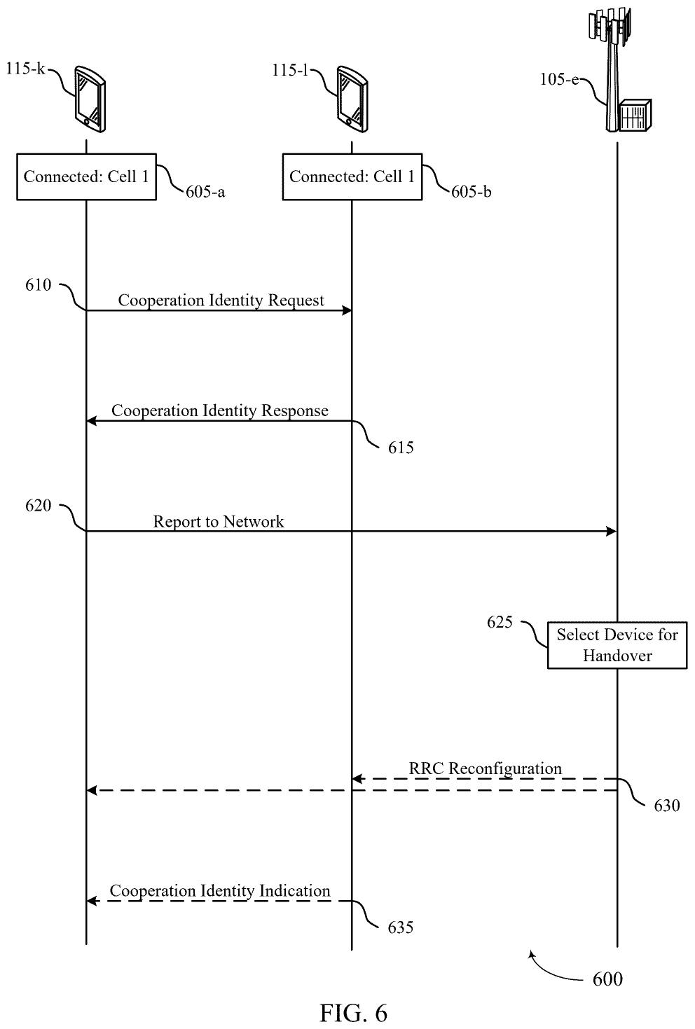

FIG. 6 shows an example of a process flow 600 that supports smart carrier selection for cooperating wireless devices in accordance with one or more aspects of the present disclosure. The process flow 600 includes a UE 115-k, a UE 115-l, and a network entity 105-e, which may be examples of the corresponding devices as described with respect to FIGS. 1-5B. In the following description of the process flow 600, the operations between the UE 115-k, the UE 115-l, and the network entity 105-e may be performed in a different order than the example order shown. Some operations may also be omitted from the process flow 600, and other operations may be added to the process flow 600. Further, although some operations or signaling may be shown to occur at different times for discussion purposes, these operations may actually occur at the same time. In the following description, one of the UE 115-k and the UE 115-l may operate as an anchor UE 115 (which hosts an application), and the other may operate as a companion UE (which supports the application). In some cases, either the anchor UE or the companion UE may manage the operations of the process flow 600 (e.g., the smart carrier selection). In some examples as described herein, a “frequency” may refer to a “carrier” and vice versa.

At 605-a, the UE 115-k may operate in a connected state (e.g., RRC_Connected) and may be connected to a first cell (on a first ARFCN). Similarly, at 605-b, the UE 115-l may operate in a connected state and may be connected to the first cell (on the first ARFCN). In some cases, the pair of UEs 115 may share a cooperation link and may accordingly perform smart carrier selection while in the connected state. In such cases, the pair of UEs 115 may perform one or more tasks to complete smart carrier selection (e.g., as described with reference to FIG. 4). In some examples (e.g., as described below), a network entity 105 (e.g., the network entity 105-e) may participate in the one or more tasks to perform the smart carrier selection.

At 610, the UE 115-k may transmit a cooperation identity request to the UE 115-l. The cooperation identity request may indicate a request for the UE 115-l to report information associated with the UE 115-l such as an ARFCN and a PCI of a serving cell of the UE 115-l, and a C-RNTI associated with the UE 115-l. At 615, the UE 115-l may transmit, to the UE 115-k, a cooperation identity response which indicates the requested information (e.g., the ARFCN and the PCI associated with the serving cell, and the C-RNTI of the UE 115-l). At 620, the UE 115-k may transmit a report to the network entity 105-e. The report may indicate the information received from the UE 115-l.

At 625, the network entity 105-e may select a device (e.g., a UE 115) for a handover procedure (since the UEs are connected to the same cell and ARFCN). In some cases, the network entity 105-e may select the device based on the report received at 620. For example, if the network entity 105-e determines that the UE 115-k would have better signal quality than the UE 115-l on a given neighboring frequency, the network entity 105-e may select the UE 115-l for the handover procedure. Accordingly, at 630, the network entity 105-e may transmit an RRC reconfiguration to the selected device (e.g., the UE 115-l in the example) to initiate the handover procedure.

At 635, if the UE 115-l participates in a handover procedure to an updated cell (and an updated ARFCN), the UE 115-l may transmit a cooperation identity indication to the UE 115-k. The cooperation identity indication may include updated values associated with the updated cell (e.g., an updated ARFCN and an updated PCI associated with the updated cell, and an updated C-RNTI associated with the UE 115-l). That is, whenever the UE 115-l (e.g., the companion UE) connects to an updated cell (e.g., through handover, RRC reestablishment, or both), the UE 115-l may transmit a cooperation identity indication message to report these updated values.

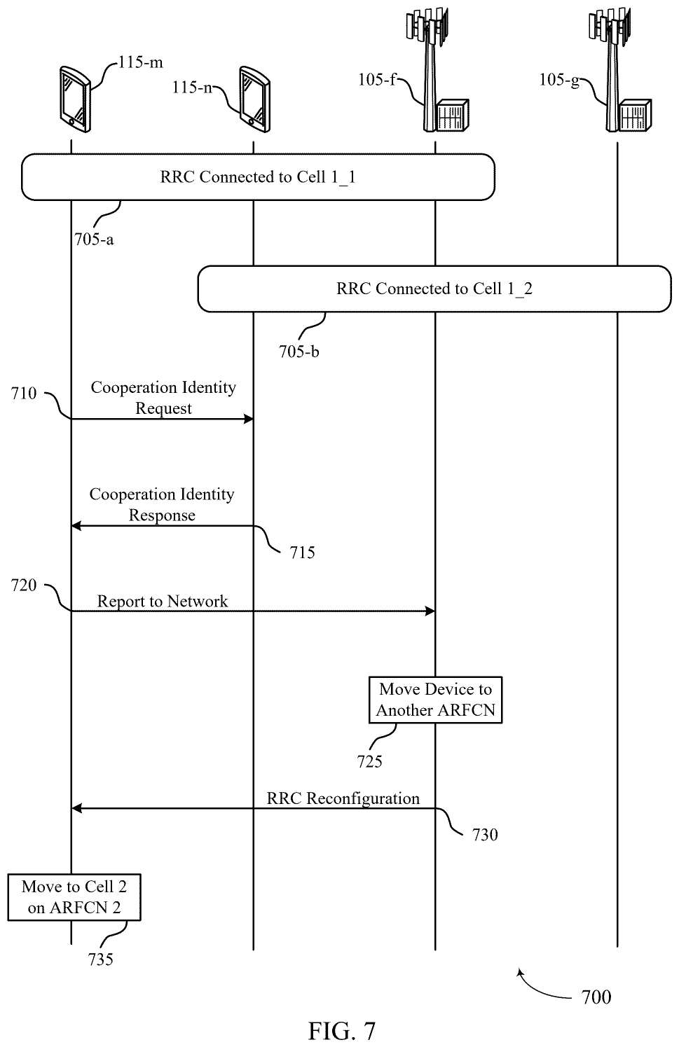

FIG. 7 shows an example of a process flow 700 that supports smart carrier selection for cooperating wireless devices in accordance with one or more aspects of the present disclosure. The process flow 700 includes a UE 115-m, a UE 115-n, a network entity 105-f, and a network entity 105-g, which may be examples of the corresponding devices as described with respect to FIGS. 1-5B. In the following description of the process flow 700, the operations between the UE 115-m, the UE 115-n, the network entity 105-f, and the network entity 105-g may be performed in a different order than the example order shown. Some operations may also be omitted from the process flow 700, and other operations may be added to the process flow 700. Further, although some operations or signaling may be shown to occur at different times for discussion purposes, these operations may actually occur at the same time. In the following description, one of the UE 115-m and the UE 115-n may operate as an anchor UE 115 (which hosts an application), and the other may operate as a companion UE (which supports the application). In some cases, either the anchor UE or the companion UE may manage the operations of the process flow 700 (e.g., the smart carrier selection). In some examples as described herein, a “frequency” may refer to a “carrier” and vice versa.

At 705-a, the UE 115-m may operate in a connected state (e.g., RRC_Connected) and may be connected to a first cell (e.g., cell 1_1). The network entity 105-f may serve the first cell. For example, the UE 115-m connected to the first cell may be associated with a first PCI (e.g., PCI_1_1), a first ARFCN (e.g., ARFCN_1), and a first C-RNTI (C-RNTI_a1_1). Similarly, at 705-b, the UE 115-n may operate in a connected state and may be connected to a second cell (e.g., cell 1_2). The network entity 105-g may serve the second cell. For example, the UE 115-n connected to the second cell may be associated with a second PCI (e.g., PCI_1_2), the first ARFCN or a second ARFCN (e.g., ARFCN_1 or ARFCN_2), and a second C-RNTI (C-RNTI_c1_2). In some cases, the pair of UEs 115 may share a cooperation link and may accordingly perform smart carrier selection while in the connected state. In such cases, the pair of UEs 115 may perform one or more tasks to complete smart carrier selection (e.g., as described with reference to FIG. 4). In some examples (e.g., as described below), one or more network entities 105 (e.g., the network entity 105-f, the network entity 105-g, or both) may participate in the one or more tasks to perform the smart carrier selection.

At 710, the UE 115-m may transmit a cooperation identity request to the UE 115-n. The cooperation identity request may indicate a request for the UE 115-n to report information associated with a serving cell of the UE 115-n (e.g., the cell 1_2) such as an ARFCN and a PCI. The information may also include a C-RNTI associated with the UE 115-n. At 715, the UE 115-n may transmit, to the UE 115-m, a cooperation identity response which indicates the requested information (e.g., the ARFCN, the PCI, and the C-RNTI). At 720, the UE 115-m may transmit a report to the network entity 105-f. The report may indicate the information received from the UE 115-n. In some examples, the report may further indicate similar information associated with the UE 115-m (e.g., the ARFCN and the PCI associated with the serving cell, and the C-RNTI of the UE 115-m). In some examples, the UE 115-m may transmit the report through an RRC message, a medium access control-control element (MAC-CE) message, a layer 1 uplink control information (UCI) message, or any combination thereof.

At 725, the network entity 105-f may initiate a move of the UE 115-m (e.g., the anchor UE 115) to an updated ARFCN (e.g., through a handover procedure) based on the report (e.g., received at 720). At 730, the network entity 105-e may transmit an RRC reconfiguration message to the UE 115-m (e.g., as part of the handover procedure). At 735, the UE 115-m may move to a cell (e.g., cell 2) on an updated ARFCN (e.g., ARFCN_2). For example, the UE 115-m may perform a handover procedure or an RRC reconfiguration procedure to move to the cell on the updated ARFCN.

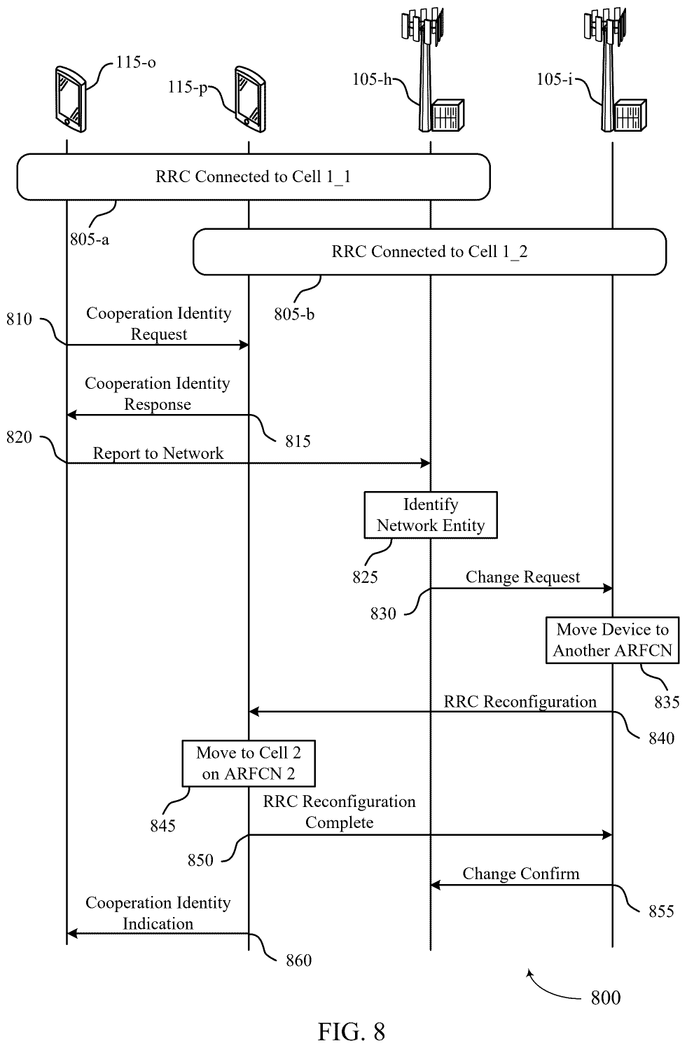

FIG. 8 shows an example of a process flow 800 that supports smart carrier selection for cooperating wireless devices in accordance with one or more aspects of the present disclosure. The process flow 800 includes a UE 115-o, a UE 115-p, a network entity 105-h, and a network entity 105-i, which may be examples of the corresponding devices as described with respect to FIGS. 1-5B. In the following description of the process flow 800, the operations between the UE 115-o, the UE 115-p, the network entity 105-h, and the network entity 105-i may be performed in a different order than the example order shown. Some operations may also be omitted from the process flow 800, and other operations may be added to the process flow 800. Further, although some operations or signaling may be shown to occur at different times for discussion purposes, these operations may actually occur at the same time. In the following description, one of the UE 115-o and the UE 115-p may operate as an anchor UE 115 (which hosts an application), and the other may operate as a companion UE (which supports the application). In some cases, either the anchor UE or the companion UE may manage the operations of the process flow 800 (e.g., the smart carrier selection). In some examples as described herein, a “frequency” may refer to a “carrier” and vice versa.

At 805-a, the UE 115-o may operate in a connected state (e.g., RRC_Connected) and may be connected to a first cell (e.g., cell 1_1). The network entity 105-h may serve the first cell. For example, the UE 115-o connected to the first cell may be associated with a first PCI (e.g., PCI_1_1), a first ARFCN (e.g., ARFCN_1), and a first C-RNTI (C-RNTI_a1_1). Similarly, at 805-b, the UE 115-n may operate in a connected state and may be connected to a second cell (e.g., cell 1_2). The network entity 105-i may serve the second cell. For example, the UE 115-p connected to the second cell may be associated with a second PCI (e.g., PCI_1_2), the first ARFCN or a second ARFCN (e.g., ARFCN_1 or ARFCN_2), and a second C-RNTI (C-RNTI_c1_2). In some cases, the pair of UEs 115 may share a cooperation link and may accordingly perform smart carrier selection while in the connected state. In such cases, the pair of UEs 115 may perform one or more tasks to complete smart carrier selection (e.g., as described with reference to FIG. 4). In some examples (e.g., as described below), one or more network entities 105 (e.g., the network entity 105-h, the network entity 105-i, or both) may participate in the one or more tasks to perform the smart carrier selection.

At 810, the UE 115-o may transmit a cooperation identity request to the UE 115-p. The cooperation identity request may indicate a request for the UE 115-p to report information associated with a serving cell of the UE 115-p (e.g., the cell 1_2) such as an ARFCN and a PCI. The information may also include a C-RNTI associated with the UE 115-p. At 815, the UE 115-p may transmit, to the UE 115-o, a cooperation identity response which indicates the requested information (e.g., the ARFCN, the PCI, and the C-RNTI). At 820, the UE 115-o may transmit a report to the network entity 105-h. The report may indicate the information received from the UE 115-p. In some examples, the report may further indicate similar information associated with the UE 115-o (e.g., the ARFCN and the PCI associated with the serving cell, and the C-RNTI of the UE 115-o). In some examples, the UE 115-o may transmit the report through an RRC message, a medium access control-control element (MAC-CE) message, a layer 1 uplink control information (UCI) message, or any combination thereof.

At 825, the network entity 105-h may identify the network entity 105-i that controls the UE 115-p (e.g., based on the report received at 820). At 830, the network entity 105-h may transmit a change request to the network entity 105-i (e.g., an Xn-Application Protocol (Xn-AP) change request). The change request may request the network entity 105-i to move one of its UEs (e.g., the UE 115-p) to another ARFCN. The change request may indicate information such as a C-RNTI of the UE 115-p, and the ARFCN and the PCI of the current serving cell of the UE 115-p.

At 835, the network entity 105-i may initiate a move of the UE 115-p (e.g., the companion UE 115) to an updated ARFCN (e.g., through a handover procedure) based on the change request (e.g., received at 730). At 840, the network entity 105-i may transmit an RRC reconfiguration message to the UE 115-p (e.g., as part of the handover procedure). At 845, the UE 115-p may move to a cell (e.g., cell 2) on an updated ARFCN (e.g., ARFCN_2). For example, the UE 115-p may perform a handover procedure, an RRC reconfiguration procedure, or both, to move to the cell on the updated ARFCN. At 850, the UE 115-p may transmit a message to the network entity 105-i, indicating that the UE 115-p successfully moved to the cell on the updated ARFCN. Then, at 855, the network entity 105-i may transmit a change confirm message (e.g., an Xn-AP ARFCN change confirm message) to the network entity 105-h indicating that the UE 115-p changed to the cell on the updated ARFCN (e.g., confirming the outcome of the procedure). In some cases, the change confirm message may include an outcome of the procedure (e.g., the handover procedure or the RRC reconfiguration procedure), a new C-RNTI of the UE 115-p (that was moved), and an ARFCN and a PCI of the updated serving cell of the UE 115-p.

At 860, the UE 115-p may transmit a cooperation identity indication to the UE 115-o. The cooperation identity indication may include updated values associated with the cell that the UE 115-p moved to (e.g., an updated ARFCN and an updated PCI associated with the updated cell, and an updated C-RNTI associated with the UE 115-p). That is, whenever the UE 115-p (e.g., the companion UE) connects to an updated cell (e.g., through handover, RRC reestablishment, or both), the UE 115-l may transmit, to the UE 115-o (e.g., the anchor UE), a cooperation identity indication message to report these updated values.

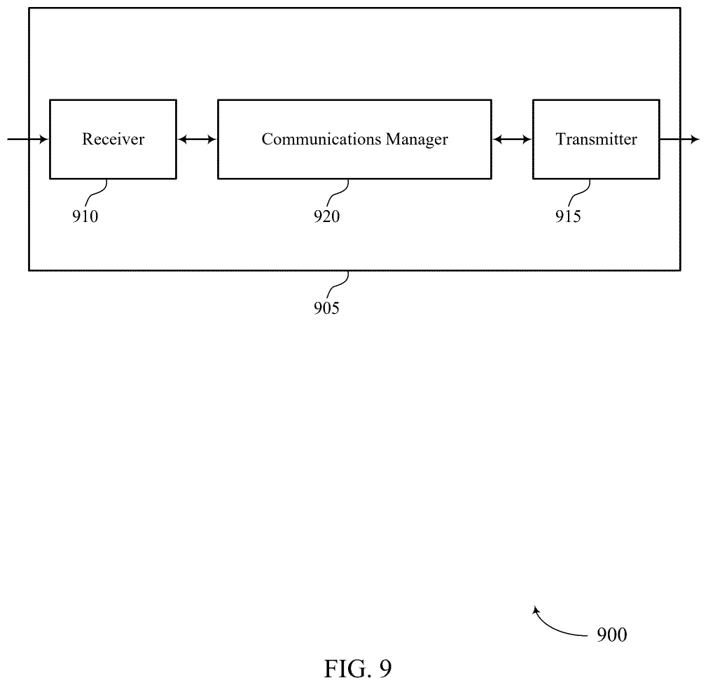

FIG. 9 shows a block diagram 900 of a device 905 that supports smart carrier selection for cooperating wireless devices in accordance with one or more aspects of the present disclosure. The device 905 may be an example of aspects of an anchor wireless device as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to smart carrier selection for cooperating wireless devices). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to smart carrier selection for cooperating wireless devices). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of smart carrier selection for cooperating wireless devices as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for establishing a cooperative communication link with a companion wireless device for direct communication with the companion wireless device and indirect communication with a network entity. The communications manager 920 is capable of, configured to, or operable to support a means for exchanging, with the companion wireless device via the cooperative communication link in accordance with a cooperative carrier selection process, messages that cause a first Uu communication link to be configured with a first carrier and a second Uu communication link to be configured with a second carrier, where the first carrier is associated with a first frequency different from a second frequency associated with the second carrier, where the first Uu communication link enables communication between the anchor wireless device and the network entity and the second Uu communication link enables communication between the companion wireless device and the network entity. The communications manager 920 is capable of, configured to, or operable to support a means for communicating, in accordance with the cooperative communication link, with the companion wireless device via the cooperative communication link and with the network entity via the first Uu communication link.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for smart carrier selection for cooperating wireless devices, which may result in reduced processing, reduced power consumption, and more efficient utilization of communication resources, among other advantages.

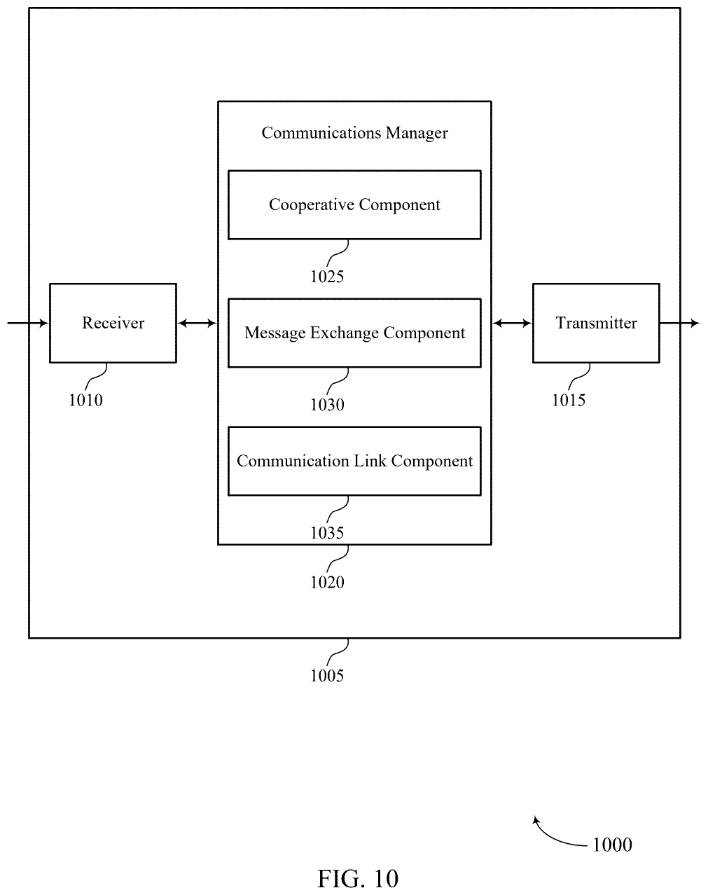

FIG. 10 shows a block diagram 1000 of a device 1005 that supports smart carrier selection for cooperating wireless devices in accordance with one or more aspects of the present disclosure. The device 1005 may be an example of aspects of a device 905 or an anchor UE 115 (e.g., anchor wireless device) as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to smart carrier selection for cooperating wireless devices). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to smart carrier selection for cooperating wireless devices). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of smart carrier selection for cooperating wireless devices as described herein. For example, the communications manager 1020 may include a cooperative component 1025, a message exchange component 1030, a communication link component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The cooperative component 1025 is capable of, configured to, or operable to support a means for establishing a cooperative communication link with a companion wireless device for direct communication with the companion wireless device and indirect communication with a network entity. The message exchange component 1030 is capable of, configured to, or operable to support a means for exchanging, with the companion wireless device via the cooperative communication link in accordance with a cooperative carrier selection process, messages that cause a first Uu communication link to be configured with a first carrier and a second Uu communication link to be configured with a second carrier, where the first carrier is associated with a first frequency different from a second frequency associated with the second carrier, where the first Uu communication link enables communication between the anchor wireless device and the network entity and the second Uu communication link enables communication between the companion wireless device and the network entity. The communication link component 1035 is capable of, configured to, or operable to support a means for communicating, in accordance with the cooperative communication link, with the companion wireless device via the cooperative communication link and with the network entity via the first Uu communication link.

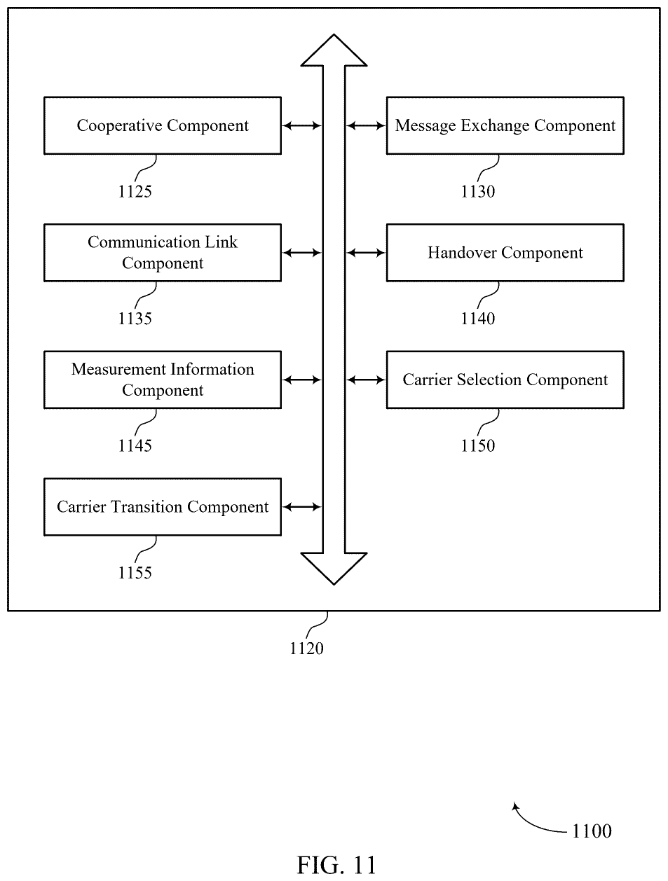

FIG. 11 shows a block diagram 1100 of a communications manager 1120 that supports smart carrier selection for cooperating wireless devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of smart carrier selection for cooperating wireless devices as described herein. For example, the communications manager 1120 may include a cooperative component 1125, a message exchange component 1130, a communication link component 1135, a handover component 1140, a measurement information component 1145, a carrier selection component 1150, a carrier transition component 1155, or any combination thereof. Each of these components, or components or subcomponents thereof (e.g., one or more processors, one or more memories), may communicate, directly or indirectly, with one another (e.g., via one or more buses).

The communications manager 1120 may support wireless communication in accordance with examples as disclosed herein. The cooperative component 1125 is capable of, configured to, or operable to support a means for establishing a cooperative communication link with a companion wireless device for direct communication with the companion wireless device and indirect communication with a network entity. The message exchange component 1130 is capable of, configured to, or operable to support a means for exchanging, with the companion wireless device via the cooperative communication link in accordance with a cooperative carrier selection process, messages that cause a first Uu communication link to be configured with a first carrier and a second Uu communication link to be configured with a second carrier, where the first carrier is associated with a first frequency different from a second frequency associated with the second carrier, where the first Uu communication link enables communication between the anchor wireless device and the network entity and the second Uu communication link enables communication between the companion wireless device and the network entity. The communication link component 1135 is capable of, configured to, or operable to support a means for communicating, in accordance with the cooperative communication link, with the companion wireless device via the cooperative communication link and with the network entity via the first Uu communication link.

In some examples, to support exchanging the messages in accordance with the cooperative carrier selection process, the message exchange component 1130 is capable of, configured to, or operable to support a means for transmitting, while in an idle connection state with the network entity, a first message that indicates a measurement and reporting configuration for the companion wireless device. In some examples, to support exchanging the messages in accordance with the cooperative carrier selection process, the message exchange component 1130 is capable of, configured to, or operable to support a means for receiving a second message that includes a report indicative of inter-frequency measurement information in accordance with the measurement and reporting configuration.

In some examples, the measurement and reporting configuration corresponds to a set of channel measurements on different frequencies and to periodic or event-triggered reporting of information indicative of the set of channel measurements.

In some examples, the inter-frequency measurement information is indicative of a SSB frequency and a PCI associated with the companion wireless device, one or more quality measurements associated with the SSB frequency, a list of other SSB frequencies not associated with the PCI, corresponding quality measurements associated with each of the list of other SSB frequencies, or any combination thereof.

In some examples, to support exchanging the messages in accordance with the cooperative carrier selection process, the message exchange component 1130 is capable of, configured to, or operable to support a means for transmitting, to the companion wireless device and based on the inter-frequency measurement information, a third message that indicates the second carrier.

In some examples, to support exchanging the messages in accordance with the cooperative carrier selection process, the carrier selection component 1150 is capable of, configured to, or operable to support a means for selecting, based on the inter-frequency measurement information, the first carrier. In some examples, to support exchanging the messages in accordance with the cooperative carrier selection process, the message exchange component 1130 is capable of, configured to, or operable to support a means for transmitting, to the companion wireless device, a third message that indicates one or more carriers that are not to be associated with the second Uu communication link, where the one or more carriers includes the first carrier.

In some examples, to support exchanging the messages in accordance with the cooperative carrier selection process, the message exchange component 1130 is capable of, configured to, or operable to support a means for transmitting, while in a connected connection state with the network entity, a first message that indicates a measurement and reporting configuration for the companion wireless device. In some examples, to support exchanging the messages in accordance with the cooperative carrier selection process, the message exchange component 1130 is capable of, configured to, or operable to support a means for receiving a second message that includes a first report indicative of first inter-frequency measurement information in accordance with the measurement and reporting configuration.

In some examples, the measurement and reporting configuration corresponds to channel measurements on a serving cell and on one or more neighboring cells and to periodic or event-triggered reporting of information indicative of the channel measurements. In some examples, the one or more neighboring cells are on one or more respective carriers different from a carrier of the serving cell.

In some examples, the first inter-frequency measurement information is indicative of one or more quality measurements associated with a same carrier, a list of other frequencies not associated with the same carrier, corresponding highest quality measurements associated with each of the list of other frequencies, or any combination thereof.

In some examples, to support exchanging the messages in accordance with the cooperative carrier selection process, the message exchange component 1130 is capable of, configured to, or operable to support a means for transmitting, to the companion wireless device and based on the first inter-frequency measurement information and on second inter-frequency measurement information associated with the anchor wireless device, a third message that indicates that the first carrier is to be disadvantaged for the companion wireless device. In some examples, to support exchanging the messages in accordance with the cooperative carrier selection process, the message exchange component 1130 is capable of, configured to, or operable to support a means for receiving a fourth message that includes a second report indicative of updated first inter-frequency measurement information that is associated with the second carrier based on the first carrier being disadvantaged for the companion wireless device by the third message.

In some examples, to support exchanging the messages in accordance with the cooperative carrier selection process, the carrier selection component 1150 is capable of, configured to, or operable to support a means for disadvantaging the second carrier at the anchor wireless device based on the first inter-frequency measurement information and on second inter-frequency measurement information associated with the anchor wireless device. In some examples, to support exchanging the messages in accordance with the cooperative carrier selection process, the carrier transition component 1155 is capable of, configured to, or operable to support a means for transitioning to the first carrier for the first Uu communication link based on the second carrier being disadvantaged. In some examples, to support exchanging the messages in accordance with the cooperative carrier selection process, the message exchange component 1130 is capable of, configured to, or operable to support a means for transmitting, to the companion wireless device, a third message that indicates that the first carrier is to be disadvantaged for the companion wireless device. In some examples, to support exchanging the messages in accordance with the cooperative carrier selection process, the message exchange component 1130 is capable of, configured to, or operable to support a means for receiving a fourth message that includes a second report indicative of updated first inter-frequency measurement information that is associated with the second carrier based on the first carrier being disadvantaged for the companion wireless device by the third message.

In some examples, to support exchanging the messages in accordance with the cooperative carrier selection process, the handover component 1140 is capable of, configured to, or operable to support a means for participating in a handover procedure that results in establishment by the anchor wireless device of a third Uu communication link configured with a third carrier. In some examples, to support exchanging the messages in accordance with the cooperative carrier selection process, the message exchange component 1130 is capable of, configured to, or operable to support a means for transmitting, to the companion wireless device and based on establishment of the third Uu communication link configured with the third carrier, a third message that indicates that the third carrier is to be disadvantaged for the companion wireless device.

In some examples, the measurement information component 1145 is capable of, configured to, or operable to support a means for receiving, from the companion wireless device after a handover procedure associated with the companion wireless device and based on establishment of a third Uu communication link configured with a third carrier for the companion wireless device, a third message that indicates a report indicative of inter-frequency measurement information that is associated with the third carrier.

In some examples, to support exchanging the messages in accordance with the cooperative carrier selection process, the measurement information component 1145 is capable of, configured to, or operable to support a means for transmitting, to the network entity, an RRC message that indicates a request to configure or to release inter-frequency measurement procedures. In some examples, to support exchanging the messages in accordance with the cooperative carrier selection process, the carrier selection component 1150 is capable of, configured to, or operable to support a means for receiving, from the network entity, an indication of one or more frequency-specific offsets that are usable by the anchor wireless device to disadvantage selection of the first carrier as a result of a measurement report triggering event.

In some examples, to support exchanging the messages in accordance with the cooperative carrier selection process, the message exchange component 1130 is capable of, configured to, or operable to support a means for transmitting, to the companion wireless device, a first message that indicates a request to report cooperation identity information associated with the companion wireless device. In some examples, to support exchanging the messages in accordance with the cooperative carrier selection process, the message exchange component 1130 is capable of, configured to, or operable to support a means for receive, from the companion wireless device and based on the first message, a first report indicative of the cooperation identity information associated with the companion wireless device, where the cooperation identity information is indicative of an ARFCN associated with the companion wireless device, a PCI that corresponds to the ARFCN, and a cell-radio network temporary identifier (C-RNTI) associated with the companion wireless device.

In some examples, the message exchange component 1130 is capable of, configured to, or operable to support a means for transmitting, to the network entity, a second message that indicates the cooperation identity information associated with the companion wireless device.

In some examples, the handover component 1140 is capable of, configured to, or operable to support a means for receiving, from the network entity, an RRC reconfiguration message that indicates that the anchor wireless device is to participate in a handover procedure that results in establishment by the anchor wireless device of a third Uu communication link configured with a third carrier. In some examples, the handover component 1140 is capable of, configured to, or operable to support a means for participating in the handover procedure to establish the third Uu communication link configured with the third carrier based on the RRC reconfiguration message.

In some examples, the second message is an RRC message, a medium access control-control element (MAC-CE) message, or a layer 1 uplink control information (UCI) message.

In some examples, to support exchanging the messages in accordance with the cooperative carrier selection process, the message exchange component 1130 is capable of, configured to, or operable to support a means for receiving, from the companion wireless device, a second report indicative of updated cooperation identity information associated with the companion wireless device, where the updated cooperation identity information includes a second ARFCN associated with the companion wireless device, a second PCI that corresponds to the second ARFCN, and a second C-RNTI associated with the companion wireless device.

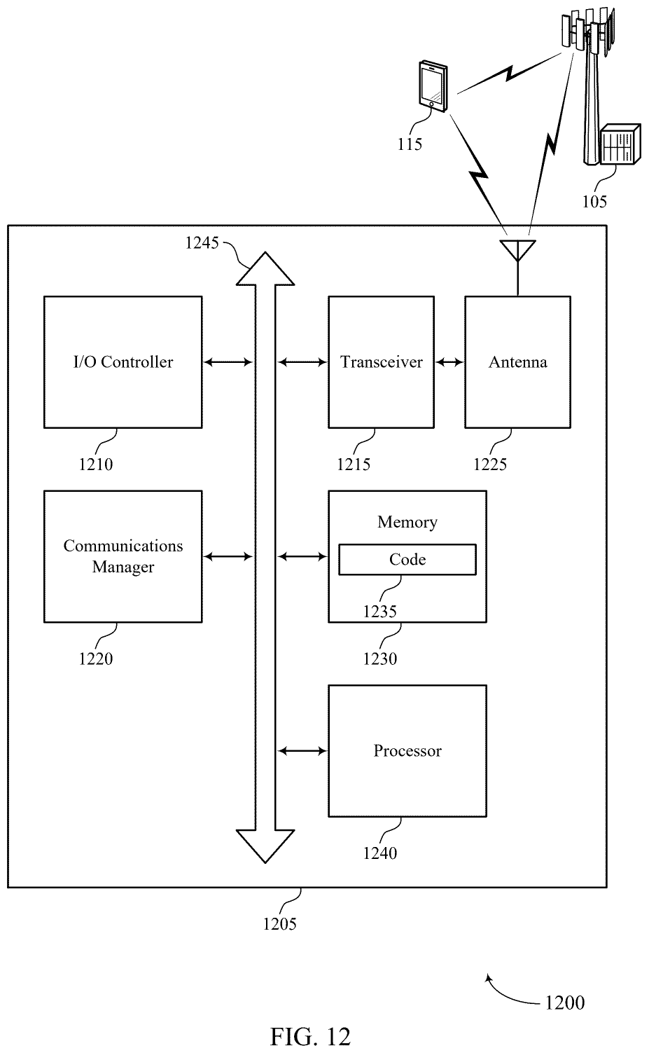

FIG. 12 shows a diagram of a system 1200 including a device 1205 that supports smart carrier selection for cooperating wireless devices in accordance with one or more aspects of the present disclosure. The device 1205 may be an example of or include components of a device 905, a device 1005, or an anchor wireless device as described herein. The device 1205 may include components for bi-directional voice and data communications including components for transmitting and receiving communications, such as a communications manager 1220, an I/O controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include RAM and ROM. The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a BIOS which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting smart carrier selection for cooperating wireless devices). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communication in accordance with examples as disclosed herein. For example, the communications manager 1220 is capable of, configured to, or operable to support a means for establishing a cooperative communication link with a companion wireless device for direct communication with the companion wireless device and indirect communication with a network entity. The communications manager 1220 is capable of, configured to, or operable to support a means for exchanging, with the companion wireless device via the cooperative communication link in accordance with a cooperative carrier selection process, messages that cause a first Uu communication link to be configured with a first carrier and a second Uu communication link to be configured with a second carrier, where the first carrier is associated with a first frequency different from a second frequency associated with the second carrier, where the first Uu communication link enables communication between the anchor wireless device and the network entity and the second Uu communication link enables communication between the companion wireless device and the network entity. The communications manager 1220 is capable of, configured to, or operable to support a means for communicating, in accordance with the cooperative communication link, with the companion wireless device via the cooperative communication link and with the network entity via the first Uu communication link.

By including or configuring the communications manager 1220 in accordance with examples as described herein, the device 1205 may support techniques for smart carrier selection for cooperating wireless devices, which may result in improved communication reliability, reduced latency, improved user experience related to reduced processing, reduced power consumption, more efficient utilization of communication resources, improved coordination between devices, improved utilization of processing capability, increased throughput, higher rank, higher data rates, among other advantages.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of smart carrier selection for cooperating wireless devices as described herein, or the at least one processor 1240 and the at least one memory 1230 may be otherwise configured to, individually or collectively, perform or support such operations.

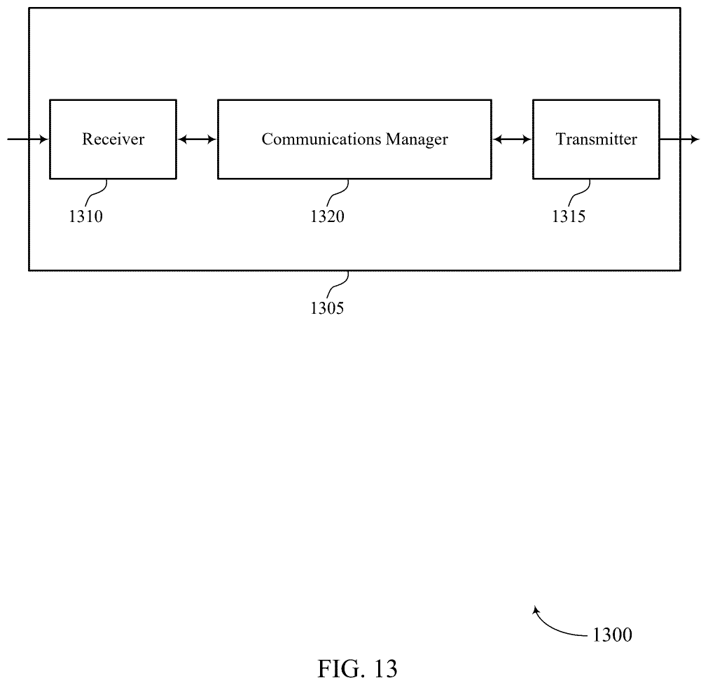

FIG. 13 shows a block diagram 1300 of a device 1305 that supports smart carrier selection for cooperating wireless devices in accordance with one or more aspects of the present disclosure. The device 1305 may be an example of aspects of a companion wireless device as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to smart carrier selection for cooperating wireless devices). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to smart carrier selection for cooperating wireless devices). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations or components thereof may be examples of means for performing various aspects of smart carrier selection for cooperating wireless devices as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication in accordance with examples as disclosed herein. For example, the communications manager 1320 is capable of, configured to, or operable to support a means for establishing a cooperative communication link with an anchor wireless device, where the companion wireless device is configured to receive first information via a first Uu communication link of the companion wireless device, and transmit, according to a forwarding scheme and via the cooperative communication link, second information to the anchor wireless device, where the second information is associated with the first information, and where the first Uu communication link enables communication between the companion wireless device and a network entity and a second Uu communication link enables communication between the anchor wireless device and the network entity. The communications manager 1320 is capable of, configured to, or operable to support a means for exchanging, with the anchor wireless device via the cooperative communication link in accordance with a cooperative carrier selection process, messages that cause the first Uu communication link to be configured with a first carrier and the second Uu communication link to be configured with a second carrier, where the first carrier is associated with a first frequency different from a second frequency associated with the second carrier. The communications manager 1320 is capable of, configured to, or operable to support a means for communicating, in accordance with the cooperative communication link and the forwarding scheme, with the anchor wireless device via the cooperative communication link and with the network entity via the first Uu communication link.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for smart carrier selection for cooperating wireless devices, which may result in reduced processing, reduced power consumption, and more efficient utilization of communication resources, among other advantages.

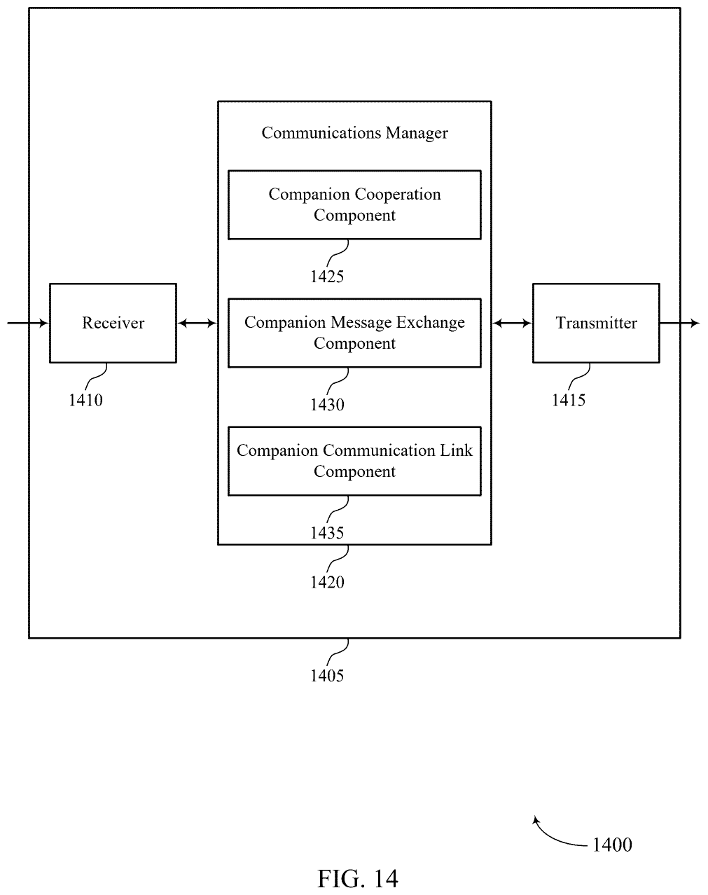

FIG. 14 shows a block diagram 1400 of a device 1405 that supports smart carrier selection for cooperating wireless devices in accordance with one or more aspects of the present disclosure. The device 1405 may be an example of aspects of a device 1305 or a companion UE 115 (e.g., a companion wireless device) as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for receiving information such as packets, user data, control information, or any combination thereof associated with various information channels (e.g., control channels, data channels, information channels related to smart carrier selection for cooperating wireless devices). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to smart carrier selection for cooperating wireless devices). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of smart carrier selection for cooperating wireless devices as described herein. For example, the communications manager 1420 may include a companion cooperation component 1425, a companion message exchange component 1430, a companion communication link component 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication in accordance with examples as disclosed herein. The companion cooperation component 1425 is capable of, configured to, or operable to support a means for establishing a cooperative communication link with an anchor wireless device, where the companion wireless device is configured to receive first information via a first Uu communication link of the companion wireless device, and transmit, according to a forwarding scheme and via the cooperative communication link, second information to the anchor wireless device, where the second information is associated with the first information, and where the first Uu communication link enables communication between the companion wireless device and a network entity and a second Uu communication link enables communication between the anchor wireless device and the network entity. The companion message exchange component 1430 is capable of, configured to, or operable to support a means for exchanging, with the anchor wireless device via the cooperative communication link in accordance with a cooperative carrier selection process, messages that cause the first Uu communication link to be configured with a first carrier and the second Uu communication link to be configured with a second carrier, where the first carrier is associated with a first frequency different from a second frequency associated with the second carrier. The companion communication link component 1435 is capable of, configured to, or operable to support a means for communicating, in accordance with the cooperative communication link and the forwarding scheme, with the anchor wireless device via the cooperative communication link and with the network entity via the first Uu communication link.

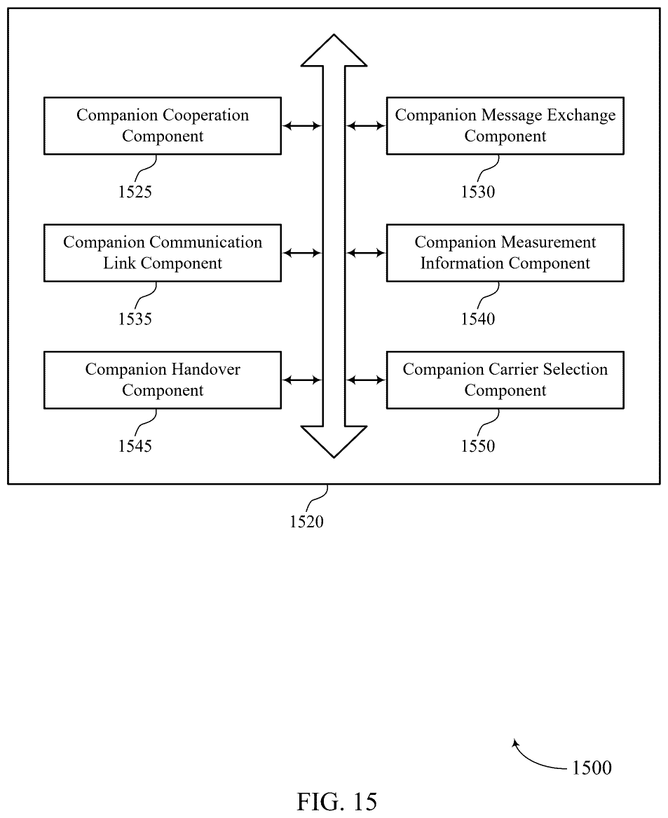

FIG. 15 shows a block diagram 1500 of a communications manager 1520 that supports smart carrier selection for cooperating wireless devices in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of smart carrier selection for cooperating wireless devices as described herein. For example, the communications manager 1520 may include a companion cooperation component 1525, a companion message exchange component 1530, a companion communication link component 1535, a companion measurement information component 1540, a companion handover component 1545, a companion carrier selection component 1550, or any combination thereof. Each of these components, or components or subcomponents thereof (e.g., one or more processors, one or more memories), may communicate, directly or indirectly, with one another (e.g., via one or more buses).

The communications manager 1520 may support wireless communication in accordance with examples as disclosed herein. The companion cooperation component 1525 is capable of, configured to, or operable to support a means for establishing a cooperative communication link with an anchor wireless device, where the companion wireless device is configured to receive first information via a first Uu communication link of the companion wireless device, and transmit, according to a forwarding scheme and via the cooperative communication link, second information to the anchor wireless device, where the second information is associated with the first information, and where the first Uu communication link enables communication between the companion wireless device and a network entity and a second Uu communication link enables communication between the anchor wireless device and the network entity. The companion message exchange component 1530 is capable of, configured to, or operable to support a means for exchanging, with the anchor wireless device via the cooperative communication link in accordance with a cooperative carrier selection process, messages that cause the first Uu communication link to be configured with a first carrier and the second Uu communication link to be configured with a second carrier, where the first carrier is associated with a first frequency different from a second frequency associated with the second carrier. The companion communication link component 1535 is capable of, configured to, or operable to support a means for communicating, in accordance with the cooperative communication link and the forwarding scheme, with the anchor wireless device via the cooperative communication link and with the network entity via the first Uu communication link.

In some examples, to support exchanging the messages in accordance with the cooperative carrier selection process, the companion message exchange component 1530 is capable of, configured to, or operable to support a means for receiving, while in an idle connection state with the network entity, a first message that indicates a measurement and reporting configuration for the companion wireless device. In some examples, to support exchanging the messages in accordance with the cooperative carrier selection process, the companion measurement information component 1540 is capable of, configured to, or operable to support a means for generating, based on the measurement and reporting configuration, inter-frequency measurement information that includes channel measurements on one or more frequencies. In some examples, to support exchanging the messages in accordance with the cooperative carrier selection process, the companion message exchange component 1530 is capable of, configured to, or operable to support a means for transmitting a second message that includes a report indicative of the inter-frequency measurement information in accordance with the measurement and reporting configuration.

In some examples, the measurement and reporting configuration corresponds to channel measurements on different frequencies and periodic or event-triggered reporting of information indicative of the channel measurements.

In some examples, the inter-frequency measurement information is indicative of a synchronization signal block (SSB) frequency and a PCI associated with the companion wireless device, one or more quality measurements associated with the SSB frequency, a list of other SSB frequencies not associated with the PCI, corresponding quality measurements associated with each of the list of other SSB frequencies, or any combination thereof.

In some examples, to support exchanging the messages in accordance with the cooperative carrier selection process, the companion message exchange component 1530 is capable of, configured to, or operable to support a means for receiving, from the anchor wireless device and based on the inter-frequency measurement information, a third message that indicates the second carrier. In some examples, to support exchanging the messages in accordance with the cooperative carrier selection process, the companion carrier selection component 1550 is capable of, configured to, or operable to support a means for selecting, based on the third message, the first carrier; and.

In some examples, to support exchanging the messages in accordance with the cooperative carrier selection process, the companion message exchange component 1530 is capable of, configured to, or operable to support a means for receiving, from the anchor wireless device, a third message that indicates one or more carriers that are not to be associated with the first Uu communication link, where the one or more carriers includes the second carrier.

In some examples, to support exchanging the messages in accordance with the cooperative carrier selection process, the companion message exchange component 1530 is capable of, configured to, or operable to support a means for receiving, while in a connected connection state with the network entity, a first message that indicates a measurement and reporting configuration for the companion wireless device. In some examples, to support exchanging the messages in accordance with the cooperative carrier selection process, the companion message exchange component 1530 is capable of, configured to, or operable to support a means for transmitting a second message that includes a first report indicative of first inter-frequency measurement information in accordance with the measurement and reporting configuration.

In some examples, the measurement and reporting configuration corresponds to channel measurements on a serving cell and on one or more neighboring cells and to periodic or event-triggered reporting of information indicative of the channel measurements. In some examples, the one or more neighboring cells are on one or more respective carriers different from a carrier of the serving cell.

In some examples, the first inter-frequency measurement information is indicative of one or more quality measurements associated with a same carrier, a list of other frequencies not associated with the same carrier, corresponding highest quality measurements associated with each of the list of other frequencies, or any combination thereof.

In some examples, to support exchanging the messages in accordance with the cooperative carrier selection process, the companion message exchange component 1530 is capable of, configured to, or operable to support a means for receiving, from the anchor wireless device, a third message that indicates that the second carrier is to be disadvantaged for the companion wireless device. In some examples, to support exchanging the messages in accordance with the cooperative carrier selection process, the companion message exchange component 1530 is capable of, configured to, or operable to support a means for transmitting a fourth message that includes a second report indicative of updated first inter-frequency measurement information that is associated with the first carrier based on the second carrier being disadvantaged for the companion wireless device by the third message.

In some examples, to support exchanging the messages in accordance with the cooperative carrier selection process, the companion message exchange component 1530 is capable of, configured to, or operable to support a means for receiving, from the anchor wireless device, a third message that indicates that the second carrier is to be disadvantaged for the companion wireless device, where a same carrier is the first carrier. In some examples, to support exchanging the messages in accordance with the cooperative carrier selection process, the companion message exchange component 1530 is capable of, configured to, or operable to support a means for transmitting a fourth message that includes a second report indicative of updated first inter-frequency measurement information that is associated with the first carrier based on the second carrier being disadvantaged for the companion wireless device by the third message.

In some examples, the companion message exchange component 1530 is capable of, configured to, or operable to support a means for receiving, from the anchor wireless device after a handover procedure associated with the anchor wireless device and based on establishment of a third Uu communication link configured with a third carrier for the anchor wireless device, a third message that indicates that the third carrier is to be disadvantaged for the companion wireless device.

In some examples, the companion handover component 1545 is capable of, configured to, or operable to support a means for participating in a handover procedure that results in establishment by the companion wireless device of a third Uu communication link configured with a third carrier. In some examples, the companion message exchange component 1530 is capable of, configured to, or operable to support a means for transmitting, to the anchor wireless device and based on establishment of the third Uu communication link configured with the third carrier, a third message that indicates a report indicative of inter-frequency measurement information that is associated with the third carrier.

In some examples, to support exchanging the messages in accordance with the cooperative carrier selection process, the companion message exchange component 1530 is capable of, configured to, or operable to support a means for receiving, via an SIB message or an RRC release message, an indication of one or more frequency-specific offsets, one or more frequency-specific priorities, or both, that are usable by the companion wireless device to disadvantage one or more frequencies.

In some examples, the companion carrier selection component 1550 is capable of, configured to, or operable to support a means for using, while in an idle connection state with the network entity, the one or more frequency-specific offsets or the one or more frequency-specific priorities to disadvantage the second carrier.

In some examples, to support exchanging the messages in accordance with the cooperative carrier selection process, the companion message exchange component 1530 is capable of, configured to, or operable to support a means for transmitting, to the network entity, an RRC message that indicates a request to configure or to release inter-frequency measurement procedures. In some examples, to support exchanging the messages in accordance with the cooperative carrier selection process, the companion message exchange component 1530 is capable of, configured to, or operable to support a means for receiving, from the network entity, an indication of one or more frequency-specific offsets that are usable by the companion wireless device to disadvantage selection of the second carrier as a result of a measurement report triggering event.

In some examples, to support exchanging the messages in accordance with the cooperative carrier selection process, the companion message exchange component 1530 is capable of, configured to, or operable to support a means for receiving, from the anchor wireless device, a first message that indicates a request to report cooperation identity information associated with the companion wireless device. In some examples, to support exchanging the messages in accordance with the cooperative carrier selection process, the companion message exchange component 1530 is capable of, configured to, or operable to support a means for transmitting, to the anchor wireless device and based on the first message, a first report indicative of the cooperation identity information associated with the companion wireless device, where the cooperation identity information is indicative of an ARFCN associated with the companion wireless device, a PCI that corresponds to the ARFCN, and a C-RNTI associated with the companion wireless device.

In some examples, the companion message exchange component 1530 is capable of, configured to, or operable to support a means for receiving, from the network entity, an RRC reconfiguration message that indicates that the companion wireless device is to participate in a handover procedure that results in establishment by the companion wireless device of a third Uu communication link configured with a third carrier. In some examples, the companion handover component 1545 is capable of, configured to, or operable to support a means for participating in the handover procedure to establish the third Uu communication link configured with the third carrier based on the RRC reconfiguration message.

In some examples, the companion message exchange component 1530 is capable of, configured to, or operable to support a means for transmitting, to the network entity, a second message that indicates that the handover procedure to establish the third Uu communication link configured with the third carrier is complete.

In some examples, to support exchanging the messages in accordance with the cooperative carrier selection process, the companion message exchange component 1530 is capable of, configured to, or operable to support a means for transmitting, to the anchor wireless device, a second report indicative of updated cooperation identity information associated with the companion wireless device, where the updated cooperation identity information includes a second ARFCN associated with the companion wireless device, a second PCI that corresponds to the second ARFCN, and a second C-RNTI associated with the companion wireless device.

In some examples, the first information and the second information include same information.

In some examples, the first information and the second information include different information.

In some examples, the forwarding scheme includes an amplify and forward scheme.

In some examples, the forwarding scheme includes a decode and forward scheme.

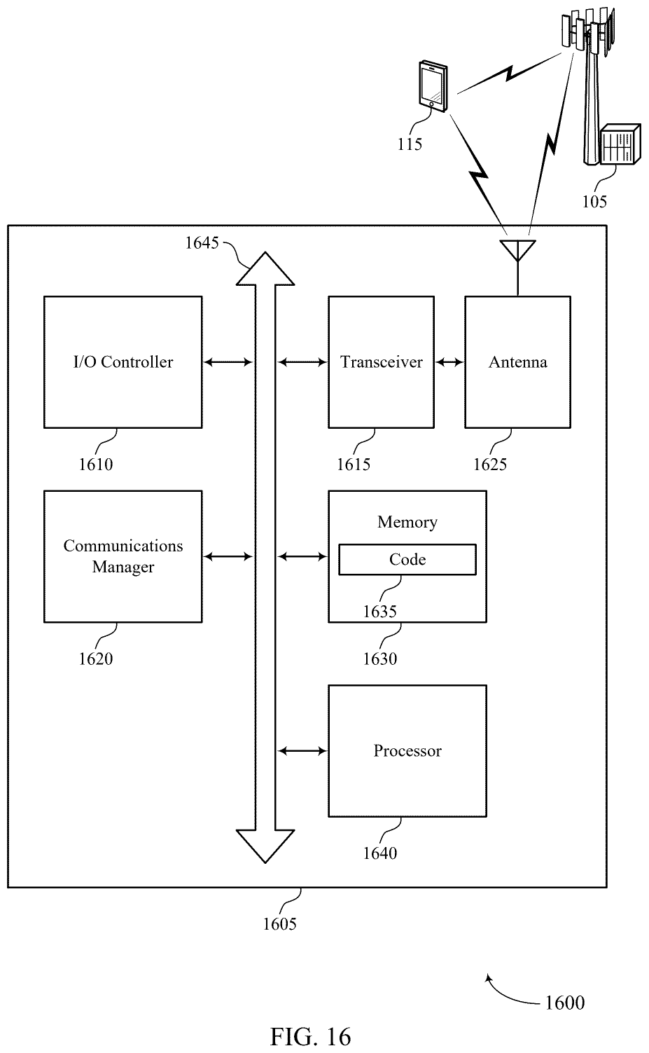

FIG. 16 shows a diagram of a system 1600 including a device 1605 that supports smart carrier selection for cooperating wireless devices in accordance with one or more aspects of the present disclosure. The device 1605 may be an example of or include components of a device 1305, a device 1405, or a companion wireless device as described herein. The device 1605 may include components for bi-directional voice and data communications including components for transmitting and receiving communications, such as a communications manager 1620, an I/O controller, such as an I/O controller 1610, a transceiver 1615, one or more antennas 1625, at least one memory 1630, code 1635, and at least one processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally, or alternatively, the I/O controller 1610 may represent or interact with a modem, a keyboard, a mouse, a touchscreen, or a similar device. In some cases, the I/O controller 1610 may be implemented as part of one or more processors, such as the at least one processor 1640. In some cases, a user may interact with the device 1605 via the I/O controller 1610 or via hardware components controlled by the I/O controller 1610.

In some cases, the device 1605 may include a single antenna. However, in some other cases, the device 1605 may have more than one antenna, which may be capable of concurrently transmitting or receiving multiple wireless transmissions. The transceiver 1615 may communicate bi-directionally via the one or more antennas 1625 using wired or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The at least one memory 1630 may include RAM and ROM. The at least one memory 1630 may store computer-readable, computer-executable, or processor-executable code, such as the code 1635. The code 1635 may include instructions that, when executed by the at least one processor 1640, cause the device 1605 to perform various functions described herein. The code 1635 may be stored in a non-transitory computer-readable medium such as system memory or another type of memory. In some cases, the code 1635 may not be directly executable by the at least one processor 1640 but may cause a computer (e.g., when compiled and executed) to perform functions described herein. In some cases, the at least one memory 1630 may include, among other things, a BIOS which may control basic hardware or software operation such as the interaction with peripheral components or devices.

The at least one processor 1640 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1640 may be configured to operate a memory array using a memory controller. In some other cases, a memory controller may be integrated into the at least one processor 1640. The at least one processor 1640 may be configured to execute computer-readable instructions stored in a memory (e.g., the at least one memory 1630) to cause the device 1605 to perform various functions (e.g., functions or tasks supporting smart carrier selection for cooperating wireless devices). For example, the device 1605 or a component of the device 1605 may include at least one processor 1640 and at least one memory 1630 coupled with or to the at least one processor 1640, the at least one processor 1640 and the at least one memory 1630 configured to perform various functions described herein.

In some examples, the at least one processor 1640 may include multiple processors and the at least one memory 1630 may include multiple memories. One or more of the multiple processors may be coupled with one or more of the multiple memories, which may, individually or collectively, be configured to perform various functions described herein. In some examples, the at least one processor 1640 may be a component of a processing system, which may refer to a system (such as a series) of machines, circuitry (including, for example, one or both of processor circuitry (which may include the at least one processor 1640) and memory circuitry (which may include the at least one memory 1630)), or components, that receives or obtains inputs and processes the inputs to produce, generate, or obtain a set of outputs. The processing system may be configured to perform one or more of the functions described herein. For example, the at least one processor 1640 or a processing system including the at least one processor 1640 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code 1635 (e.g., processor-executable code) stored in the at least one memory 1630 or otherwise, to perform one or more of the functions described herein.

The communications manager 1620 may support wireless communication in accordance with examples as disclosed herein. For example, the communications manager 1620 is capable of, configured to, or operable to support a means for establishing a cooperative communication link with an anchor wireless device, where the companion wireless device is configured to receive first information via a first Uu communication link of the companion wireless device, and transmit, according to a forwarding scheme and via the cooperative communication link, second information to the anchor wireless device, where the second information is associated with the first information, and where the first Uu communication link enables communication between the companion wireless device and a network entity and a second Uu communication link enables communication between the anchor wireless device and the network entity. The communications manager 1620 is capable of, configured to, or operable to support a means for exchanging, with the anchor wireless device via the cooperative communication link in accordance with a cooperative carrier selection process, messages that cause the first Uu communication link to be configured with a first carrier and the second Uu communication link to be configured with a second carrier, where the first carrier is associated with a first frequency different from a second frequency associated with the second carrier. The communications manager 1620 is capable of, configured to, or operable to support a means for communicating, in accordance with the cooperative communication link and the forwarding scheme, with the anchor wireless device via the cooperative communication link and with the network entity via the first Uu communication link.

By including or configuring the communications manager 1620 in accordance with examples as described herein, the device 1605 may support techniques for smart carrier selection for cooperating wireless devices, which may result in improved communication reliability, reduced latency, improved user experience related to reduced processing, reduced power consumption, more efficient utilization of communication resources, improved coordination between devices, improved utilization of processing capability, increased throughput, higher rank, higher data rates, among other advantages.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the at least one processor 1640, the at least one memory 1630, the code 1635, or any combination thereof. For example, the code 1635 may include instructions executable by the at least one processor 1640 to cause the device 1605 to perform various aspects of smart carrier selection for cooperating wireless devices as described herein, or the at least one processor 1640 and the at least one memory 1630 may be otherwise configured to, individually or collectively, perform or support such operations.

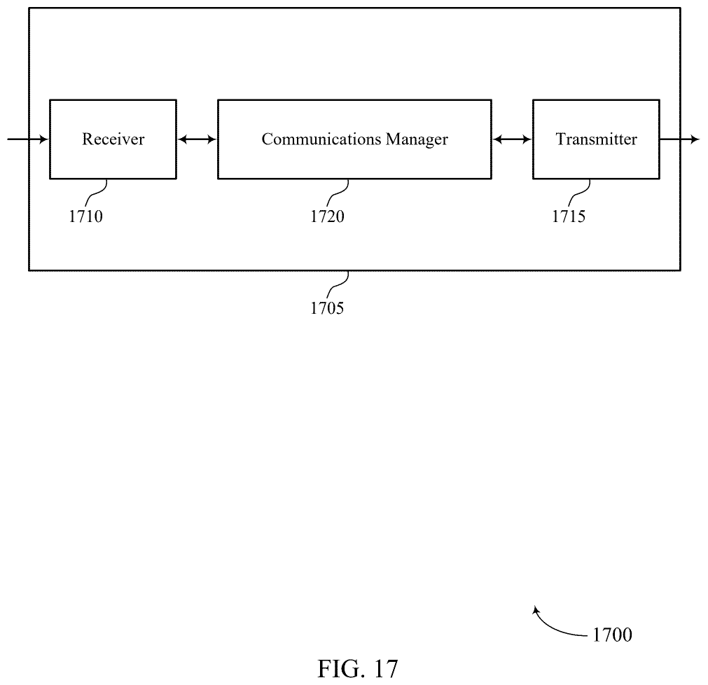

FIG. 17 shows a block diagram 1700 of a device 1705 that supports smart carrier selection for cooperating wireless devices in accordance with one or more aspects of the present disclosure. The device 1705 may be an example of aspects of a network entity 105 as described herein. The device 1705 may include a receiver 1710, a transmitter 1715, and a communications manager 1720. The device 1705, or one or more components of the device 1705 (e.g., the receiver 1710, the transmitter 1715, the communications manager 1720), may include at least one processor, which may be coupled with at least one memory, to, individually or collectively, support or enable the described techniques. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The communications manager 1720, the receiver 1710, the transmitter 1715, or various combinations or components thereof may be examples of means for performing various aspects of smart carrier selection for cooperating wireless devices as described herein. For example, the communications manager 1720, the receiver 1710, the transmitter 1715, or various combinations or components thereof may be capable of performing one or more of the functions described herein.

In some examples, the communications manager 1720, the receiver 1710, the transmitter 1715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1720, the receiver 1710, the transmitter 1715, or various combinations or components thereof may be implemented in code (e.g., as communications management software or firmware) executed by at least one processor (e.g., referred to as a processor-executable code). If implemented in code executed by at least one processor, the functions of the communications manager 1720, the receiver 1710, the transmitter 1715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1720 may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communication in accordance with examples as disclosed herein. For example, the communications manager 1720 is capable of, configured to, or operable to support a means for outputting, to an anchor wireless device connected via a cooperative communication link with a companion wireless device, an indication of one or more frequency-specific offsets that are usable by the anchor wireless device to disadvantage selection of a carrier in a cooperative carrier selection process that configures a first Uu communication link of the anchor wireless device to be configured with a first carrier and a second Uu communication link of the companion wireless device to be configured with a second carrier that is different from the first carrier, where the first Uu communication link enables communication between the anchor wireless device and the first network entity and the second Uu communication link enables communication between the companion wireless device and the first network entity, and where a cooperative communication link between the anchor wireless device and the companion wireless device enables indirect communication between the anchor wireless device and the first network entity. The communications manager 1720 is capable of, configured to, or operable to support a means for communicating with the anchor wireless device, the companion wireless device, or both, in accordance with a forwarding scheme.

By including or configuring the communications manager 1720 in accordance with examples as described herein, the device 1705 (e.g., at least one processor controlling or otherwise coupled with the receiver 1710, the transmitter 1715, the communications manager 1720, or a combination thereof) may support techniques for smart carrier selection for cooperating wireless devices, which may result in reduced processing, reduced power consumption, and more efficient utilization of communication resources, among other advantages.

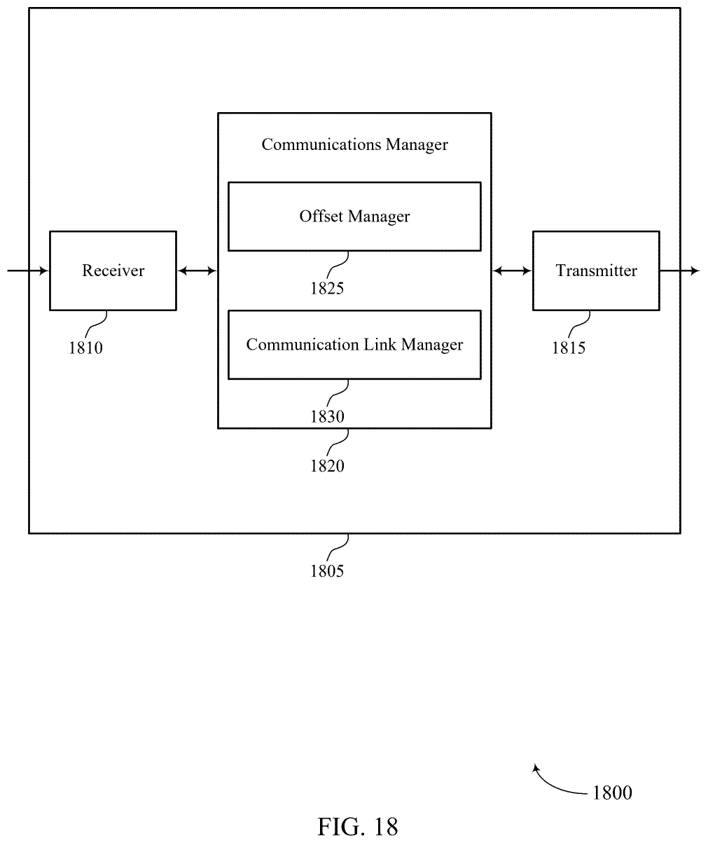

FIG. 18 shows a block diagram 1800 of a device 1805 that supports smart carrier selection for cooperating wireless devices in accordance with one or more aspects of the present disclosure. The device 1805 may be an example of aspects of a device 1705 or a network entity 105 as described herein. The device 1805 may include a receiver 1810, a transmitter 1815, and a communications manager 1820. The device 1805, or one or more components of the device 1805 (e.g., the receiver 1810, the transmitter 1815, the communications manager 1820), may include at least one processor, which may be coupled with at least one memory, to support the described techniques. Each of these components may be in communication with one another (e.g., via one or more buses).

The receiver 1810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1805. In some examples, the receiver 1810 may support obtaining information by receiving signals via one or more antennas. Additionally, or alternatively, the receiver 1810 may support obtaining information by receiving signals via one or more wired (e.g., electrical, fiber optic) interfaces, wireless interfaces, or any combination thereof.

The transmitter 1815 may provide a means for outputting (e.g., transmitting, providing, conveying, sending) information generated by other components of the device 1805. For example, the transmitter 1815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1815 may support outputting information by transmitting signals via one or more antennas. Additionally, or alternatively, the transmitter 1815 may support outputting information by transmitting signals via one or more wired (e.g., electrical, fiber optic) interfaces, wireless interfaces, or any combination thereof. In some examples, the transmitter 1815 and the receiver 1810 may be co-located in a transceiver, which may include or be coupled with a modem.

The device 1805, or various components thereof, may be an example of means for performing various aspects of smart carrier selection for cooperating wireless devices as described herein. For example, the communications manager 1820 may include an offset manager 1825 a communication link manager 1830, or any combination thereof. The communications manager 1820 may be an example of aspects of a communications manager 1720 as described herein. In some examples, the communications manager 1820, or various components thereof, may be configured to perform various operations (e.g., receiving, obtaining, monitoring, outputting, transmitting) using or otherwise in cooperation with the receiver 1810, the transmitter 1815, or both. For example, the communications manager 1820 may receive information from the receiver 1810, send information to the transmitter 1815, or be integrated in combination with the receiver 1810, the transmitter 1815, or both to obtain information, output information, or perform various other operations as described herein.

The communications manager 1820 may support wireless communication in accordance with examples as disclosed herein. The offset manager 1825 is capable of, configured to, or operable to support a means for outputting, to an anchor wireless device connected via a cooperative communication link with a companion wireless device, an indication of one or more frequency-specific offsets that are usable by the anchor wireless device to disadvantage selection of a carrier in a cooperative carrier selection process that configures a first Uu communication link of the anchor wireless device to be configured with a first carrier and a second Uu communication link of the companion wireless device to be configured with a second carrier that is different from the first carrier, where the first Uu communication link enables communication between the anchor wireless device and the first network entity and the second Uu communication link enables communication between the companion wireless device and the first network entity, and where a cooperative communication link between the anchor wireless device and the companion wireless device enables indirect communication between the anchor wireless device and the first network entity. The communication link manager 1830 is capable of, configured to, or operable to support a means for communicating with the anchor wireless device, the companion wireless device, or both, in accordance with a forwarding scheme.

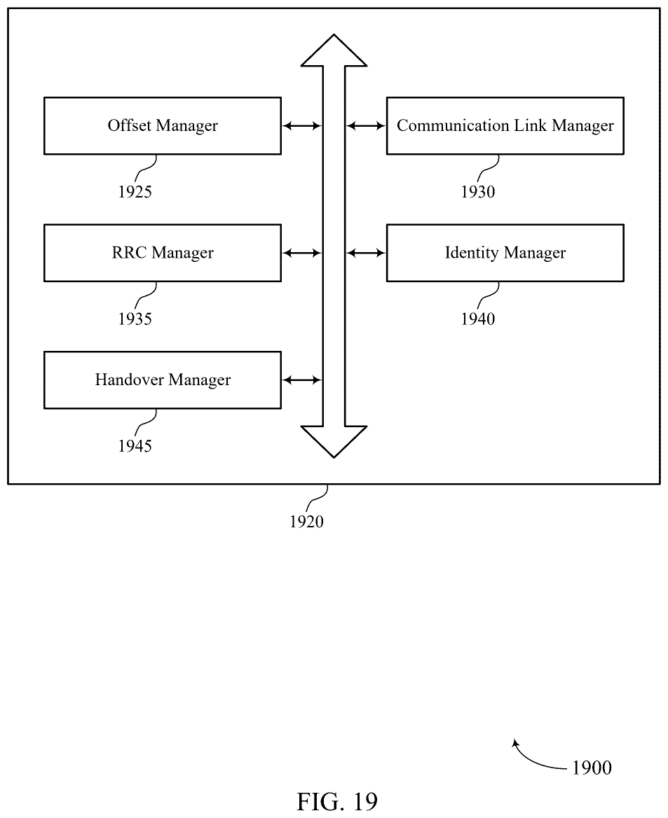

FIG. 19 shows a block diagram 1900 of a communications manager 1920 that supports smart carrier selection for cooperating wireless devices in accordance with one or more aspects of the present disclosure. The communications manager 1920 may be an example of aspects of a communications manager 1720, a communications manager 1820, or both, as described herein. The communications manager 1920, or various components thereof, may be an example of means for performing various aspects of smart carrier selection for cooperating wireless devices as described herein. For example, the communications manager 1920 may include an offset manager 1925, a communication link manager 1930, an RRC manager 1935, an identity manager 1940, a handover manager 1945, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1920 may support wireless communication in accordance with examples as disclosed herein. The offset manager 1925 is capable of, configured to, or operable to support a means for outputting, to an anchor wireless device connected via a cooperative communication link with a companion wireless device, an indication of one or more frequency-specific offsets that are usable by the anchor wireless device to disadvantage selection of a carrier in a cooperative carrier selection process that configures a first Uu communication link of the anchor wireless device to be configured with a first carrier and a second Uu communication link of the companion wireless device to be configured with a second carrier that is different from the first carrier, where the first Uu communication link enables communication between the anchor wireless device and the first network entity and the second Uu communication link enables communication between the companion wireless device and the first network entity, and where a cooperative communication link between the anchor wireless device and the companion wireless device enables indirect communication between the anchor wireless device and the first network entity. The communication link manager 1930 is capable of, configured to, or operable to support a means for communicating with the anchor wireless device, the companion wireless device, or both, in accordance with a forwarding scheme.

In some examples, the RRC manager 1935 is capable of, configured to, or operable to support a means for obtaining, from the anchor wireless device, an RRC message that indicates a request to configure or to release inter-frequency measurement procedures, where the one or more frequency-specific offsets are usable by the anchor wireless device to disadvantage selection of the first carrier as a result of a measurement report triggering event.

In some examples, the identity manager 1940 is capable of, configured to, or operable to support a means for obtaining, from the anchor wireless device, a message that indicates cooperation identity information associated with the companion wireless device, where the cooperation identity information is indicative of an ARFCN associated with the companion wireless device, a PCI that corresponds to the ARFCN, and a C-RNTI associated with the companion wireless device.

In some examples, the RRC manager 1935 is capable of, configured to, or operable to support a means for outputting, to the anchor wireless device, an RRC reconfiguration message that indicates that the anchor wireless device is to participate in a handover procedure that results in establishment by the anchor wireless device of a third Uu communication link configured with a third carrier.

In some examples, the message is an RRC message, a medium access control-control element (MAC-CE) message, or a layer 1 uplink control information (UCI) message.

In some examples, the handover manager 1945 is capable of, configured to, or operable to support a means for obtaining, from a second network entity, a message that includes a request to initiate a handover procedure for the companion wireless device, where the message indicates cooperation identity information associated with the companion wireless device, and where the cooperation identity information is indicative of an ARFCN associated with the companion wireless device, a PCI that corresponds to the ARFCN, and a C-RNTI associated with the companion wireless device. In some examples, the RRC manager 1935 is capable of, configured to, or operable to support a means for outputting, to the companion wireless device, an RRC reconfiguration message that indicates that the companion wireless device is to participate in the handover procedure that results in establishment by the companion wireless device of a third Uu communication link configured with a third carrier.

In some examples, the handover manager 1945 is capable of, configured to, or operable to support a means for obtaining, from the companion wireless device, a second message that indicates that the handover procedure to establish the third Uu communication link configured with the third carrier is complete. In some examples, the handover manager 1945 is capable of, configured to, or operable to support a means for outputting, to the second network entity, a third message that indicates a confirmation of the handover procedure.

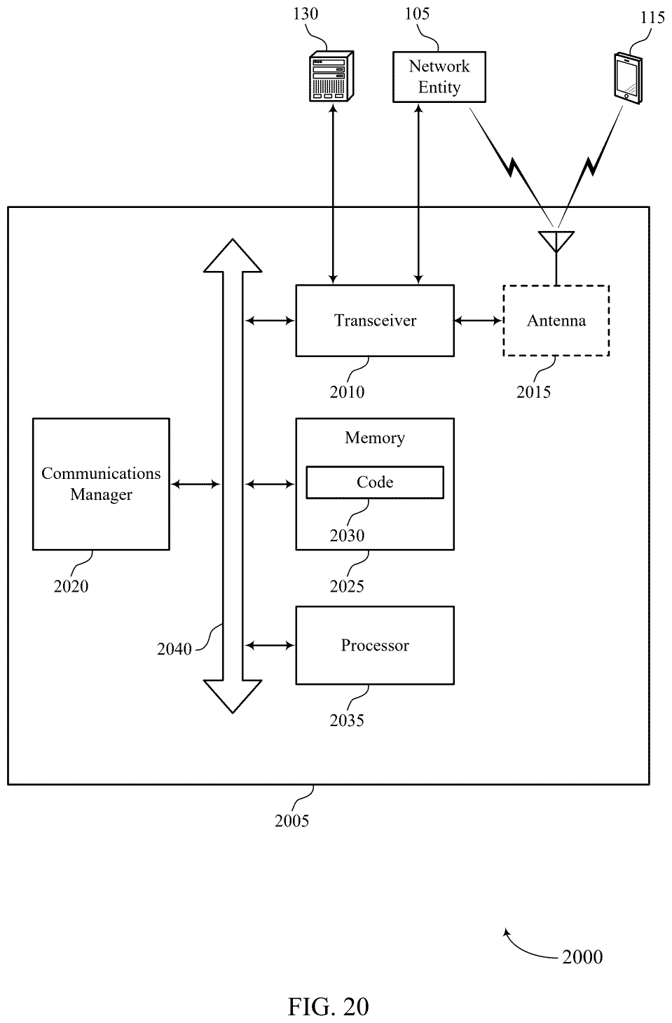

FIG. 20 shows a diagram of a system 2000 including a device 2005 that supports smart carrier selection for cooperating wireless devices in accordance with one or more aspects of the present disclosure. The device 2005 may be an example of or include components of a device 1705, a device 1805, or a network entity 105 as described herein. The device 2005 may communicate with other network devices or network equipment such as one or more of the network entities 105, UEs 115, or any combination thereof. The communications may include communications over one or more wired interfaces, over one or more wireless interfaces, or any combination thereof. The device 2005 may include components that support outputting and obtaining communications, such as a communications manager 2020, a transceiver 2010, one or more antennas 2015, at least one memory 2025, code 2030, and at least one processor 2035. These components may be in electronic communication or otherwise coupled (e.g., operatively, communicatively, functionally, electronically, electrically) via one or more buses (e.g., a bus 2040).

The transceiver 2010 may support bi-directional communications via wired links, wireless links, or both as described herein. In some examples, the transceiver 2010 may include a wired transceiver and may communicate bi-directionally with another wired transceiver. Additionally, or alternatively, in some examples, the transceiver 2010 may include a wireless transceiver and may communicate bi-directionally with another wireless transceiver. In some examples, the device 2005 may include one or more antennas 2015, which may be capable of transmitting or receiving wireless transmissions (e.g., concurrently). The transceiver 2010 may also include a modem to modulate signals, to provide the modulated signals for transmission (e.g., by one or more antennas 2015, by a wired transmitter), to receive modulated signals (e.g., from one or more antennas 2015, from a wired receiver), and to demodulate signals. In some implementations, the transceiver 2010 may include one or more interfaces, such as one or more interfaces coupled with the one or more antennas 2015 that are configured to support various receiving or obtaining operations, or one or more interfaces coupled with the one or more antennas 2015 that are configured to support various transmitting or outputting operations, or a combination thereof. In some implementations, the transceiver 2010 may include or be configured for coupling with one or more processors or one or more memory components that are operable to perform or support operations based on received or obtained information or signals, or to generate information or other signals for transmission or other outputting, or any combination thereof. In some implementations, the transceiver 2010, or the transceiver 2010 and the one or more antennas 2015, or the transceiver 2010 and the one or more antennas 2015 and one or more processors or one or more memory components (e.g., the at least one processor 2035, the at least one memory 2025, or both), may be included in a chip or chip assembly that is installed in the device 2005. In some examples, the transceiver 2010 may be operable to support communications via one or more communications links (e.g., communication link(s) 125, backhaul communication link(s) 120, a midhaul communication link 162, a fronthaul communication link 168).

The at least one memory 2025 may include RAM, ROM, or any combination thereof. The at least one memory 2025 may store computer-readable, computer-executable, or processor-executable code, such as the code 2030. The code 2030 may include instructions that, when executed by one or more of the at least one processor 2035, cause the device 2005 to perform various functions described herein. The code 2030 may be stored in a non-transitory computer-readable medium such as system memory or another type of memory. In some cases, the code 2030 may not be directly executable by a processor of the at least one processor 2035 but may cause a computer (e.g., when compiled and executed) to perform functions described herein. In some cases, the at least one memory 2025 may include, among other things, a BIOS which may control basic hardware or software operation such as the interaction with peripheral components or devices. In some examples, the at least one processor 2035 may include multiple processors and the at least one memory 2025 may include multiple memories. One or more of the multiple processors may be coupled with one or more of the multiple memories which may, individually or collectively, be configured to perform various functions herein (for example, as part of a processing system).

The at least one processor 2035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 2035 may be configured to operate a memory array using a memory controller. In some other cases, a memory controller may be integrated into one or more of the at least one processor 2035. The at least one processor 2035 may be configured to execute computer-readable instructions stored in a memory (e.g., one or more of the at least one memory 2025) to cause the device 2005 to perform various functions (e.g., functions or tasks supporting smart carrier selection for cooperating wireless devices). For example, the device 2005 or a component of the device 2005 may include at least one processor 2035 and at least one memory 2025 coupled with one or more of the at least one processor 2035, the at least one processor 2035 and the at least one memory 2025 configured to perform various functions described herein. The at least one processor 2035 may be an example of a cloud-computing platform (e.g., one or more physical nodes and supporting software such as operating systems, virtual machines, or container instances) that may host the functions (e.g., by executing code 2030) to perform the functions of the device 2005. The at least one processor 2035 may be any one or more suitable processors capable of executing scripts or instructions of one or more software programs stored in the device 2005 (such as within one or more of the at least one memory 2025).

In some examples, the at least one processor 2035 may include multiple processors and the at least one memory 2025 may include multiple memories. One or more of the multiple processors may be coupled with one or more of the multiple memories, which may, individually or collectively, be configured to perform various functions herein. In some examples, the at least one processor 2035 may be a component of a processing system, which may refer to a system (such as a series) of machines, circuitry (including, for example, one or both of processor circuitry (which may include the at least one processor 2035) and memory circuitry (which may include the at least one memory 2025)), or components, that receives or obtains inputs and processes the inputs to produce, generate, or obtain a set of outputs. The processing system may be configured to perform one or more of the functions described herein. For example, the at least one processor 2035 or a processing system including the at least one processor 2035 may be configured to, configurable to, or operable to cause the device 2005 to perform one or more of the functions described herein. Further, as described herein, being “configured to,” being “configurable to,” and being “operable to” may be used interchangeably and may be associated with a capability, when executing code stored in the at least one memory 2025 or otherwise, to perform one or more of the functions described herein.

In some examples, a bus 2040 may support communications of (e.g., within) a protocol layer of a protocol stack. In some examples, a bus 2040 may support communications associated with a logical channel of a protocol stack (e.g., between protocol layers of a protocol stack), which may include communications performed within a component of the device 2005, or between different components of the device 2005 that may be co-located or located in different locations (e.g., where the device 2005 may refer to a system in which one or more of the communications manager 2020, the transceiver 2010, the at least one memory 2025, the code 2030, and the at least one processor 2035 may be located in one of the different components or divided between different components).

In some examples, the communications manager 2020 may manage aspects of communications with a core network 130 (e.g., via one or more wired or wireless backhaul links). For example, the communications manager 2020 may manage the transfer of data communications for client devices, such as one or more UEs 115. In some examples, the communications manager 2020 may manage communications with one or more other network entities 105, and may include a controller or scheduler for controlling communications with UEs 115 (e.g., in cooperation with the one or more other network devices). In some examples, the communications manager 2020 may support an X2 interface within an LTE/LTE-A wireless communications network technology to provide communication between network entities 105.

The communications manager 2020 may support wireless communication in accordance with examples as disclosed herein. For example, the communications manager 2020 is capable of, configured to, or operable to support a means for outputting, to an anchor wireless device connected via a cooperative communication link with a companion wireless device, an indication of one or more frequency-specific offsets that are usable by the anchor wireless device to disadvantage selection of a carrier in a cooperative carrier selection process that configures a first Uu communication link of the anchor wireless device to be configured with a first carrier and a second Uu communication link of the companion wireless device to be configured with a second carrier that is different from the first carrier, where the first Uu communication link enables communication between the anchor wireless device and the first network entity and the second Uu communication link enables communication between the companion wireless device and the first network entity, and where a cooperative communication link between the anchor wireless device and the companion wireless device enables indirect communication between the anchor wireless device and the first network entity. The communications manager 2020 is capable of, configured to, or operable to support a means for communicating with the anchor wireless device, the companion wireless device, or both, in accordance with a forwarding scheme.

By including or configuring the communications manager 2020 in accordance with examples as described herein, the device 2005 may support techniques for smart carrier selection for cooperating wireless devices, which may result in improved communication reliability, reduced latency, improved user experience related to reduced processing, reduced power consumption, more efficient utilization of communication resources, improved coordination between devices, improved utilization of processing capability, increased throughput, higher rank, higher data rates, among other advantages.

In some examples, the communications manager 2020 may be configured to perform various operations (e.g., receiving, obtaining, monitoring, outputting, transmitting) using or otherwise in cooperation with the transceiver 2010, the one or more antennas 2015 (e.g., where applicable), or any combination thereof. Although the communications manager 2020 is illustrated as a separate component, in some examples, one or more functions described with reference to the communications manager 2020 may be supported by or performed by the transceiver 2010, one or more of the at least one processor 2035, one or more of the at least one memory 2025, the code 2030, or any combination thereof (for example, by a processing system including at least a portion of the at least one processor 2035, the at least one memory 2025, the code 2030, or any combination thereof). For example, the code 2030 may include instructions executable by one or more of the at least one processor 2035 to cause the device 2005 to perform various aspects of smart carrier selection for cooperating wireless devices as described herein, or the at least one processor 2035 and the at least one memory 2025 may be otherwise configured to, individually or collectively, perform or support such operations.

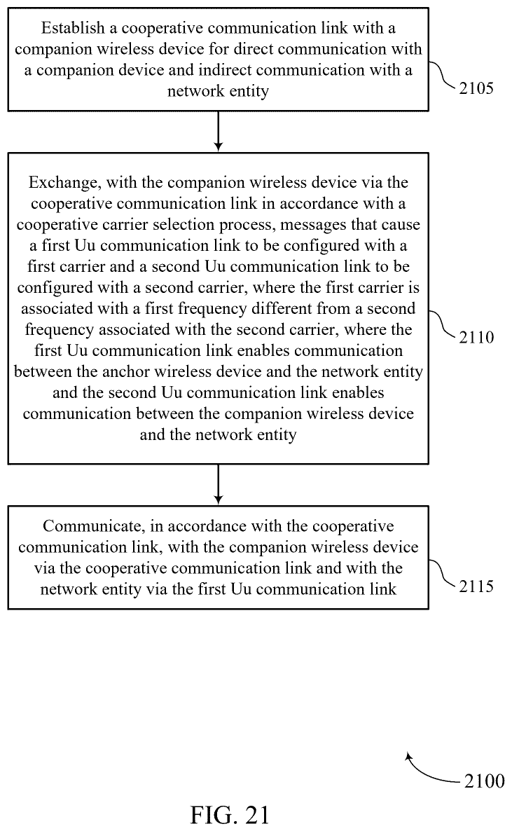

FIG. 21 shows a flowchart illustrating a method 2100 that supports smart carrier selection for cooperating wireless devices in accordance with one or more aspects of the present disclosure. The operations of the method 2100 may be implemented by an anchor wireless device or its components as described herein. For example, the operations of the method 2100 may be performed by an anchor wireless device as described with reference to FIGS. 1 through 12. In some examples, an anchor wireless device may execute a set of instructions to control the functional elements of the anchor wireless device to perform the described functions. Additionally, or alternatively, the anchor wireless device may perform aspects of the described functions using special-purpose hardware.

At 2105, the method may include establishing a cooperative communication link with a companion wireless device for direct communication with the companion wireless device and indirect communication with a network entity. The operations of 2105 may be performed in accordance with examples as disclosed herein. In some examples, aspects of the operations of 2105 may be performed by a cooperative component 1125 as described with reference to FIG. 11.

At 2110, the method may include exchanging, with the companion wireless device via the cooperative communication link in accordance with a cooperative carrier selection process, messages that cause a first Uu communication link to be configured with a first carrier and a second Uu communication link to be configured with a second carrier, where the first carrier is associated with a first frequency different from a second frequency associated with the second carrier, where the first Uu communication link enables communication between the anchor wireless device and the network entity and the second Uu communication link enables communication between the companion wireless device and the network entity. The operations of 2110 may be performed in accordance with examples as disclosed herein. In some examples, aspects of the operations of 2110 may be performed by a message exchange component 1130 as described with reference to FIG. 11.

At 2115, the method may include communicating, in accordance with the cooperative communication link, with the companion wireless device via the cooperative communication link and with the network entity via the first Uu communication link. The operations of 2115 may be performed in accordance with examples as disclosed herein. In some examples, aspects of the operations of 2115 may be performed by a communication link component 1135 as described with reference to FIG. 11.

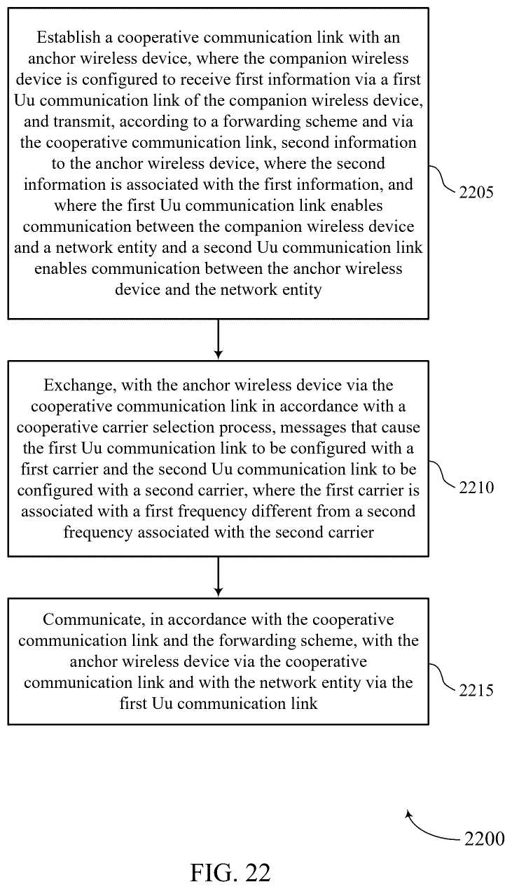

FIG. 22 shows a flowchart illustrating a method 2200 that supports smart carrier selection for cooperating wireless devices in accordance with one or more aspects of the present disclosure. The operations of the method 2200 may be implemented by a companion wireless device or its components as described herein. For example, the operations of the method 2200 may be performed by a companion wireless device as described with reference to FIGS. 1 through 8 and 13 through 16. In some examples, a companion wireless device may execute a set of instructions to control the functional elements of the companion wireless device to perform the described functions. Additionally, or alternatively, the companion wireless device may perform aspects of the described functions using special-purpose hardware.

At 2205, the method may include establishing a cooperative communication link with an anchor wireless device, where the companion wireless device is configured to receive first information via a first Uu communication link of the companion wireless device, and transmit, according to a forwarding scheme and via the cooperative communication link, second information to the anchor wireless device, where the second information is associated with the first information, and where the first Uu communication link enables communication between the companion wireless device and a network entity and a second Uu communication link enables communication between the anchor wireless device and the network entity. The operations of 2205 may be performed in accordance with examples as disclosed herein. In some examples, aspects of the operations of 2205 may be performed by a companion cooperation component 1525 as described with reference to FIG. 15.

At 2210, the method may include exchanging, with the anchor wireless device via the cooperative communication link in accordance with a cooperative carrier selection process, messages that cause the first Uu communication link to be configured with a first carrier and the second Uu communication link to be configured with a second carrier, where the first carrier is associated with a first frequency different from a second frequency associated with the second carrier. The operations of 2210 may be performed in accordance with examples as disclosed herein. In some examples, aspects of the operations of 2210 may be performed by a companion message exchange component 1530 as described with reference to FIG. 15.

At 2215, the method may include communicating, in accordance with the cooperative communication link and the forwarding scheme, with the anchor wireless device via the cooperative communication link and with the network entity via the first Uu communication link. The operations of 2215 may be performed in accordance with examples as disclosed herein. In some examples, aspects of the operations of 2215 may be performed by a companion communication link component 1535 as described with reference to FIG. 15.

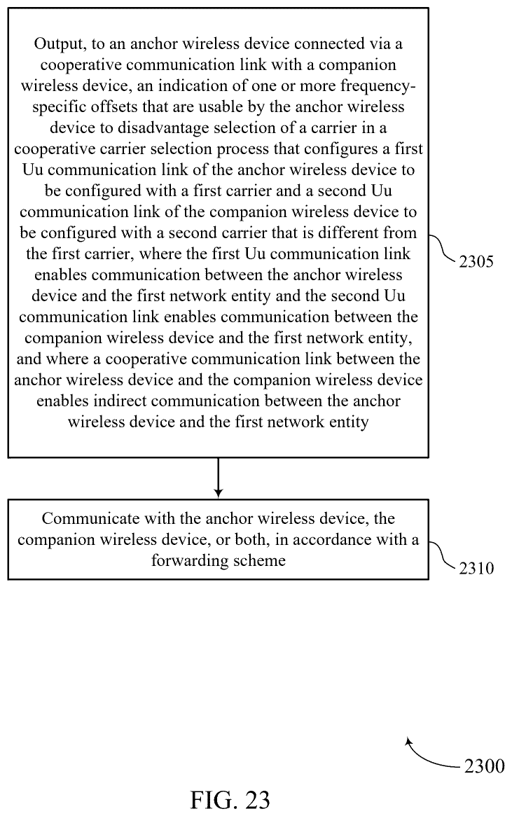

FIG. 23 shows a flowchart illustrating a method 2300 that supports smart carrier selection for cooperating wireless devices in accordance with one or more aspects of the present disclosure. The operations of the method 2300 may be implemented by a network entity or its components as described herein. For example, the operations of the method 2300 may be performed by a network entity as described with reference to FIGS. 1 through 8 and 17 through 20. In some examples, a network entity may execute a set of instructions to control the functional elements of the network entity to perform the described functions. Additionally, or alternatively, the network entity may perform aspects of the described functions using special-purpose hardware.

At 2305, the method may include outputting, to an anchor wireless device connected via a cooperative communication link with a companion wireless device, an indication of one or more frequency-specific offsets that are usable by the anchor wireless device to disadvantage selection of a carrier in a cooperative carrier selection process that configures a first Uu communication link of the anchor wireless device to be configured with a first carrier and a second Uu communication link of the companion wireless device to be configured with a second carrier that is different from the first carrier, where the first Uu communication link enables communication between the anchor wireless device and the first network entity and the second Uu communication link enables communication between the companion wireless device and the first network entity, and where a cooperative communication link between the anchor wireless device and the companion wireless device enables indirect communication between the anchor wireless device and the first network entity. The operations of 2305 may be performed in accordance with examples as disclosed herein. In some examples, aspects of the operations of 2305 may be performed by an offset manager 1925 as described with reference to FIG. 19.

At 2310, the method may include communicating with the anchor wireless device, the companion wireless device, or both, in accordance with a forwarding scheme. The operations of 2310 may be performed in accordance with examples as disclosed herein. In some examples, aspects of the operations of 2310 may be performed by a communication link manager 1930 as described with reference to FIG. 19.

The following provides an overview of aspects of the present disclosure:

Aspect 1: A method for wireless communication at an anchor wireless device, comprising: establishing a cooperative communication link with a companion wireless device for direct communication with the companion wireless device and indirect communication with a network entity; exchanging, with the companion wireless device via the cooperative communication link in accordance with a cooperative carrier selection process, messages that cause a first Uu communication link to be configured with a first carrier and a second Uu communication link to be configured with a second carrier, wherein the first carrier is associated with a first frequency different from a second frequency associated with the second carrier, wherein the first Uu communication link enables communication between the anchor wireless device and the network entity and the second Uu communication link enables communication between the companion wireless device and the network entity; and communicating, in accordance with the cooperative communication link, with the companion wireless device via the cooperative communication link and with the network entity via the first Uu communication link.

Aspect 2: The method of aspect 1, wherein exchanging the messages in accordance with the cooperative carrier selection process comprises: transmitting, while in an idle connection state with the network entity, a first message that indicates a measurement and reporting configuration for the companion wireless device; and receiving a second message that includes a report indicative of inter-frequency measurement information in accordance with the measurement and reporting configuration.

Aspect 3: The method of aspect 2, wherein the measurement and reporting configuration corresponds to a set of channel measurements on different frequencies and to periodic or event-triggered reporting of information indicative of the set of channel measurements.

Aspect 4: The method of any of aspects 2 through 3, wherein the inter-frequency measurement information is indicative of a SSB frequency and a PCI associated with the companion wireless device, one or more quality measurements associated with the SSB frequency, a list of other SSB frequencies not associated with the PCI, corresponding quality measurements associated with each of the list of other SSB frequencies, or any combination thereof.

Aspect 5: The method of any of aspects 2 through 4, wherein exchanging the messages in accordance with the cooperative carrier selection process comprises: transmitting, to the companion wireless device and based on the inter-frequency measurement information, a third message that indicates the second carrier.

Aspect 6: The method of any of aspects 2 through 5, wherein exchanging the messages in accordance with the cooperative carrier selection process comprises: selecting, based on the inter-frequency measurement information, the first carrier; and transmitting, to the companion wireless device, a third message that indicates one or more carriers that are not to be associated with the second Uu communication link, wherein the one or more carriers includes the first carrier.

Aspect 7: The method of any of aspects 1 through 6, wherein exchanging the messages in accordance with the cooperative carrier selection process comprises: transmitting, while in a connected connection state with the network entity, a first message that indicates a measurement and reporting configuration for the companion wireless device; and receiving a second message that includes a first report indicative of first inter-frequency measurement information in accordance with the measurement and reporting configuration.

Aspect 8: The method of aspect 7, wherein the measurement and reporting configuration corresponds to channel measurements on a serving cell and on one or more neighboring cells and to periodic or event-triggered reporting of information indicative of the channel measurements, and the one or more neighboring cells are on one or more respective carriers different from a carrier of the serving cell.

Aspect 9: The method of any of aspects 7 through 8, wherein the first inter-frequency measurement information is indicative of one or more quality measurements associated with a same carrier, a list of other frequencies not associated with the same carrier, corresponding highest quality measurements associated with each of the list of other frequencies, or any combination thereof.

Aspect 10: The method of any of aspects 7 through 9, wherein exchanging the messages in accordance with the cooperative carrier selection process comprises: transmitting, to the companion wireless device and based on the first inter-frequency measurement information and on second inter-frequency measurement information associated with the anchor wireless device, a third message that indicates that the first carrier is to be disadvantaged for the companion wireless device; and receiving a fourth message that includes a second report indicative of updated first inter-frequency measurement information that is associated with the second carrier based on the first carrier being disadvantaged for the companion wireless device by the third message.

Aspect 11: The method of any of aspects 7 through 10, wherein exchanging the messages in accordance with the cooperative carrier selection process comprises: disadvantaging the second carrier at the anchor wireless device based on the first inter-frequency measurement information and on second inter-frequency measurement information associated with the anchor wireless device; transitioning to the first carrier for the first Uu communication link based on the second carrier being disadvantaged; transmitting, to the companion wireless device, a third message that indicates that the first carrier is to be disadvantaged for the companion wireless device; and receiving a fourth message that includes a second report indicative of updated first inter-frequency measurement information that is associated with the second carrier based on the first carrier being disadvantaged for the companion wireless device by the third message.

Aspect 12: The method of any of aspects 1 through 11, wherein exchanging the messages in accordance with the cooperative carrier selection process comprises: participating in a handover procedure that results in establishment by the anchor wireless device of a third Uu communication link configured with a third carrier; and transmitting, to the companion wireless device and based on establishment of the third Uu communication link configured with the third carrier, a third message that indicates that the third carrier is to be disadvantaged for the companion wireless device.

Aspect 13: The method of any of aspects 1 through 12, further comprising: receiving, from the companion wireless device after a handover procedure associated with the companion wireless device and based on establishment of a third Uu communication link configured with a third carrier for the companion wireless device, a third message that indicates a report indicative of inter-frequency measurement information that is associated with the third carrier.

Aspect 14: The method of any of aspects 1 through 13, wherein exchanging the messages in accordance with the cooperative carrier selection process comprises: transmitting, to the network entity, an RRC message that indicates a request to configure or to release inter-frequency measurement procedures; and receiving, from the network entity, an indication of one or more frequency-specific offsets that are usable by the anchor wireless device to disadvantage selection of the first carrier as a result of a measurement report triggering event.

Aspect 15: The method of any of aspects 1 through 14, wherein exchanging the messages in accordance with the cooperative carrier selection process comprises: transmitting, to the companion wireless device, a first message that indicates a request to report cooperation identity information associated with the companion wireless device; and receive, from the companion wireless device and based on the first message, a first report indicative of the cooperation identity information associated with the companion wireless device, wherein the cooperation identity information is indicative of an ARFCN associated with the companion wireless device, a PCI that corresponds to the ARFCN, and a C-RNTI associated with the companion wireless device.

Aspect 16: The method of aspect 15, further comprising: transmitting, to the network entity, a second message that indicates the cooperation identity information associated with the companion wireless device.

Aspect 17: The method of aspect 16, further comprising: receiving, from the network entity, an RRC reconfiguration message that indicates that the anchor wireless device is to participate in a handover procedure that results in establishment by the anchor wireless device of a third Uu communication link configured with a third carrier; and participating in the handover procedure to establish the third Uu communication link configured with the third carrier based on the RRC reconfiguration message.

Aspect 18: The method of any of aspects 16 through 17, wherein the second message is an RRC message, a medium access control-control element (MAC-CE) message, or a layer 1 uplink control information (UCI) message.

Aspect 19: The method of any of aspects 15 through 18, wherein exchanging the messages in accordance with the cooperative carrier selection process comprises: receiving, from the companion wireless device, a second report indicative of updated cooperation identity information associated with the companion wireless device, wherein the updated cooperation identity information includes a second ARFCN associated with the companion wireless device, a second PCI that corresponds to the second ARFCN, and a second C-RNTI associated with the companion wireless device.

Aspect 20: A method for wireless communication at a companion wireless device, comprising: establishing a cooperative communication link with an anchor wireless device, wherein the companion wireless device is configured to receive first information via a first Uu communication link of the companion wireless device, and transmit, according to a forwarding scheme and via the cooperative communication link, second information to the anchor wireless device, wherein the second information is associated with the first information, and wherein the first Uu communication link enables communication between the companion wireless device and a network entity and a second Uu communication link enables communication between the anchor wireless device and the network entity; exchanging, with the anchor wireless device via the cooperative communication link in accordance with a cooperative carrier selection process, messages that cause the first Uu communication link to be configured with a first carrier and the second Uu communication link to be configured with a second carrier, wherein the first carrier is associated with a first frequency different from a second frequency associated with the second carrier; and communicating, in accordance with the cooperative communication link and the forwarding scheme, with the anchor wireless device via the cooperative communication link and with the network entity via the first Uu communication link.

Aspect 21: The method of aspect 20, wherein exchanging the messages in accordance with the cooperative carrier selection process comprises: receiving, while in an idle connection state with the network entity, a first message that indicates a measurement and reporting configuration for the companion wireless device; generating, based on the measurement and reporting configuration, inter-frequency measurement information that includes channel measurements on one or more frequencies; and transmitting a second message that includes a report indicative of the inter-frequency measurement information in accordance with the measurement and reporting configuration.

Aspect 22: The method of aspect 21, wherein the measurement and reporting configuration corresponds to channel measurements on different frequencies and periodic or event-triggered reporting of information indicative of the channel measurements.

Aspect 23: The method of any of aspects 21 through 22, wherein the inter-frequency measurement information is indicative of a SSB frequency and a PCI associated with the companion wireless device, one or more quality measurements associated with the SSB frequency, a list of other SSB frequencies not associated with the PCI, corresponding quality measurements associated with each of the list of other SSB frequencies, or any combination thereof.

Aspect 24: The method of any of aspects 21 through 23, wherein exchanging the messages in accordance with the cooperative carrier selection process comprises: receiving, from the anchor wireless device and based on the inter-frequency measurement information, a third message that indicates the second carrier; and selecting, based on the third message, the first carrier; and.

Aspect 25: The method of any of aspects 21 through 24, wherein exchanging the messages in accordance with the cooperative carrier selection process comprises: receiving, from the anchor wireless device, a third message that indicates one or more carriers that are not to be associated with the first Uu communication link, wherein the one or more carriers includes the second carrier.

Aspect 26: The method of any of aspects 20 through 25, wherein exchanging the messages in accordance with the cooperative carrier selection process comprises: receiving, while in a connected connection state with the network entity, a first message that indicates a measurement and reporting configuration for the companion wireless device; and transmitting a second message that includes a first report indicative of first inter-frequency measurement information in accordance with the measurement and reporting configuration.

Aspect 27: The method of aspect 26, wherein the measurement and reporting configuration corresponds to channel measurements on a serving cell and on one or more neighboring cells and to periodic or event-triggered reporting of information indicative of the channel measurements, and the one or more neighboring cells are on one or more respective carriers different from a carrier of the serving cell.

Aspect 28: The method of any of aspects 26 through 27, wherein the first inter-frequency measurement information is indicative of one or more quality measurements associated with a same carrier, a list of other frequencies not associated with the same carrier, corresponding highest quality measurements associated with each of the list of other frequencies, or any combination thereof.

Aspect 29: The method of any of aspects 26 through 28, wherein exchanging the messages in accordance with the cooperative carrier selection process comprises: receiving, from the anchor wireless device, a third message that indicates that the second carrier is to be disadvantaged for the companion wireless device; and transmitting a fourth message that includes a second report indicative of updated first inter-frequency measurement information that is associated with the first carrier based on the second carrier being disadvantaged for the companion wireless device by the third message.

Aspect 30: The method of any of aspects 26 through 29, wherein exchanging the messages in accordance with the cooperative carrier selection process comprises: receiving, from the anchor wireless device, a third message that indicates that the second carrier is to be disadvantaged for the companion wireless device, wherein a same carrier is the first carrier; and transmitting a fourth message that includes a second report indicative of updated first inter-frequency measurement information that is associated with the first carrier based on the second carrier being disadvantaged for the companion wireless device by the third message.

Aspect 31: The method of any of aspects 20 through 30, further comprising: receiving, from the anchor wireless device after a handover procedure associated with the anchor wireless device and based on establishment of a third Uu communication link configured with a third carrier for the anchor wireless device, a third message that indicates that the third carrier is to be disadvantaged for the companion wireless device.

Aspect 32: The method of any of aspects 20 through 31, further comprising: participating in a handover procedure that results in establishment by the companion wireless device of a third Uu communication link configured with a third carrier; and transmitting, to the anchor wireless device and based on establishment of the third Uu communication link configured with the third carrier, a third message that indicates a report indicative of inter-frequency measurement information that is associated with the third carrier.

Aspect 33: The method of any of aspects 20 through 32, wherein exchanging the messages in accordance with the cooperative carrier selection process comprises: receiving, via an SIB message or an RRC release message, an indication of one or more frequency-specific offsets, one or more frequency-specific priorities, or both, that are usable by the companion wireless device to disadvantage one or more frequencies.

Aspect 34: The method of aspect 33, further comprising: using, while in an idle connection state with the network entity, the one or more frequency-specific offsets or the one or more frequency-specific priorities to disadvantage the second carrier.

Aspect 35: The method of any of aspects 20 through 34, wherein exchanging the messages in accordance with the cooperative carrier selection process comprises: transmitting, to the network entity, an RRC message that indicates a request to configure or to release inter-frequency measurement procedures; and receiving, from the network entity, an indication of one or more frequency-specific offsets that are usable by the companion wireless device to disadvantage selection of the second carrier as a result of a measurement report triggering event.

Aspect 36: The method of any of aspects 20 through 35, wherein exchanging the messages in accordance with the cooperative carrier selection process comprises: receiving, from the anchor wireless device, a first message that indicates a request to report cooperation identity information associated with the companion wireless device; and transmitting, to the anchor wireless device and based on the first message, a first report indicative of the cooperation identity information associated with the companion wireless device, wherein the cooperation identity information is indicative of an ARFCN associated with the companion wireless device, a PCI that corresponds to the ARFCN, and a C-RNTI associated with the companion wireless device.

Aspect 37: The method of aspect 36, further comprising: receiving, from the network entity, an RRC reconfiguration message that indicates that the companion wireless device is to participate in a handover procedure that results in establishment by the companion wireless device of a third Uu communication link configured with a third carrier; and participating in the handover procedure to establish the third Uu communication link configured with the third carrier based on the RRC reconfiguration message.

Aspect 38: The method of aspect 37, further comprising: transmitting, to the network entity, a second message that indicates that the handover procedure to establish the third Uu communication link configured with the third carrier is complete.

Aspect 39: The method of any of aspects 36 through 38, wherein exchanging the messages in accordance with the cooperative carrier selection process comprises: transmitting, to the anchor wireless device, a second report indicative of updated cooperation identity information associated with the companion wireless device, wherein the updated cooperation identity information includes a second ARFCN associated with the companion wireless device, a second PCI that corresponds to the second ARFCN, and a second C-RNTI associated with the companion wireless device.

Aspect 40: The method of any of aspects 20 through 39, wherein the first information and the second information comprise same information.

Aspect 41: The method of any of aspects 20 through 40, wherein the first information and the second information comprise different information.

Aspect 42: The method of any of aspects 20 through 41, wherein the forwarding scheme comprises an amplify and forward scheme.

Aspect 43: The method of any of aspects 20 through 42, wherein the forwarding scheme comprises a decode and forward scheme.

Aspect 44: A method for wireless communication at a first network entity, comprising: outputting, to an anchor wireless device connected via a cooperative communication link with a companion wireless device, an indication of one or more frequency-specific offsets that are usable by the anchor wireless device to disadvantage selection of a carrier in a cooperative carrier selection process that configures a first Uu communication link of the anchor wireless device to be configured with a first carrier and a second Uu communication link of the companion wireless device to be configured with a second carrier that is different from the first carrier, wherein the first Uu communication link enables communication between the anchor wireless device and the first network entity and the second Uu communication link enables communication between the companion wireless device and the first network entity, and wherein a cooperative communication link between the anchor wireless device and the companion wireless device enables indirect communication between the anchor wireless device and the first network entity; and communicating with the anchor wireless device, the companion wireless device, or both, in accordance with a forwarding scheme.

Aspect 45: The method of aspect 44, further comprising: obtaining, from the anchor wireless device, an RRC message that indicates a request to configure or to release inter-frequency measurement procedures, wherein the one or more frequency-specific offsets are usable by the anchor wireless device to disadvantage selection of the first carrier as a result of a measurement report triggering event.

Aspect 46: The method of any of aspects 44 through 45, further comprising: obtaining, from the anchor wireless device, a message that indicates cooperation identity information associated with the companion wireless device, wherein the cooperation identity information is indicative of an ARFCN associated with the companion wireless device, a PCI that corresponds to the ARFCN, and a C-RNTI associated with the companion wireless device.

Aspect 47: The method of aspect 46, further comprising: outputting, to the anchor wireless device, an RRC reconfiguration message that indicates that the anchor wireless device is to participate in a handover procedure that results in establishment by the anchor wireless device of a third Uu communication link configured with a third carrier.

Aspect 48: The method of any of aspects 46 through 47, wherein the message is an RRC message, a medium access control-control element (MAC-CE) message, or a layer 1 uplink control information (UCI) message.

Aspect 49: The method of any of aspects 44 through 48, further comprising: obtaining, from a second network entity, a message that includes a request to initiate a handover procedure for the companion wireless device, wherein the message indicates cooperation identity information associated with the companion wireless device, and wherein the cooperation identity information is indicative of an ARFCN associated with the companion wireless device, a PCI that corresponds to the ARFCN, and a C-RNTI associated with the companion wireless device; and outputting, to the companion wireless device, an RRC reconfiguration message that indicates that the companion wireless device is to participate in the handover procedure that results in establishment by the companion wireless device of a third Uu communication link configured with a third carrier.

Aspect 50: The method of aspect 49, further comprising: obtaining, from the companion wireless device, a second message that indicates that the handover procedure to establish the third Uu communication link configured with the third carrier is complete; and outputting, to the second network entity, a third message that indicates a confirmation of the handover procedure.

Aspect 51: An anchor wireless device for wireless communication, comprising one or more memories storing processor-executable code, and one or more processors coupled with the one or more memories and individually or collectively operable to execute the code to cause the anchor wireless device to perform a method of any of aspects 1 through 19.

Aspect 52: An anchor wireless device for wireless communication, comprising at least one means for performing a method of any of aspects 1 through 19.

Aspect 53: A non-transitory computer-readable medium storing code for wireless communication, the code comprising instructions executable by one or more processors to perform a method of any of aspects 1 through 19.

Aspect 54: A companion wireless device for wireless communication, comprising one or more memories storing processor-executable code, and one or more processors coupled with the one or more memories and individually or collectively operable to execute the code to cause the companion wireless device to perform a method of any of aspects 20 through 43.

Aspect 55: A companion wireless device for wireless communication, comprising at least one means for performing a method of any of aspects 20 through 43.

Aspect 56: A non-transitory computer-readable medium storing code for wireless communication, the code comprising instructions executable by one or more processors to perform a method of any of aspects 20 through 43.

Aspect 57: A first network entity for wireless communication, comprising one or more memories storing processor-executable code, and one or more processors coupled with the one or more memories and individually or collectively operable to execute the code to cause the first network entity to perform a method of any of aspects 44 through 50.

Aspect 58: A first network entity for wireless communication, comprising at least one means for performing a method of any of aspects 44 through 50.

Aspect 59: A non-transitory computer-readable medium storing code for wireless communication, the code comprising instructions executable by one or more processors to perform a method of any of aspects 44 through 50.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An anchor wireless device for wireless communication, comprising:
a processing system configured to:
establish a cooperative communication link with a companion wireless device for direct communication with the companion wireless device and indirect communication with a network entity;
exchange, with the companion wireless device via the cooperative communication link in accordance with a cooperative carrier selection process, messages that cause a first Uu communication link to be configured with a first carrier and a second Uu communication link to be configured with a second carrier, wherein the first carrier is associated with a first frequency different from a second frequency associated with the second carrier, wherein the first Uu communication link enables communication between the anchor wireless device and the network entity and the second Uu communication link enables communication between the companion wireless device and the network entity; and
communicate, in accordance with the cooperative communication link, with the companion wireless device via the cooperative communication link and with the network entity via the first Uu communication link.

2. The anchor wireless device of claim 1, wherein, to exchange the messages in accordance with the cooperative carrier selection process, the processing system is configured to:
transmit, while in an idle connection state with the network entity, a first message that indicates a measurement and reporting configuration for the companion wireless device; and
receive a second message that includes a report indicative of inter-frequency measurement information in accordance with the measurement and reporting configuration.

3. The anchor wireless device of claim 2, wherein the measurement and reporting configuration corresponds to a set of channel measurements on different frequencies and to periodic or event-triggered reporting of information indicative of the set of channel measurements.

4. The anchor wireless device of claim 2, wherein the inter-frequency measurement information is indicative of:
a synchronization signal block (SSB) frequency and a physical cell identifier (PCI) associated with the companion wireless device,
one or more quality measurements associated with the SSB frequency,
a list of other SSB frequencies not associated with the PCI,
corresponding quality measurements associated with each of the list of other SSB frequencies, or
any combination thereof.

5. The anchor wireless device of claim 2, wherein, to exchange the messages in accordance with the cooperative carrier selection process, the processing system is configured to:
transmit, to the companion wireless device and based on the inter-frequency measurement information, a third message that indicates the second carrier.

6. The anchor wireless device of claim 2, wherein, to exchange the messages in accordance with the cooperative carrier selection process, the processing system is configured to:
select, based on the inter-frequency measurement information, the first carrier; and
transmit, to the companion wireless device, a third message that indicates one or more carriers that are not to be associated with the second Uu communication link, wherein the one or more carriers includes the first carrier.

7. The anchor wireless device of claim 1, wherein, to exchange the messages in accordance with the cooperative carrier selection process, the processing system is configured to:
transmit, while in a connected connection state with the network entity, a first message that indicates a measurement and reporting configuration for the companion wireless device; and
receive a second message that includes a first report indicative of first inter-frequency measurement information in accordance with the measurement and reporting configuration.

8. The anchor wireless device of claim 7, wherein:
the measurement and reporting configuration corresponds to channel measurements on a serving cell and on one or more neighboring cells and to periodic or event-triggered reporting of information indicative of the channel measurements, and
the one or more neighboring cells are on one or more respective carriers different from a carrier of the serving cell.

9. The anchor wireless device of claim 7, wherein the first inter-frequency measurement information is indicative of:
one or more quality measurements associated with a same carrier,
a list of other frequencies not associated with the same carrier,
corresponding highest quality measurements associated with each of the list of other frequencies, or
any combination thereof.

10. The anchor wireless device of claim 7, wherein, to exchange the messages in accordance with the cooperative carrier selection process, the processing system is configured to:
transmit, to the companion wireless device and based on the first inter-frequency measurement information and on second inter-frequency measurement information associated with the anchor wireless device, a third message that indicates that the first carrier is to be disadvantaged for the companion wireless device; and
receive a fourth message that includes a second report indicative of updated first inter-frequency measurement information that is associated with the second carrier based on the first carrier being disadvantaged for the companion wireless device by the third message.

11. The anchor wireless device of claim 7, wherein, to exchange the messages in accordance with the cooperative carrier selection process, the processing system is configured to:
disadvantage the second carrier at the anchor wireless device based on the first inter-frequency measurement information and on second inter-frequency measurement information associated with the anchor wireless device;
transition to the first carrier for the first Uu communication link based on the second carrier being disadvantaged;
transmit, to the companion wireless device, a third message that indicates that the first carrier is to be disadvantaged for the companion wireless device; and
receive a fourth message that includes a second report indicative of updated first inter-frequency measurement information that is associated with the second carrier based on the first carrier being disadvantaged for the companion wireless device by the third message.

12. The anchor wireless device of claim 1, wherein, to exchange the messages in accordance with the cooperative carrier selection process, the processing system is configured to:
participate in a handover procedure that results in establishment by the anchor wireless device of a third Uu communication link configured with a third carrier; and
transmit, to the companion wireless device and based on establishment of the third Uu communication link configured with the third carrier, a third message that indicates that the third carrier is to be disadvantaged for the companion wireless device.

13. The anchor wireless device of claim 1, wherein the processing system is configured to:
receive, from the companion wireless device after a handover procedure associated with the companion wireless device and based on establishment of a third Uu communication link configured with a third carrier for the companion wireless device, a third message that indicates a report indicative of inter-frequency measurement information that is associated with the third carrier.

14. The anchor wireless device of claim 1, wherein, to exchange the messages in accordance with the cooperative carrier selection process, the processing system is configured to:
transmit, to the network entity, a radio resource control (RRC) message that indicates a request to configure or to release inter-frequency measurement procedures; and
receive, from the network entity, an indication of one or more frequency-specific offsets that are usable by the anchor wireless device to disadvantage selection of the first carrier as a result of a measurement report triggering event.

15. The anchor wireless device of claim 1, wherein, to exchange the messages in accordance with the cooperative carrier selection process, the processing system is configured to:
transmit, to the companion wireless device, a first message that indicates a request to report cooperation identity information associated with the companion wireless device; and
receive, from the companion wireless device and based on the first message, a first report indicative of the cooperation identity information associated with the companion wireless device, wherein the cooperation identity information is indicative of:
an absolute radio frequency channel number (ARFCN) associated with the companion wireless device,
a physical cell identifier (PCI) that corresponds to the ARFCN, and
a cell-radio network temporary identifier (C-RNTI) associated with the companion wireless device.

16. The anchor wireless device of claim 15, wherein the processing system is configured to:
transmit, to the network entity, a second message that indicates the cooperation identity information associated with the companion wireless device.

17. The anchor wireless device of claim 16, wherein the processing system is configured to:
receive, from the network entity, a radio resource control (RRC) reconfiguration message that indicates that the anchor wireless device is to participate in a handover procedure that results in establishment by the anchor wireless device of a third Uu communication link configured with a third carrier; and
participate in the handover procedure to establish the third Uu communication link configured with the third carrier based on the RRC reconfiguration message.

18. The anchor wireless device of claim 16, wherein the second message is a radio resource control (RRC) message, a medium access control-control element (MAC-CE) message, or a layer 1 uplink control information (UCI) message.

19. The anchor wireless device of claim 15, wherein, to exchange the messages in accordance with the cooperative carrier selection process, the processing system is configured to:
receive, from the companion wireless device, a second report indicative of updated cooperation identity information associated with the companion wireless device, wherein the updated cooperation identity information includes a second ARFCN associated with the companion wireless device, a second PCI that corresponds to the second ARFCN, and a second C-RNTI associated with the companion wireless device.

20. A method for wireless communication at an anchor wireless device, comprising:
establishing a cooperative communication link with a companion wireless device for direct communication with the companion wireless device and indirect communication with a network entity;
exchanging, with the companion wireless device via the cooperative communication link in accordance with a cooperative carrier selection process, messages that cause a first Uu communication link to be configured with a first carrier and a second Uu communication link to be configured with a second carrier, wherein the first carrier is associated with a first frequency different from a second frequency associated with the second carrier, wherein the first Uu communication link enables communication between the anchor wireless device and the network entity and the second Uu communication link enables communication between the companion wireless device and the network entity; and
communicating, in accordance with the cooperative communication link, with the companion wireless device via the cooperative communication link and with the network entity via the first Uu communication link.

21. The method of claim 20, wherein exchanging the messages in accordance with the cooperative carrier selection process comprises:
transmitting, while in an idle connection state with the network entity, a first message that indicates a measurement and reporting configuration for the companion wireless device; and
receiving a second message that includes a report indicative of inter-frequency measurement information in accordance with the measurement and reporting configuration.

22. The method of claim 21, wherein the measurement and reporting configuration corresponds to a set of channel measurements on different frequencies and to periodic or event-triggered reporting of information indicative of the set of channel measurements.

23. The method of claim 21, wherein the inter-frequency measurement information is indicative of a synchronization signal block (SSB) frequency and a physical cell identifier (PCI) associated with the companion wireless device, one or more quality measurements associated with the SSB frequency, a list of other SSB frequencies not associated with the PCI, corresponding quality measurements associated with each of the list of other SSB frequencies, or any combination thereof.

24. The method of claim 21, wherein exchanging the messages in accordance with the cooperative carrier selection process comprises:
transmitting, to the companion wireless device and based on the inter-frequency measurement information, a third message that indicates the second carrier.

25. The method of claim 21, wherein exchanging the messages in accordance with the cooperative carrier selection process comprises:
selecting, based on the inter-frequency measurement information, the first carrier; and
transmitting, to the companion wireless device, a third message that indicates one or more carriers that are not to be associated with the second Uu communication link, wherein the one or more carriers includes the first carrier.

26. The method of claim 20, wherein exchanging the messages in accordance with the cooperative carrier selection process comprises:
transmitting, while in a connected connection state with the network entity, a first message that indicates a measurement and reporting configuration for the companion wireless device; and
receiving a second message that includes a first report indicative of first inter-frequency measurement information in accordance with the measurement and reporting configuration.

27. The method of claim 26, wherein:
the measurement and reporting configuration corresponds to channel measurements on a serving cell and on one or more neighboring cells and to periodic or event-triggered reporting of information indicative of the channel measurements, and
the one or more neighboring cells are on one or more respective carriers different from a carrier of the serving cell.

28. The method of claim 26, wherein the first inter-frequency measurement information is indicative of one or more quality measurements associated with a same carrier, a list of other frequencies not associated with the same carrier, corresponding highest quality measurements associated with each of the list of other frequencies, or any combination thereof.

29. The method of claim 26, wherein exchanging the messages in accordance with the cooperative carrier selection process comprises:
transmitting, to the companion wireless device and based on the first inter-frequency measurement information and on second inter-frequency measurement information associated with the anchor wireless device, a third message that indicates that the first carrier is to be disadvantaged for the companion wireless device; and
receiving a fourth message that includes a second report indicative of updated first inter-frequency measurement information that is associated with the second carrier based on the first carrier being disadvantaged for the companion wireless device by the third message.

30. The method of claim 26, wherein exchanging the messages in accordance with the cooperative carrier selection process comprises:
disadvantaging the second carrier at the anchor wireless device based on the first inter-frequency measurement information and on second inter-frequency measurement information associated with the anchor wireless device;
transitioning to the first carrier for the first Uu communication link based on the second carrier being disadvantaged;
transmitting, to the companion wireless device, a third message that indicates that the first carrier is to be disadvantaged for the companion wireless device; and
receiving a fourth message that includes a second report indicative of updated first inter-frequency measurement information that is associated with the second carrier based on the first carrier being disadvantaged for the companion wireless device by the third message.

31. The method of claim 20, wherein exchanging the messages in accordance with the cooperative carrier selection process comprises:
participating in a handover procedure that results in establishment by the anchor wireless device of a third Uu communication link configured with a third carrier; and
transmitting, to the companion wireless device and based on establishment of the third Uu communication link configured with the third carrier, a third message that indicates that the third carrier is to be disadvantaged for the companion wireless device.

32. The method of claim 20, further comprising:
receiving, from the companion wireless device after a handover procedure associated with the companion wireless device and based on establishment of a third Uu communication link configured with a third carrier for the companion wireless device, a third message that indicates a report indicative of inter-frequency measurement information that is associated with the third carrier.

33. The method of claim 20, wherein exchanging the messages in accordance with the cooperative carrier selection process comprises:
transmitting, to the network entity, a radio resource control (RRC) message that indicates a request to configure or to release inter-frequency measurement procedures; and
receiving, from the network entity, an indication of one or more frequency-specific offsets that are usable by the anchor wireless device to disadvantage selection of the first carrier as a result of a measurement report triggering event.

34. The method of claim 20, wherein exchanging the messages in accordance with the cooperative carrier selection process comprises:
transmitting, to the companion wireless device, a first message that indicates a request to report cooperation identity information associated with the companion wireless device; and
receive, from the companion wireless device and based on the first message, a first report indicative of the cooperation identity information associated with the companion wireless device, wherein the cooperation identity information is indicative of an absolute radio frequency channel number (ARFCN) associated with the companion wireless device, a physical cell identifier (PCI) that corresponds to the ARFCN, and a cell-radio network temporary identifier (C-RNTI) associated with the companion wireless device.

35. The method of claim 34, further comprising:
transmitting, to the network entity, a second message that indicates the cooperation identity information associated with the companion wireless device.

36. The method of claim 35, further comprising:
receiving, from the network entity, a radio resource control (RRC) reconfiguration message that indicates that the anchor wireless device is to participate in a handover procedure that results in establishment by the anchor wireless device of a third Uu communication link configured with a third carrier; and
participating in the handover procedure to establish the third Uu communication link configured with the third carrier based on the RRC reconfiguration message.

37. The method of claim 35, wherein the second message is a radio resource control (RRC) message, a medium access control-control element (MAC-CE) message, or a layer 1 uplink control information (UCI) message.

38. The method of claim 34, wherein exchanging the messages in accordance with the cooperative carrier selection process comprises:
receiving, from the companion wireless device, a second report indicative of updated cooperation identity information associated with the companion wireless device, wherein the updated cooperation identity information includes a second ARFCN associated with the companion wireless device, a second PCI that corresponds to the second ARFCN, and a second C-RNTI associated with the companion wireless device.

39. An anchor wireless device for wireless communication, comprising:
means for establishing a cooperative communication link with a companion wireless device for direct communication with the companion wireless device and indirect communication with a network entity;
means for exchanging, with the companion wireless device via the cooperative communication link in accordance with a cooperative carrier selection process, messages that cause a first Uu communication link to be configured with a first carrier and a second Uu communication link to be configured with a second carrier, wherein the first carrier is associated with a first frequency different from a second frequency associated with the second carrier, wherein the first Uu communication link enables communication between the anchor wireless device and the network entity and the second Uu communication link enables communication between the companion wireless device and the network entity; and
means for communicating, in accordance with the cooperative communication link, with the companion wireless device via the cooperative communication link and with the network entity via the first Uu communication link.

40. A non-transitory computer-readable medium having code for wireless communication stored thereon that, when executed by an anchor wireless device, causes the anchor wireless device to:
establish a cooperative communication link with a companion wireless device for direct communication with the companion wireless device and indirect communication with a network entity;
exchange, with the companion wireless device via the cooperative communication link in accordance with a cooperative carrier selection process, messages that cause a first Uu communication link to be configured with a first carrier and a second Uu communication link to be configured with a second carrier, wherein the first carrier is associated with a first frequency different from a second frequency associated with the second carrier, wherein the first Uu communication link enables communication between the anchor wireless device and the network entity and the second Uu communication link enables communication between the companion wireless device and the network entity; and
communicate, in accordance with the cooperative communication link, with the companion wireless device via the cooperative communication link and with the network entity via the first Uu communication link.
